(19) United States
(12) Patent Application Publication
(10) Pub. No.: US 2025/0262625 A1
(43) Pub. Date: Aug. 21, 2025

(54) ORGANIC MATTER PROCESSING APPARATUS AND METHODS OF USE THEREOF

(71) Applicant: Chewie Labs LLC, San Bruno, CA (US)

(72) Inventors: Adam Mittleman, Redwood City, CA (US); Emma Bright, San Francisco, CA (US); Donald Ripatti, San Francisco, CA (US); Adam Kilgore, Mill Valley, CA (US); Michael Mosle, San Francisco, CA (US); Kevin Peterson, San Francisco, CA (US); Kelly Veit, San Franciso, CA (US); Brian Zhang, San Francisco, CA (US); David Zhang, San Francisco, CA (US); Tom Ayotte, San Francisco, CA (US); Jaideep Singh, Mountain View, CA (US); Nicholas Alexander Gregorich, San Francisco, CA (US); Nicholas Paul Nieminen, San Francisco, CA (US)

(21) Appl. No.: 19/054,832

(22) Filed: Feb. 15, 2025

Related U.S. Application Data
(60) Provisional application No. 63/554,383, filed on Feb. 16, 2024.
(60) Provisional application No. 63/559,759, filed on Feb. 29, 2024.
(60) Provisional application No. 63/575,091, filed on Apr. 5, 2024.

(51) Int. Cl. B02C 18/00; B01F 27/053; B01F 27/091; B01F 27/113; B01F 27/172; B01F 27/2124; B01F 27/808; B01F 27/84; B01F 27/85; B01F 27/91; B01F 33/83; B01F 35/21; B01F 35/222; B01F 35/30; B01F 35/32; B01F 35/33; B01F 35/51; B01F 35/511; B01F 35/90; B01F 35/92; B02C 18/06; B02C 18/12; B02C 18/18; B02C 23/24; B02C 25/00; B65F 1/16

(52) U.S. Cl. CPC B02C 18/0092; B01F 27/053; B01F 27/091; B01F 27/113; B01F 27/172; B01F 27/2124; B01F 27/808; B01F 27/84; B01F 27/85; B01F 27/91; B01F 33/833; B01F 35/211; B01F 35/2115; B01F 35/2135; B01F 35/222; B01F 35/3204; B01F 35/3231; B01F 35/33; B01F 35/51; B01F 35/511; B01F 35/92; B02C 18/067; B02C 18/12; B02C 18/18; B02C 23/24; B02C 25/00; B65F 1/1646; B01F 2035/351; B01F 2035/99; B65F 2210/126; B65F 2210/168; B65F 2210/184; B65F 2210/20; B65F 2250/11

(57) ABSTRACT

Embodiments disclosed herein provide an organic matter processing apparatus and method for the use thereof to convert organic matter into a ground and substantially dried product. The apparatus uses a bucket assembly that can grind, paddle, and heat organic matter contained therein. The bucket assembly can include a metal housing that has a flat bottom surface with multiple support structures that hold respective impeller assemblies that rotate about respective vertical axes. The impeller assemblies each include cutting structures and other structures designed to mix and agitate matter contained in the bucket assembly. One or more blade arrays can be mounted in a vertical orientation on a side of the metal housing plate and assist in fracture cutting and grinding of contents contained in the bucket.

### CROSS-REFERENCE TO RELATED APPLICATIONS

This application claims priority to U.S. Provisional Patent Application No. 63/554,383, filed Feb. 16, 2024, U.S. Provisional Patent Application No. 63/559,759, filed Feb. 26, 2024, and U.S. Provisional Patent Application No. 63/575,091, filed Apr. 5, 2024, the disclosures of which are incorporated by reference in their entireties.

### TECHNICAL FIELD

This patent specification relates to apparatus and methods for processing organic matter, and more particularly to processing organic matter with a practical, user friendly, and internet connected apparatus.

### BACKGROUND

The terms “waste management” and “waste disposal” may be used to refer to the activities required to manage waste from its inception to its disposal. These activities generally include the collection, transport, treatment, and disposal of waste, together with monitoring the process to ensure compliance with related ordinances, rules, and laws. Landfills represent the oldest form of waste management.

A common form of waste in landfills is food and other organic matter. This is a significant problem since food and other organic matter degrades into methane—a powerful greenhouse gas—without oxygen. These harmful emissions can be avoided by diverting food and other organic matter from landfills. One way to divert food and other organic matter from landfills is to process the food and other organic matter into a partially descicatted product using a conventional food recycler or food grinder. These conventional food recylers and food grinders, however, are not efficient in processing food and other organic matter.

### BRIEF SUMMARY

Embodiments disclosed herein provide apparatus and methods for converting organic matter to a ground and selectively dried product. This can be accomplished using an organic matter processing apparatus that can intelligently and efficiently process a load of matter inserted into the apparatus.

A further understanding of the nature and advantages of the embodiments discussed herein may be realized by reference to the remaining portions of the specification and the drawings.

### BRIEF DESCRIPTION OF THE DRAWINGS

FIG. 1 includes a high-level illustration of an organic matter processing apparatus in accordance with various embodiments according to embodiment.

FIG. 1A shows a simplified illustrative block diagram of an organic matter processing apparatus and airflow paths according to an embodiment.

FIG. 2A includes a perspective front view of an organic matter processing apparatus according to embodiment.

FIG. 2B includes a perspective rear view of the organic matter processing apparatus according to embodiment.

FIGS. 2C-2F show front, back, top, and bottom views, respectively of the organic matter processing apparatus according to embodiment.

FIG. 3A includes a perspective view of an organic matter processing apparatus without its lid according to embodiment.

FIG. 3B illustrates another perspective view of the organic matter processing apparatus, with its lid and bezel removed, to show location of a used-air intake vent according to embodiment.

FIG. 3C illustrates yet another perspective view of the organic matter processing apparatus, with its lid and bezel removed, to show location of an ambient air vent according to embodiment.

FIG. 3D shows a view of an OMPA with an open lid, according to an embodiment.

FIG. 3E shows a view of an OMPA with the lid and bezel in an open position, according to an embodiment.

FIG. 3F shows an illustrative top view of and OMPA with the lid removed to show how the gasket overlays both top surface of the liner structure and bezel, according to embodiment.

FIGS. 4A-4E shows different views of an organic matter processing apparatus with its durable housing removed to show additional details according to embodiment.

FIGS. 4F-4J show different views of the organic matter processing apparatus with housing, spine member, cover, air treatment components, and inlet fan components all removed to show additional details according to an embodiment.

FIGS. 5A-5E show various perspective views, a top view, and cross-sectional views of a liner structure, heat plate, overmold structure, mass bracket, load cell, drivetrain, and other components according to an embodiment.

FIG. 5F shows multiple views of a drivetrain coupler according to an embodiment.

FIG. 5G shows multiple views of another drivetrain coupler according to an embodiment.

FIG. 6A shows a perspective view of a bucket assembly that includes a metal housing designed to fit securely within the liner structure of an OMPA according to embodiment.

FIG. 6B shows a top view of the bucket assembly of FIG. 6A according to an embodiment.

FIGS. 6C and 6D show respective bottom and side views of the bucket assembly of FIG. 6A according to various embodiments.

FIGS. 6E and 6F shows different cross sectional views of the bucket assembly according to various embodiments.

FIG. 6G shows multiple views of an impeller coupling according to an embodiment.

FIG. 6H shows several views, including cross-sectional views of an impeller coupling engaged with a couple according to an embodiment.

FIG. 6I shows an alternative bucket assembly to bucket assembly of FIG. 6A according to an embodiment.

FIG. 7 shows an illustrative cross-sectional view of a bucket assembly with emphasis on impeller assemblies, impeller couplings, and drive train couplings according to an embodiment.

FIGS. 7A-7E show different views of a metal housing according to an embodiment.

FIGS. 7F-7J show different views of various blade arrays according to various embodiments.

FIGS. 8A-8G show different views of an impeller according to an embodiment.

FIGS. 8H-8J show different views of an impeller with a modified scraper according to an embodiment.

FIGS. 9A-9H show different views of another impeller according to an embodiment.

FIGS. 91-9K show different views of an impeller with a modified scraper according to an embodiment.

FIG. 10 shows an illustrative process for processing organic matter with a bucket assembly, according to an embodiment.

FIG. 11 shows another illustrative process for processing organic matter with a bucket assembly, according to an embodiment.

FIG. 12 shows yet another illustrative process for processing organic matter with a bucket assembly, according to an embodiment.

FIG. 13 illustrates a network environment that includes a control platform according to embodiment.

FIG. 14 is a block diagram illustrating an example of a computing system in which at least some operations described herein can be implemented according to embodiment.

FIGS. 15A and 15B show different views of a load cell according to an embodiment.

FIGS. 16A and 16B show illustrative bottom and top perspective views, respectively, of a mass bracket according to embodiment.

FIGS. 17A and 17B show perspective top and bottom views of drivetrain assembly respectively according to an embodiment.

FIGS. 18A-18C show different illustrative views of the mass bracket and load cell according to an embodiment.

FIG. 18D shows a partial perspective view of a mass bracket, drivetrain assembly, and other bucket assembly components according to an embodiment.

FIG. 19 shows an illustrative cross-sectional view the bucket assembly and drivetrain and heating system according to an embodiment.

FIG. 20 shows an exploded view of a portion of the drivetrain and heating system according to an embodiment.

FIGS. 20A and 20B show respective bottom and top views of the drivetrain and heating system according to an embodiment.

FIGS. 21A and 21B show respective bottom and top views showing the overmold structure and the insulation layer according to an embodiment.

FIGS. 21C-21E show perspective bottom and top views of the overmold structure and the hot plate according to an embodiment.

FIG. 22 shows a perspective view of hot plate and insulation layer according to an embodiment.

FIG. 23 shows an illustrative process for measuring mass according to an embodiment.

FIGS. 24A-24C show different views of pedal assembly according to an embodiment.

FIGS. 25A-25F show different views of a hinge assembly and components thereof according to an embodiment.

FIGS. 25G and 25H show enlarged views of a hinge bracket and a hinge plate with emphasis on structures that enable the lid to be locked back in open position according to an embodiment.

FIGS. 26A-26E show different views of a hinge pusher according to an embodiment.

FIGS. 27A-27C show different views of a hinge bracket according to an embodiment.

FIGS. 28A-28B show different views of a hinge plate according to an embodiment.

FIGS. 29A-29E shows an illustrative view of the air intake system, or components thereof, according to an embodiment.

FIGS. 30A-30C show different views of a bezel according to an embodiment.

FIG. 30D shows different views of an alternative bezel according to an embodiment.

FIGS. 31A-31E show different views of parts of the air treatment system according to an embodiment.

FIGS. 32A-32E show different views of a duct according to an embodiment.

FIGS. 33A-33C show how the air treatment system is coupled to a midframe according to an embodiment.

FIGS. 33D-33F show different views of an air dispersion manifold according to an embodiment.

FIG. 34 shows a partial backside view of the OMPA with air treatment chamber according to an embodiment.

FIG. 35 shows an illustrative cross-sectional view of the OMPA with emphasis on air flow path for treated air, according to an embodiment.

FIGS. 36A-36E show different views of removable drawer according to an embodiment.

FIGS. 37A-37H show different views of lid locking mechanism according to an embodiment.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The organic matter processing apparatus can include a bucket assembly, a heating assembly, a drivetrain assembly, an air inlet system, an air treatment system, a pedal/lid linkage system, a lid lock assembly, sensors, communications circuitry, and one or more processors for controlling the apparatus. Each of these assemblies, systems, and components can operate together to provide users such as residential users an easy to use appliance to convert, for example, a day's worth of unused organic matter (e.g., unconsumed food) into a ground and shelf stable product at the end of a processing schedule (e.g., operate during the nighttime). The apparatus is capable of processing substantial volumes of organic matter over the course of days or weeks, depending on the frequency and amount of organic matter added thereto, without requiring the bucket to be emptied. This capacity can facilitate repeated use by users because they are not continuously inconvenienced with having to empty the bucket. Moreover the apparatus can intelligently operate itself to maximize efficiency in processing contents contained in the bucket to minimize runtime and minimize power consumption while best adhering to a processing schedule, minimizing wear and tear on components, and maximizing the operational life of air treatment media used to eliminate any odors present in the apparatus. For example, the apparatus can dynamically adjust heater temperatures, fan speeds, motor speeds, and motor rotation direction based on values obtained by the sensors. In addition, the apparatus can communicate with an application operating on a user device or with a backend server. This can enable, for example, remote control of the apparatus (e.g., instructing the apparatus to immediately start a processing event), exchange of status information between the apparatus and the applications, exchange of data for heuristics, artificial intelligence, big data analytics, compliance, statistics, etc., download firmware updates, provide data packages for municipalities, provide troubleshooting data, or any other suitable exchanges of data.

The bucket assembly can use a dual impeller configuration that can grind and paddle the organic matter contained therein. The bucket assembly can include a metal housing that has a flat bottom surface with multiple support structures that hold respective impeller assemblies that rotate about respective vertical axes within the bucket assembly. The impeller assemblies can include cutting structures and other extension members (e.g., integrated paddle cutting structure or paddles). One or more blade arrays can be mounted in a vertical orientation on a side of the metal housing plate and are configured to bisect the cutting structures and the integrated paddle cutting structure as the impeller assemblies rotate, resulting in fracture cutting and grinding of contents contained in the bucket. The configuration of the cutting structures, the integrated paddle cutting structures, and paddles mix and push organic matter down to the bottom of the bucket assembly during impeller assembly rotation. The bottom surface of the bucket assembly is adapted to be placed directly on a heated plate that transfers heat energy into the metal housing. A load cell is also provided to measure the mass of a drivetrain and heating system, a bucket assembly, and any contents contained in the bucket assembly.

The air intake system can include a fan and a heater to bring in ambient air from outside of the apparatus and optionally heat the air before it is injected into to the bucket assembly. The air treatment system can include a fan for drawing untreated air in from the bucket assembly and pushing it through an air treatment chamber that converts the untreated air to treated air before it is exhausted from the apparatus.

The lid may be opened in response depression of a pedal that is mechanically linked to a lid assembly. The lid assembly can include a hinge pusher that decouples the lid from the mechanical linkage connected to the pedal. This decoupling enables the lid to be opened independently of a pedal activation.

As defined herein, an organic matter processing apparatus (OMPA) is an aero-mechanical device operative to convert OMPA input into an OMPA output using judicious combinations of physical, aero, and thermal processes including grinding, paddling, electric heating, and airflow.

OMPA input is defined herein as predominantly organic matter that is intended for processing by the OMPA. OMPA input can include food matter and/or mixed organic matter. Food matter can include consumable food items such as fats, oils, sweets such as sugars and chocolates, dairy products such as milk, yogurt, cheese, proteins such as meat (and bones thereof), poultry (and bones thereof), fish (and bones thereof), beans, eggs, and nuts, vegetables, fruits, and starches such as bread, cereal, pasta, and rice. Food matter is sometimes referred to as foodstuffs. Mixed organic matter can include paper or other fiber materials (e.g., soiled napkins or paper towels), compostable resins, compostable plastics, cellulosic materials (e.g., compostable silverware), and other non-food organic materials. OMPA input can also include other types of biodegradable matter (e.g., compostable diapers).

For many implementations, OMPA input may include food matter and/or mixed organic matter that is post-consumer, post-commercial, or post-industrial in nature, matter that if not processed according to the present teachings could be considered as waste, garbage, refuse, leavings, remains, or scraps. By way of example, food that is leftover on a child's dinner plate, and not in suitable condition or quantity to be stored and served later as leftovers, can represent one example of OMPA input. As another example, items such as potato peels, apple cores, cantaloupe rinds, broccoli stumps, and so forth, and similar organic materials that are spun off from the food preparation process, can represent other examples of OMPA input.

OMPA output is defined herein as processed organics derived from transformation of organic matter processed by the OMPA to yield a ground and selectively desiccated product. The processed organics can be a substantially desiccated product having water content ranging between 0.1 and 30 percent of total weight, between 5 and 25 percent of total weight, between 5 and 20 percent of total weight, between 1 and 15 percent of total weight, between 5 and 15 percent of total weight, between 10 and 15 percent of total weight, between 10 and 20 percent of total weight, between 15-20 percent of total weight, or between 10 and 25 percent of total weight. Alternatively, the processed organics can be a substantially desiccated product having water content of less than 15 percent of total weight, less than 10 percent of total weight, or less than 5 percent of total weight. The processed organics can exist as granulated or ground media. One type of processed organics can be FOOD GROUNDS™.

As defined herein FOOD GROUNDS™ refers to an OMPA output characterized as having a minimum nutritional value. FOOD GROUNDS™ can be derived from OMPA input comprised of a minimum percentage of food matter such that the FOOD GROUNDS™ OMPA output has the minimum nutritional value. The minimum percentage of food matter can ensure that the FOOD GROUNDS™ OMPA output attains at least the minimum nutritional value. For example, a higher nutrient value OMPA output can be more readily obtained from food matter than from mixed organics such as fiber materials and cellulosic materials.

As defined herein, an OMPA output processor repurposes the OMPA output for a commercial purpose. For example, the OMPA output can be used as feed or feedstock for feed for animals or fish. In some embodiments, an OMPA output processor that receives FOOD GROUNDS™ may produce a derivative product having a higher intrinsic value (e.g., nutritional, monetary, or both nutritional and monetary) than a derivative product produced primarily from mixed organics.

As defined herein, non-processed matter refers to matter that is not intended for processing by an OMPA or an OMPA output processor. Non-processed matter is not an OMPA input or an OMPA output. An example of non-processed matter can include inorganic matter such as, for example, metals, plastics, glass, ceramics, rocks, minerals, or any other substance that is not linked to the chemistry of life. Another example of non-processed matter can be yard waste such as grass clippings, leaves, flowers, branches, or the like. In very general terms, non-processed matter can refer to the garbage or waste that a resident or business disposes in a conventional trash bin for transport to a landfill processor, a recycle bin for transport to recyclables processor, or a yard waste bin for transport to a yard waste processor.

In one embodiment, the OMPA is designed to be used primarily in a residential context (e.g., in single family homes, townhouses, condos, apartment buildings, etc.) to convert residential based OMPA input into residential sourced OMPA output. Converting residential generated OMPA input to OMPA output can have a net positive effect in the reduction of methane and space occupied by landfills or compost centers by redirecting the OMPA input and the OMPA output thereof away from traditional reception centers of such material. Moreover, because the OMPA is user friendly, aesthetically pleasing, energy efficient, clean, and substantially odor free, the OMPA provides an easy to use platform for the residential sector to handle OMPA input (e.g., food scraps, etc.), thereby making the decision on what to do with residential based OMPA input an easier one to handle. The OMPA can convert OMPA input into FOOD GROUNDS overnight, where the FOOD GROUNDS are substantially odorless, easily transportable, and shelf-stable. The FOOD GROUNDS can remain in the OMPA until it is full, at which point the FOOD GROUNDS are removed and transported to an OMPA processing facility, which may convert the FOOD GROUNDS into a higher value food product (e.g., animal feed). It should be understood that OMPAs can be used to serve entire communities, cities, and industries. Use of OMPAs in these other sectors, as well as the residential sector, can result in diversion from landfills and further serve a goal of preventing OMPA input from becoming waste in the first place by converting it into usable products that can be used to enable more resilient, sustainable food systems.

### Overview of Organic Matter Processing Apparatus

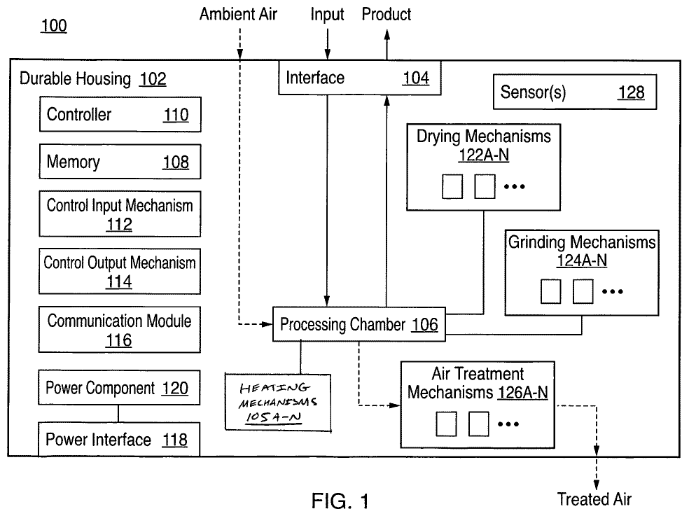

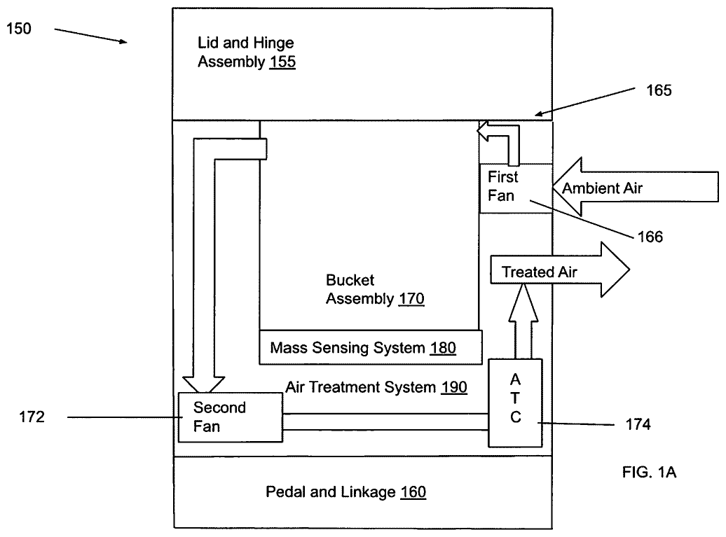

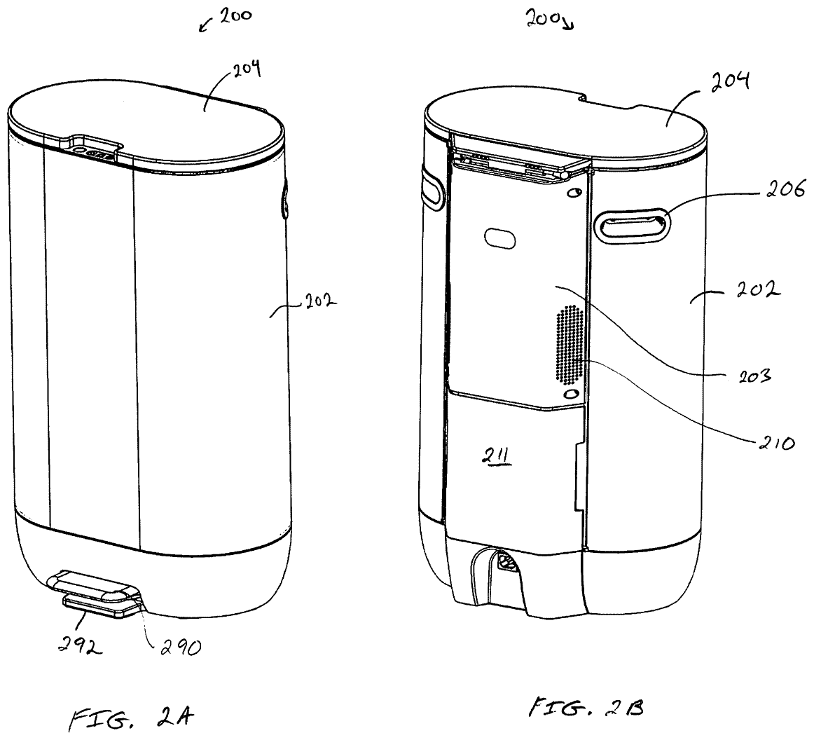

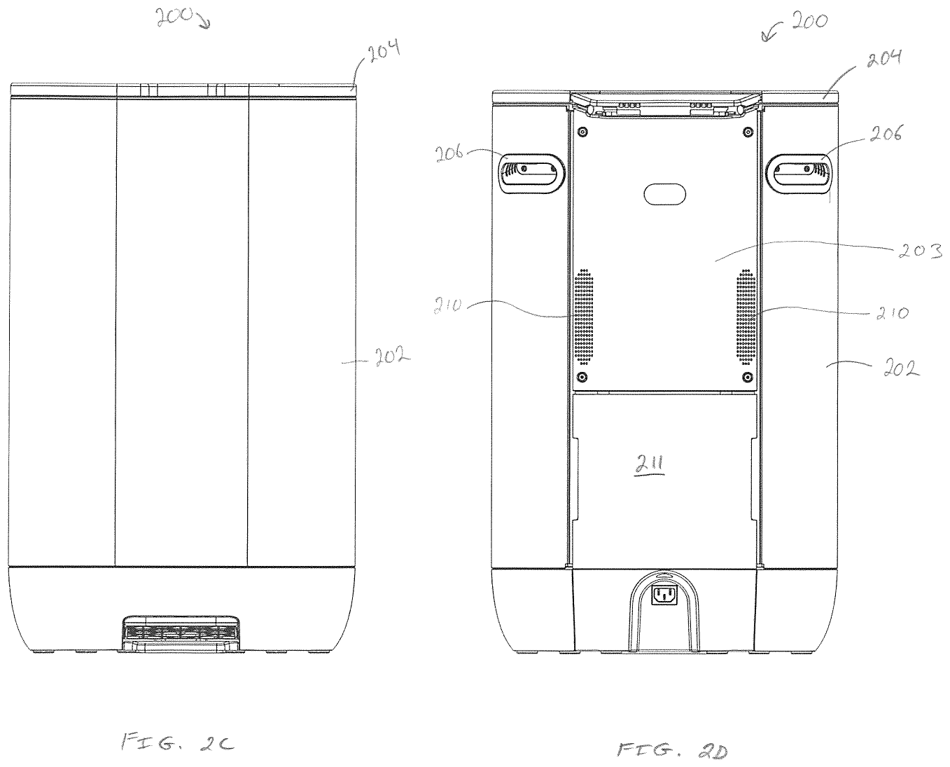

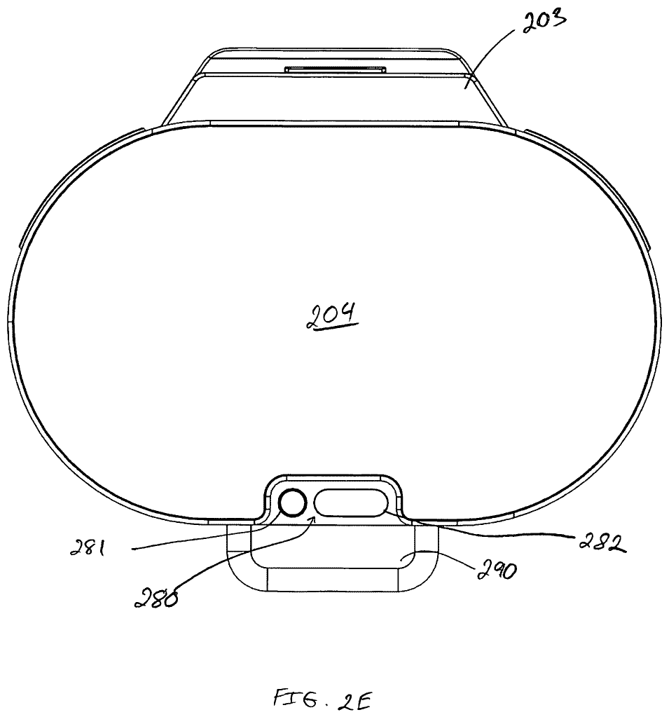

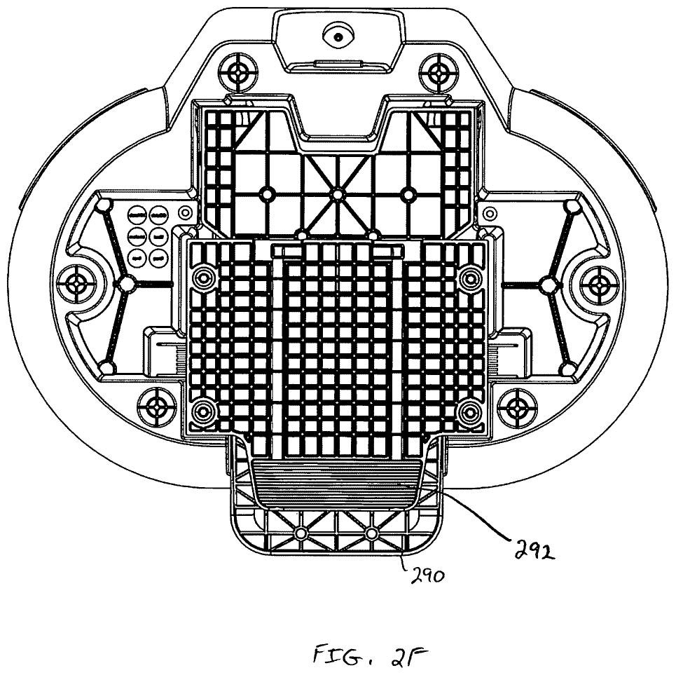

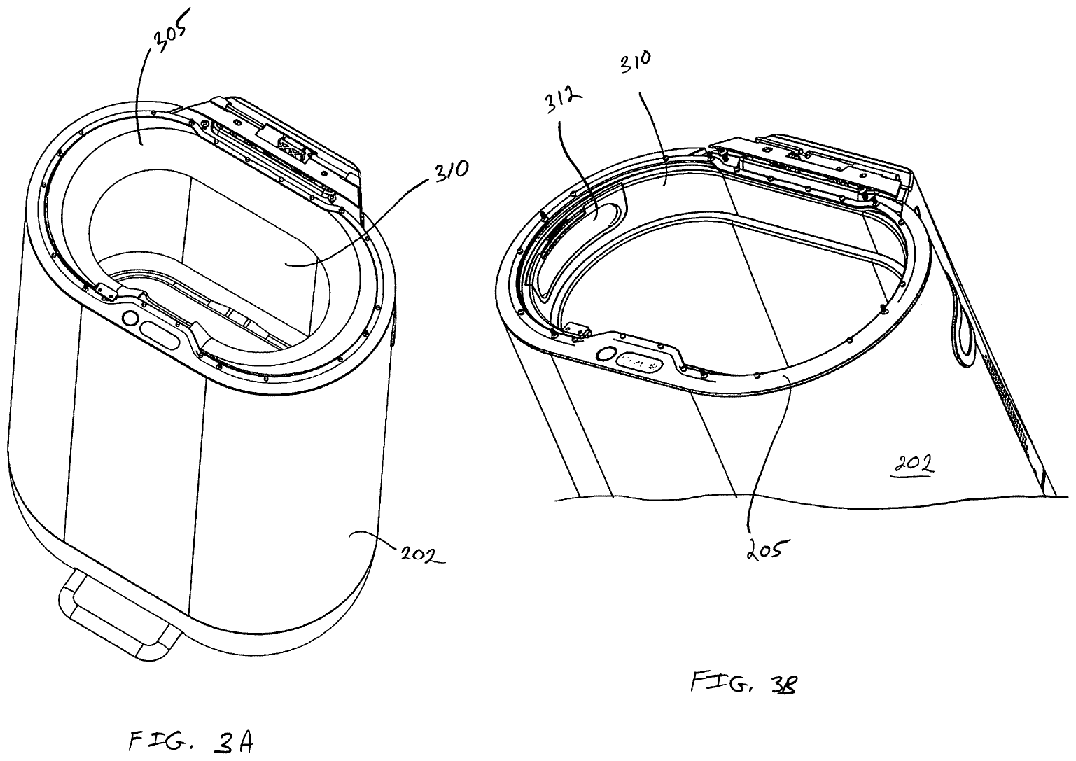

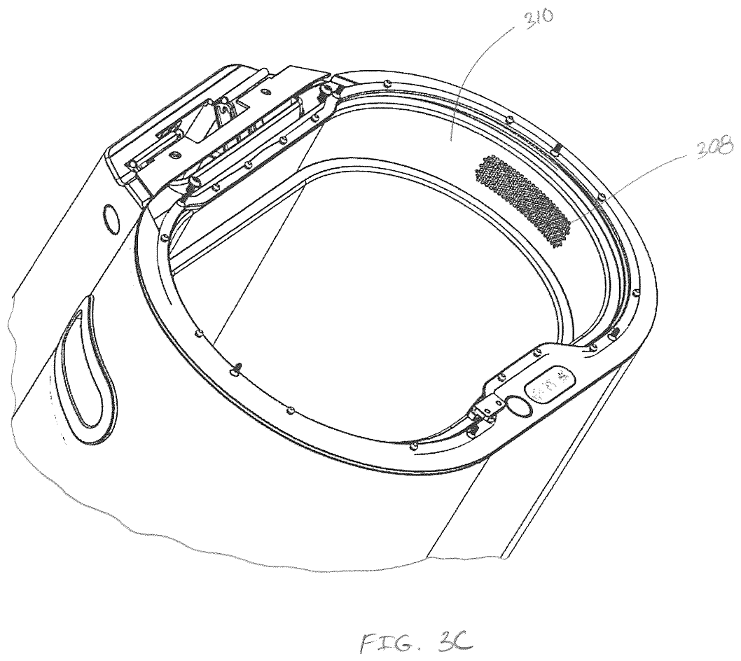

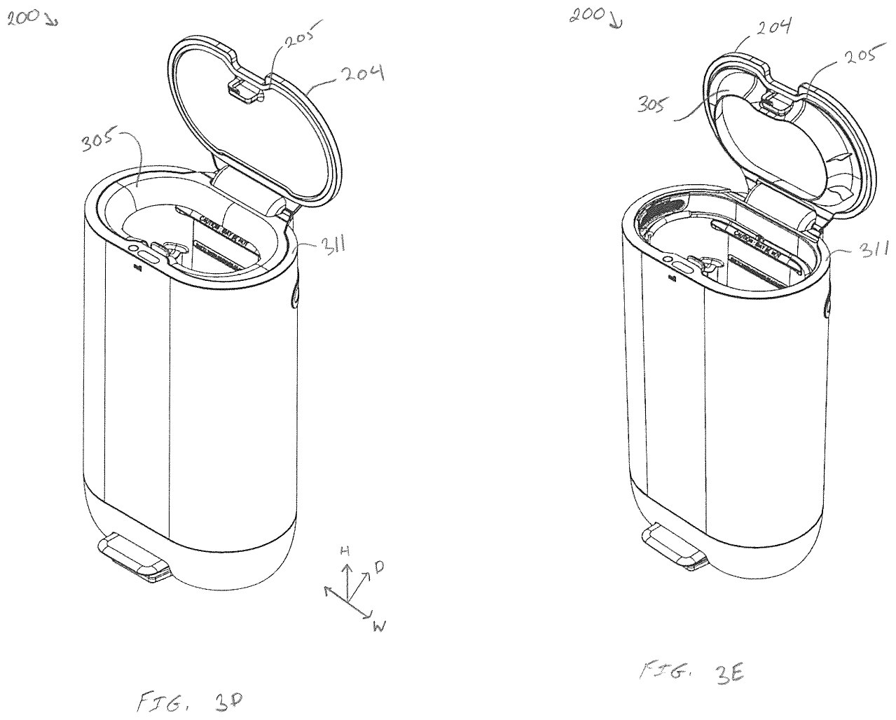

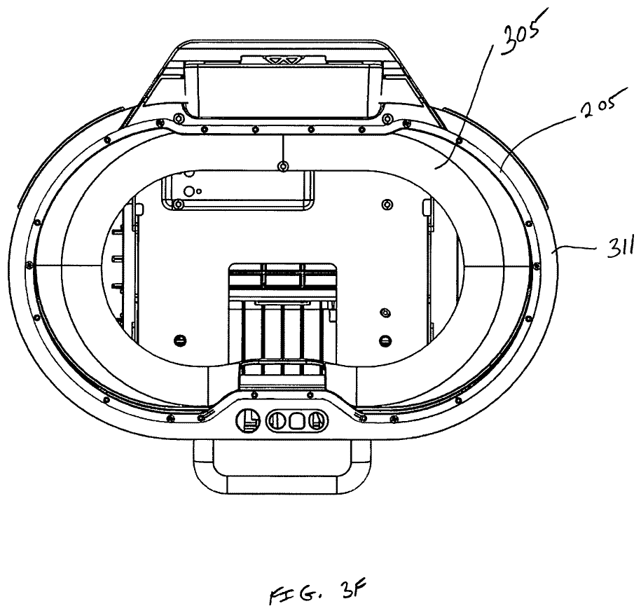

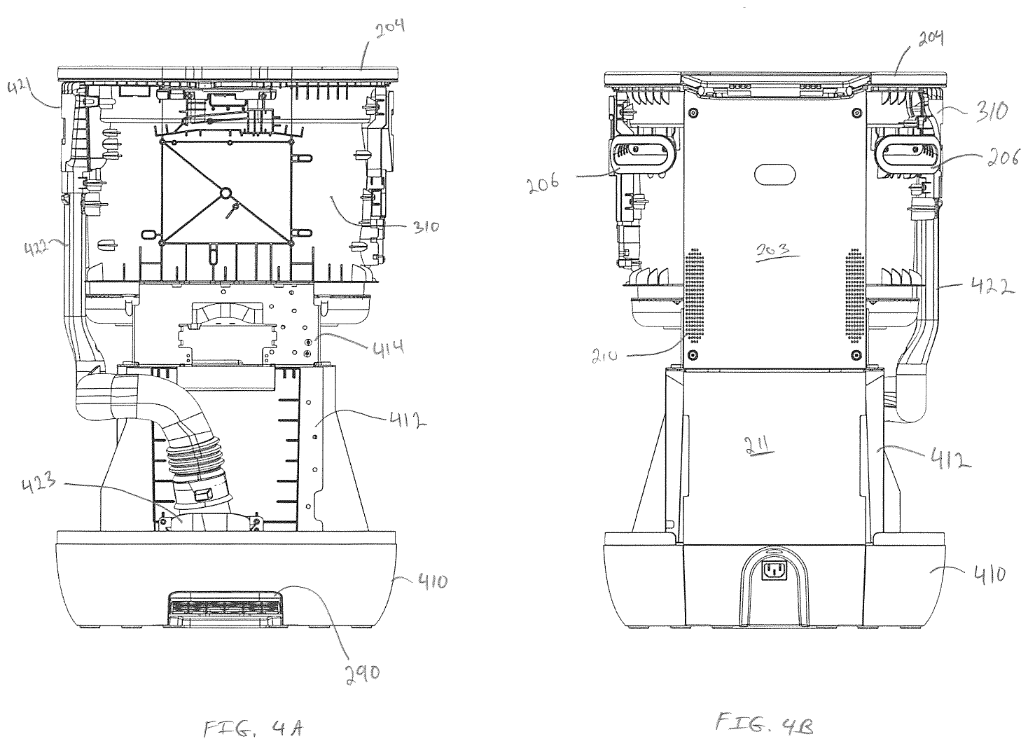

FIG. 1 includes a high-level illustration of a OMPA 100 in accordance with various embodiments. As further discussed below, OMPA 100 may have a durable housing 102 with an interface 104 through which a processing chamber 106 can be accessed. Interface 104 may serve as the ingress interface through which OMPA input can be deposited into processing chamber 106 and the egress interface through which the product can be retrieved from processing chamber 106. As shown in FIGS. 2A and 2B, the OMPA may take the form of a roughly cylindrical or elliptically shaped container that has an aperture along its top end.

Instructions for operating OMPA 100 may be stored in a memory 108. Memory 108 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by controller 110, memory 108 can also store data that is generated by OMPA 100. For example, values generated by one or more sensors 128 included in OMPA 100 may be stored in memory 108 in preparation for further analysis, as further discussed below. As further discussed below, these values may relate to characteristics (e.g., humidity or temperature) of the air traveling through OMPA 100, and insights into the OMPA input contained in processing chamber 106 can be gained through analysis of these values. Note that memory 108 is merely an abstract representation of a storage environment. Memory 108 could be comprised of actual integrated circuits (also referred to as “chips”). When executed by a controller 110, the instructions may specify how to control the other components of OMPA 100 to produce OMPA output from OMPA input in processing chamber 106. Controller 110 may include a general purpose processor or a customized chip (referred to as an “application-specific integrated circuit” or “ASIC”) that is designed specifically for OMPA 100.

Generally, OMPA 100 is able to operate on its own. Assume, for example, that OMPA 100 determines that OMPA input has been deposited into processing chamber 106 based on measurements output by a weight sensor (also referred to as a “mass sensor”), as further discussed below. In response to such a determination, OMPA 100 may initiate processing of the OMPA input. Note, however, that the OMPA input need not necessarily be processed immediately. For example, OMPA 100 may not dry and then grind the OMPA input until a given criterion (e.g., time of day, weight of OMPA input, etc.) or combination(s) of various criteria is/are satisfied.

While OMPA 100 may be able to operate largely, if not entirely, on its own, there may be some situations where input from a user will be helpful or necessary. For example, the user may want to indicate when processing should be temporarily halted so that additional OMPA input can be added to processing chamber 106. As another example, the user may request that an operation be initiated or halted. For instance, the user could opt to initiate a “drying cycle” if the ambient environment is expected to be vacant, or the user could opt to halt a “grinding cycle” if the ambient environment is expected to be occupied. The various cycles of OMPA 100 are discussed in greater detail below.

As shown in FIG. 1, OMPA 100 may include a control input mechanism 112 (also referred to as a “data input mechanism” or simply “input mechanism”) with which the user can interact to provide input. Examples of input mechanisms include mechanical buttons and keypads for tactile input, microphones for audible input, scanners for visual input (e.g., of machine-readable codes, such as barcodes or Quick Response codes), and the like. OMPA 100 may also include a control output mechanism 114 (also referred to as a “data output mechanism” or simply “output mechanism”) for presenting information to inform the user of its status. For example, control output mechanism 114 may indicate the current cycle (e.g., whether OMPA input is being processed, or whether product is ready for retrieval), connectivity status (e.g., whether OMPA 100 is presently connected to another electronic device via a wireless communication channel), and the like. One example of an output mechanism is a display panel comprised of light-emitting diodes (LEDs), organic LEDs, liquid crystal elements, or electrophoretic elements. In embodiments where the display panel is touch sensitive, the display panel may serve as the control input mechanism 112 and control output mechanism 114. Another example of an output mechanism is a speaker that is operable to output audible notifications (e.g., in response to a determination that the product is ready for retrieval).

Some embodiments of OMPA 100 are able to communicate with other electronic devices via wireless communication channels. For example, a user may be able to interact with OMPA 100 through a control platform (not shown) that is embodied as a computer program executing on an electronic device. The control platform is discussed in greater detail below with reference to FIG. 11. In such embodiments, OMPA 100 may include a communication module 116 that is responsible for receiving data from, or transmitting data to, the electronic device on which the control platform resides. Communication module 116 may be wireless communication circuitry that is designed to establish wireless communication channels with other electronic devices. Examples of wireless communication circuitry include chips configured for Bluetooth®, Wi-Fi®, ZigBee®, LoRa®, Thread, Near Field Communication (NFC), and the like.

OMPA 100 may include a power interface 118 (also referred to as a “power port” or “power jack”) that is able to provide main power for the drying and grinding functionality, as well as power for the other components of OMPA 100, as necessary. The power interface 118 may allow OMPA 100 to be physically connected to a power source (e.g., an electrical outlet) from which power can be obtained without limitation. Alternatively, power interface 118 may be representative of a chip that is able to wirelessly receive power from the power source. The chip may be able to receive power transmitted in accordance with the Qi standard developed by the Wireless Power Consortium or some other wireless power standard. Regardless of its form, power interface 118 may allow power to be received from a source external to the durable housing 102. Power interface 118 may include, for example, a plug configured to accept a power cord that can be attached and detached therefrom and can be connected to an AC outlet to supply power to OMPA 100. By enabling the power cord to be attached and detached from power interface 118, any suitable length of power cord can be used can be supplied with the OMPA. In some embodiments, a user can order a two foot, four foot, or eight food cord as needed. In addition to power interface 118, OMPA 100 may include a power component 120 that can store power received at power interface 118. Power component 118 could advantageously be useful to maintain some or all operations (e.g., the state of communications and functionality of electronic components) in the event of a power outage. Examples of power components include rechargeable lithium-ion (Li-Ion) batteries, rechargeable nickel-metal hydride (NiMH) batteries, rechargeable nickel-cadmium (NiCad) batteries, and the like.

In order to produce an OMPA output from OMPA input, OMPA 100 (and, more specifically, its controller 110) may control one or more drying mechanisms 122A-N, one or more grinding mechanisms 124A-N, and one or more heating mechanisms 105A-N. The drying mechanisms 122A-N are responsible for drying out or substantially removing moisture content of the OMPA input. Drying may not only allow the OMPA input easier to process (e.g., grind), but also may prevent the formation of mold that thrives in humid conditions. Examples of drying mechanisms include heating elements that reduce moisture by introducing heat and fans that reduce moisture by introducing airflow. Meanwhile, the grinding mechanisms are responsible for cutting, crushing, or otherwise separating the OMPA input into fragments. Examples of grinding mechanisms include paddles, mixers, impellers, and rotating blades (e.g., with two, three, or four prongs). Grinding mechanisms are normally comprised of a durable material, such as die cast aluminum, stainless steel, or another material that offers comparable strength and rigidity. Heating mechanism 105A-N may impart heat directly to processing chamber 106 to assist in drying out any OMPA input contained therein. Examples of the heating mechanism can include a hot plate that interfaces with a bottom surface of processing chamber 106. As another example, a heater may exist in an ambient air inlet path that can heat the air being forced into processing chamber 106 by one of drying mechanisms 122A-N. By working in concert, the drying, grinding, and heating mechanisms 122A-N, 124A-N, and 105A-N can convert OMPA input into a more stable product as further discussed below.

Moreover, air may be drawn from the ambient environment into the durable housing 102 and then expelled into the processing chamber 106 so as to help dry the OMPA input contained therein to desired moisture content levels, as further discussed below. As shown in FIG. 1, air that is drawn from the processing chamber may be treated using one or more air treatment mechanisms 126A-N (also referred to as “air management mechanisms” or “air discharge mechanisms”) before being released back into the ambient environment.

Other components may also be included in OMPA 100. For example, sensor(s) 128 may be arranged in various locations throughout OMPA 100 (e.g., along the path that the air travels through OMPA 100). Sensor(s) 128 may include a proximity sensor that is able to detect the presence of nearby individuals without any physical contact. The proximity sensor may include, for example, an emitter that is able to emit infrared (IR) light and a detector that is able to detect reflected IR light that is returned toward the proximity sensor. These types of proximity sensors are sometimes called laser imaging, detection, and ranging (LiDAR) scanners. Alternatively, the presence of an individual may be inferred based (i) whether sounds indicative of the user are detectable (e.g., by a passive microphone or an active sonar system) or (ii) whether an electronic device associated with the user is detectable (e.g., by the communication module 116).

OMPA 100 may adjust its behavior based on whether any individuals are nearby. For instance, OMPA 100 may change its operating state (or simply “state”) responsive to a determination that an individual is nearby. As an example, OMPA 100 may stop driving the grinding mechanisms upon determining that someone is located nearby. Thus, OMPA 100 could intelligently react to changes in the ambient environment. Over time, outputs produced by the proximity sensor (plus other components of OMPA 100) could be used to better understand the normal schedule of individuals who frequent the physical space in which OMPA is situated.

In some embodiments, OMPA 100 includes an ambient light sensor whose output can be used to control different components. The ambient light sensor may be representative of a photodetector that is able to sense the amount of ambient light and generate, as output, values that are indicative of the sensed amount of ambient light. In embodiments where control output mechanism 114 is a display panel, the values output by the ambient light sensor may be used by the controller 110 to adjust the brightness of the display panel.

In some embodiments, OMPA 100 can include one or more media capture devices such as a camera or video camera that can take pictures or videos of OMPA input inserted into the processing chamber (e.g., to identify what OMPA input item has been added), monitor conversion of OMPA input to OMPA output, or generate video shorts showing conversion of OMPA input to OMPA output for uploading to a cloud based viewing platform (e.g., TikTok™ or YouTube™) or for viewing on a propriety application running a user's device. Additional components such as IR sensors, heat sensors, and LiDAR sensors may be positioned to directly monitor contents contained in the bucket assembly. The data obtained by observing the contents of the processing chamber can be used as input to an OMPA processing algorithm that running natively on the OMPA and/or can be transmitted to a backend server that uses the data for various other purposes (e.g., data collection, metrics, to improve OMPA operations, etc.).

FIG. 1A shows a simplified illustrative block diagram of OMPA 150 and airflow paths according to an embodiment. OMPA 150 can include lid and hinge assembly 155, pedal and linkage 160, air intake assembly 165, bucket assembly 170, mass system 180, and air treatment system 190. Lid and hinge assembly 155 work in concert with pedal and linkage 160. For example, when a user depresses a pedal, a mechanical linkage is activated to cause the hinge assembly to move and thereby open the lid. Air intake assembly 165 is operative to draw ambient air into the OMPA via first fan 166 and optionally heat the ambient air before directing the air into bucket assembly 170. Bucket assembly 170 may be akin to processing chamber 106 of FIG. 1 and various bucket assembly embodiments discussed below. Mass system 180 may measure the mass of a subset of components (e.g., bucket assembly 170) of OMPA 150 and organic content contained in bucket assembly 170. Air treatment system 190 may be akin to the air treatment mechanism 126A-N. OMPA 150 has a length corresponding to an X axis, a width corresponding to a Z axis, and a height corresponding to a Y axis.

Air intake assembly 165 may be responsible for controlling a first airflow path in which ambient air is pulled into OMPA lid by first fan 166 and directed into bucket assembly 170. The first air flow path forces air into bucket assembly 170 to assist bucket assembly 170 in drying any OMPA input that is being processed therein. Air intake assembly 165 may optionally preheat the ambient air using a heater (not shown) prior to directing the air into bucket assembly 170. The heated air may further assist bucket assembly 170 with processing OMPA input to produce OMPA output. Heating the ambient air may also reduce the moisture content of the air being injected into bucket assembly 170 and the moisture of the air being treated by air treatment system 190. Reducing the moisture content of the air circulating in the OMPA can improve efficiency of OMPA input processing and air treatment.

Air treatment system 190 may be responsible for controlling a second airflow path in which untreated air is drawn from bucket assembly 170 by second fan 172 and directed through air treatment chamber (ATC) 174, which converts the untreated air to treated air that is exhausted away from OMPA 150. As defined herein, untreated air refers to air that has been in the vicinity of bucket assembly 170 and has potentially been imparted with particles or compounds that have odorous qualities. As defined herein, treated air refers to air that been “scrubbed” or “cleaned” of particles or compounds that have odorous qualities. Air treatment chamber 174 can be one or more of an activated carbon chamber and an ultraviolet light chamber. Air treatment system 190 may heat the untreated air using a heater (not shown) to reduce moisture content of the untreated air before the air is pushed through an activated carbon filter (not shown). The activated carbon filter can extract odor causing molecules from the air as it passes through the filter such that treated air is exhausted out of OMPA 150.

When the lid is in a closed configuration and OMPA 150 is managing operations that require use of first fan 166 and second fan 172, OMPA 150 may ensure that a negative pressure differential is maintained between inlet air and exhausted air. This negative pressure differential can be achieved by operating second fan 172 at a higher airflow rate (e.g., higher cubic feet per minute (CFM)) than first fan 166. In other words, the airflow rate (or volume) of treated air exiting out of OMPA 150 is greater than the airflow rate (or volume) of ambient air being pulled into OMPA 150. This can ensure that air treatment system 190 controls the flow of air from bucket assembly 170 to the exhaust port and prevents any untreated air from prematurely exiting OMPA 150.

FIG. 2A includes a front-side perspective view of OMPA 200 that includes a lid 204 in a closed position. FIG. 2B includes a rear-side perspective view of OMPA 200. FIGS. 2C-2F show front, back, top, and bottom views, respectively of OMPA 200. The following discussion will reference one or more of FIGS. 2A-2F. Lid 204 may be pivotably connected to durable housing 202, to allow a user to easily expose and then cover a processing chamber (not shown) located inside the durable housing 202. As described further herein, OMPA 200 can be advantageously designed and configured such that it can be placed flush against a wall or other barrier in a space-saving manner, in that it does not require gapped separation from the wall, while at the same time maintaining the ability for good airflow in and out of OMPA 200.

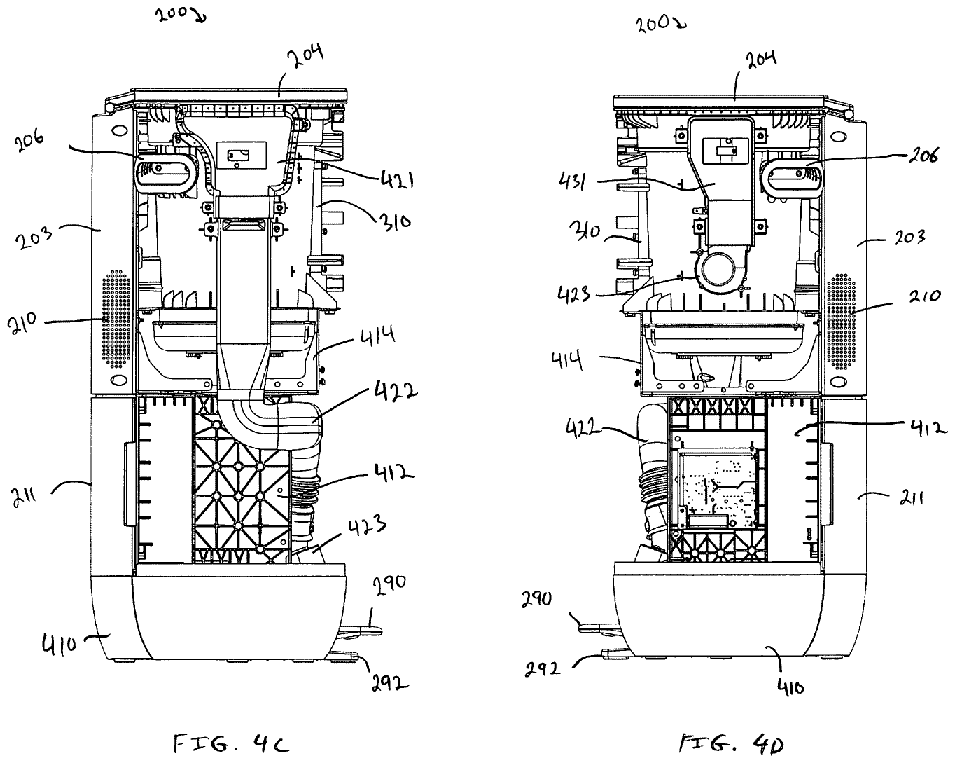

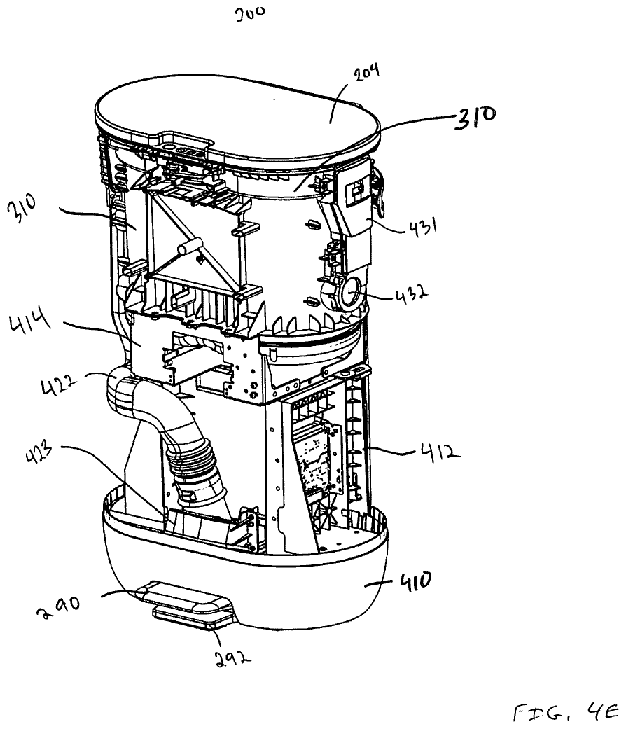

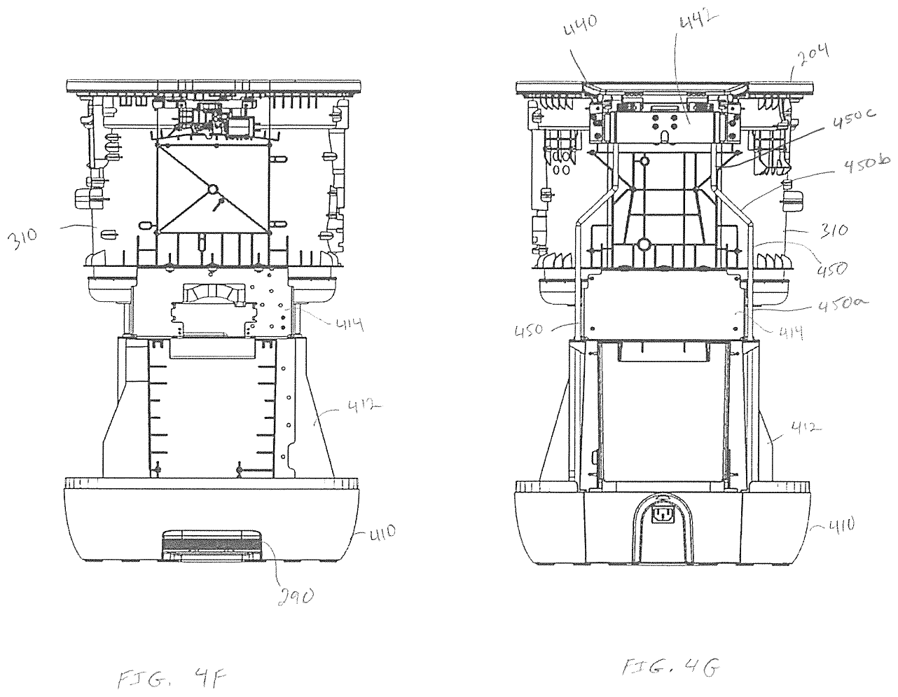

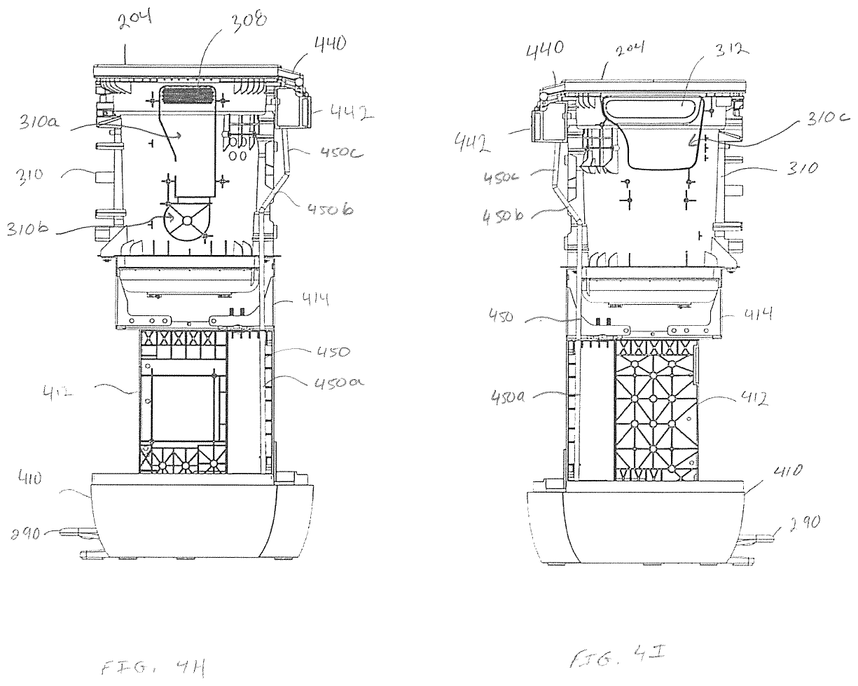

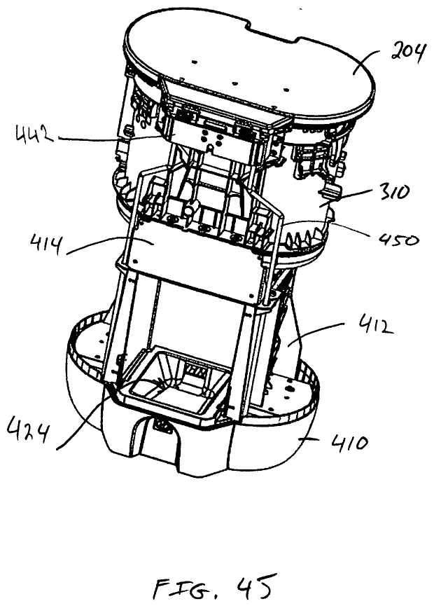

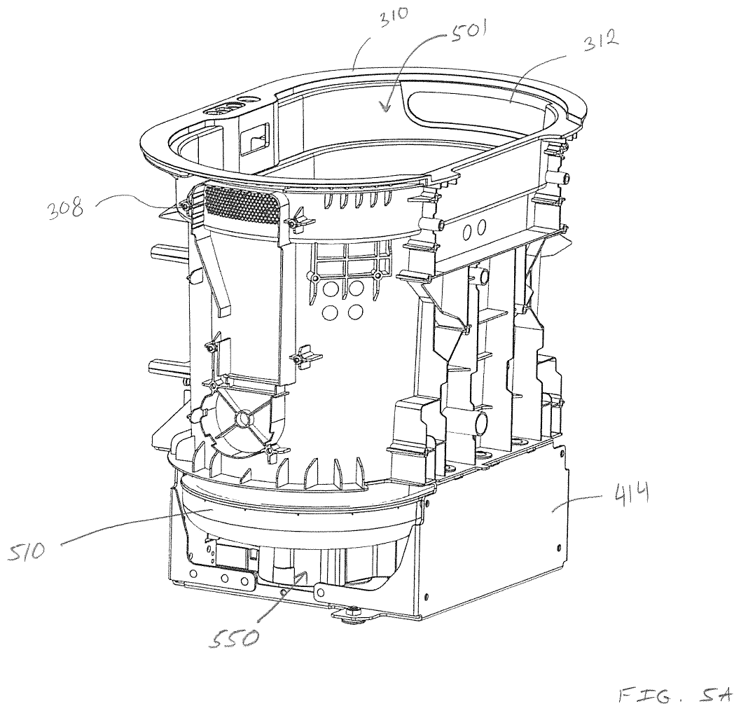

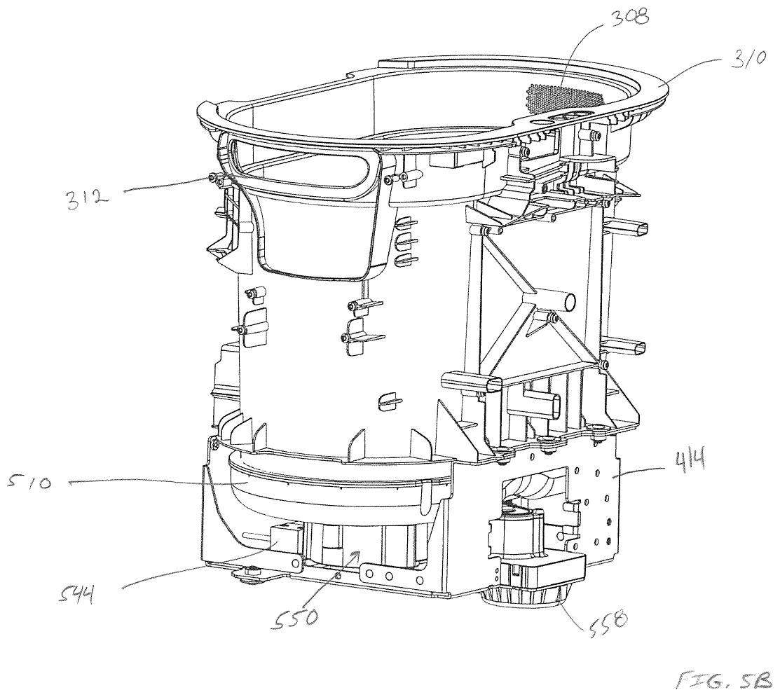

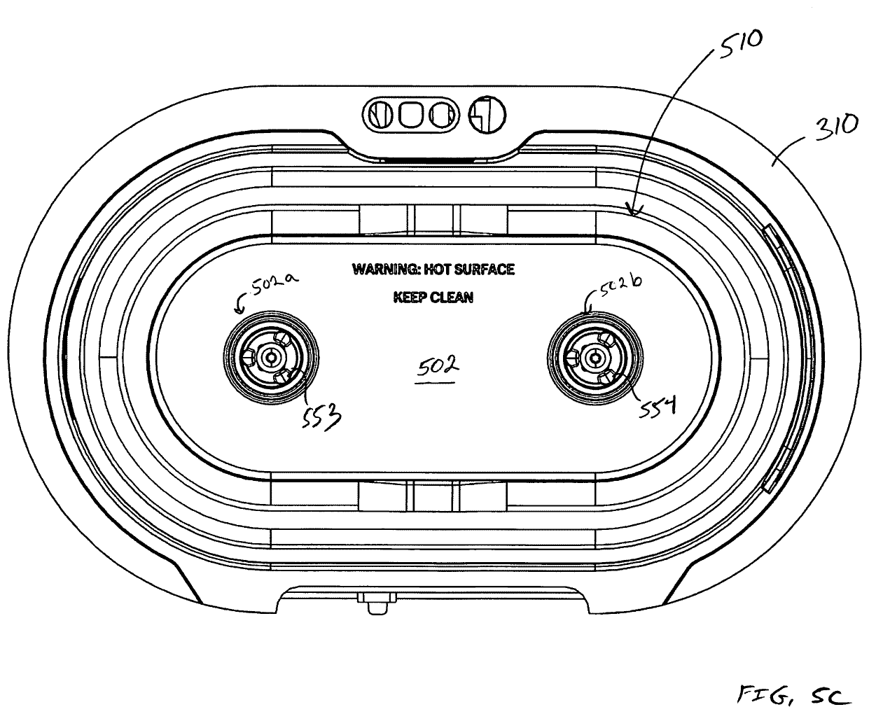

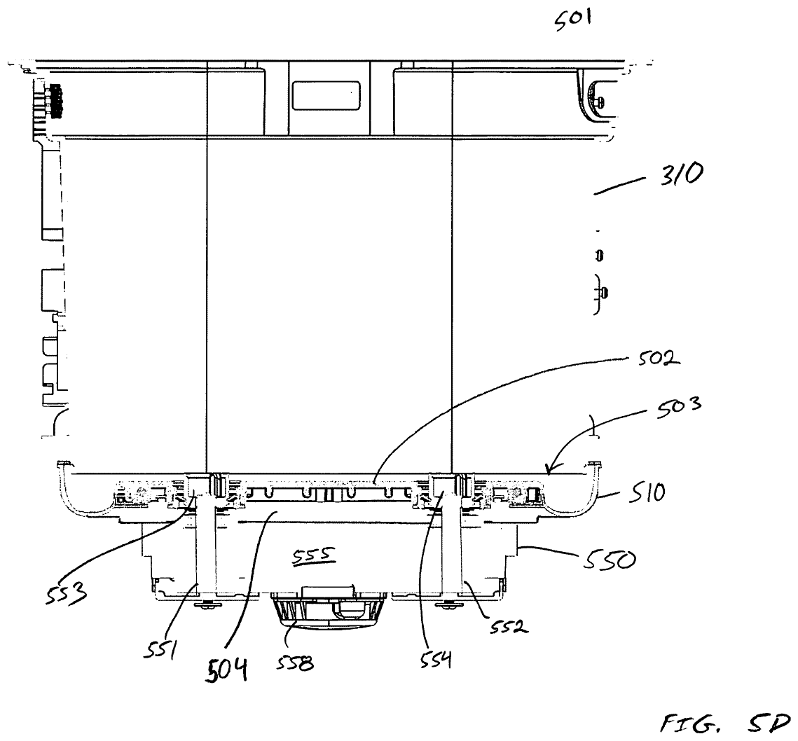

OMPA 200 can include spine member 203 that forms a backbone or column structure that is centered along the back side of OMPA 200 and projects outwardly from the elliptical shape of durable housing 202. Exhaust ports 210 may exist in spine member 203, as shown. Spine member 203 can include removable panel 211 that provides access to an air treatment media chamber (not shown) so that the air treatment media (e.g., activated carbon) can be serviced as needed. In some embodiments, removable panel 211 can be a removable drawer configured to hold the air treatment media (e.g., see FIGS. 36A-36E). OMPA 200 can include user interface region 280 that exists adjacent to lid 204 and can reside on a liner structure (e.g., shown as liner structure 310 in FIGS. 3A-3C). User interface region 280 can include button 281 and display 282. Button 281 may be user depressible to initiate several different instructions (e.g., start operation, cease operation, reset, lock and unlock a lid lock, etc.). Display 282 may include an LCD screen, a dead fronted display, any other suitable display. User interface region 280 may remain unobstructed when lid 204 is open or closed. OMPA 200 can include pedal 290 that can be depressed by a user to open lid 204. Pedal 290 may be part of a mechanical linkage that causes lid 204 to open and close. Support plate 292 may be positioned on the bottom of OMPA 200 to provide stability. As shown in FIG. 2F, support plate 292 can cover a portion of the OMPA footprint.

### Drying OMPA Input Through Airflow Generation

One core aspect of the OMPA is its ability to dry OMPA input that is deposited into the processing chamber. By removing moisture from the OMPA input through a judicious application of heating, grinding, mixing, and airflow according to the teachings herein, the OMPA can substantially halt decomposition of the OMPA input and produce a stable mass of dried-and-grinded OMPA input (hereinafter “OMPA output” or “end product” or simply “product”). This can be accomplished by directing an airflow through the processing chamber that causes the OMPA input to become increasingly dry in a predictable manner.

As shown in FIGS. 2B and 2D, housing 202 can include integrated air inlet and handle structures 206 that have one or more air ingress openings (or simply “openings”) through which air can be drawn from the ambient environment by a first fan (e.g., a fan designated for drawing air into the OMPA) installed within OMPA 200. Here, for example, integrated air inlet and handle structures 206 can be located near the top of OMPA 200 near lid 204 and on a back side of OMPA 200. Integrated air inlet and handle structures 206 can provide a handle for a user to move OMPA 200 to a desired location. Advantageously, there may be a built-in offset between a curved outer surface of air inlet and handle structures 206 and a backmost plane of the overall durable housing 202, whereby airflow into OMPA 200 will not be impeded even while the backmost plane is flush against a wall. As shown, air inlet and handle structures 206 are positioned on the backside of housing 202 and adjacent to spine member 203. If desired, for example, air ingress openings may be placed at different locations on OMPA 200 to ensure that sufficient air can be drawn into OMPA 200 by the first fan even if OMPA 200 is positioned proximate to an obstacle (e.g., a wall).

FIG. 3A shows a perspective view of OMPA 200 with the lid removed according to an embodiment. With removal of lid 204, bezel 305 is shown covering liner structure 310. Bezel 305 may be an ellipsoid ring that can pivot up and down, for example, in a path similar to how the lid can pivot up and down. In some embodiments, bezel 305 can be removed. Bezel 305 may assist in air flow direction and can prevent organic matter from splashing up towards the lid. Bezel 305 may also help guide OMPA input into the bucket assembly (not shown) when a user is inserting OMPA input therein. Bezel 305 is pivoted up or removed to allow for insertion and removal of a bucket assembly (not shown).

FIG. 3B shows a partial perspective view of OMPA 200 with lid and bezel 305 removed according to an embodiment. This view shows untreated air inlet port 312 contained in liner structure 310. Untreated air is drawn from the processing chamber through untreated air inlet port 312 for treatment by an air treatment system (not shown). The untreated air is pulled into the air treatment system via untreated air inlet port 312 via a second fan, treated by the air treatment system, and treated air is expelled from the OMPA via exhaust ports 210. Untreated air inlet port 312 can be covered with a removable filter, screen, a porous structure, a vent, or other structure that covers port 312 but allows air to flow through. Gasket 205 is shown to illustrate where it would be relative to bezel 305 and liner structure 310 when lid 204 is closed.

FIG. 3C show another partial perspective view of OMPA 200 with lid and bezel 305 removed according to an embodiment. This view shows openings 308 contained in liner structure 310. Ambient air pulled in from the environment external to OMPA 200 by the first fan is expelled toward the processing chamber through one or more openings 308. Bezel 305 (not shown) may direct the air downward to cause turbulence inside the processing chamber, thereby increasing the rate at which the OMPA input is dried. The speed of the first fan may be roughly proportional to the speed of the turbulent airflow. OMPA 200 may increase the speed of the first fan if quicker drying is desired.

FIG. 3D shows a perspective view OMPA 200 with lid 204 in an open position and bezel 305 still in closed position according to an embodiment. FIG. 3E shows a perspective view of OMPA 200 with lid 204 and bezel 305 open. Gasket 205 can be secured to lid 204 and extends around a periphery of lid 204 so that when lid 204 is closed, a seal can be formed between lid 204 and bezel 305 and between lid 204 and top surface 311 of liner structure 310. Bezel 305 is shown to include air redirection members, discussed in detail in connection with FIGS. 30B and 30C. FIG. 3F shows an illustrative top view of OMPA 200 with the lid removed to show how the gasket 205 overlays both top surface 311 and bezel 305, as shown.

Accordingly, referring back to FIGS. 2A-2D and FIG. 3C, the first fan may draw air through air inlet and handle structures 206 and then direct the air into the bucket via openings 308 such that air is further downward toward any OMPA input contained in the OMPA, thereby to create a turbulent airflow (also referred to as a “turbulent airstream”). This turbulent airflow may create small vortices inside the processing chamber that ensure the air continues to move across the OMPA input. The second fan can pull untreated air from the processing chamber, for processing in an air treatment system, and exhausted via exhaust ports 210.

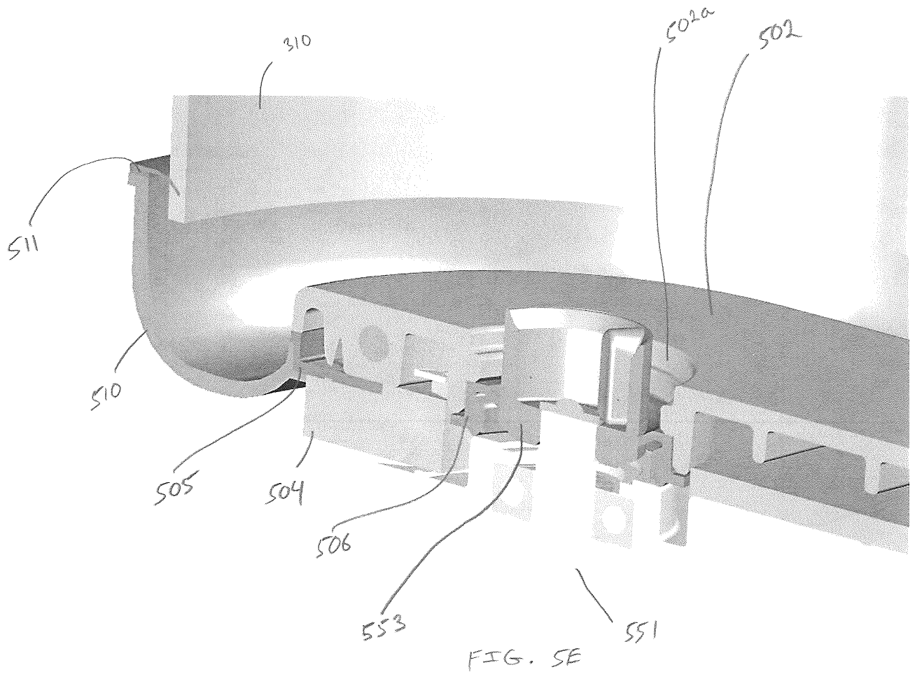

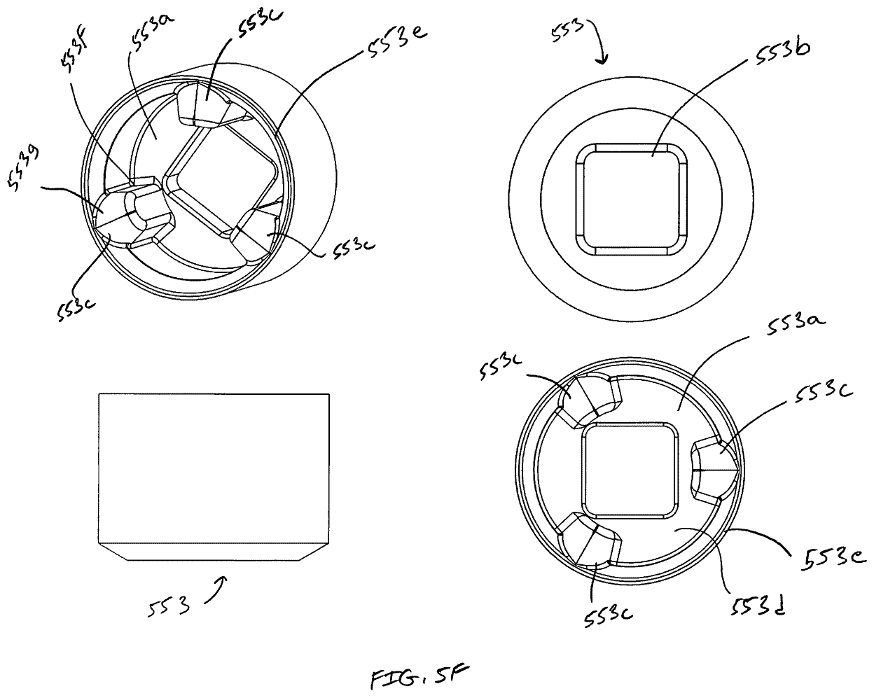

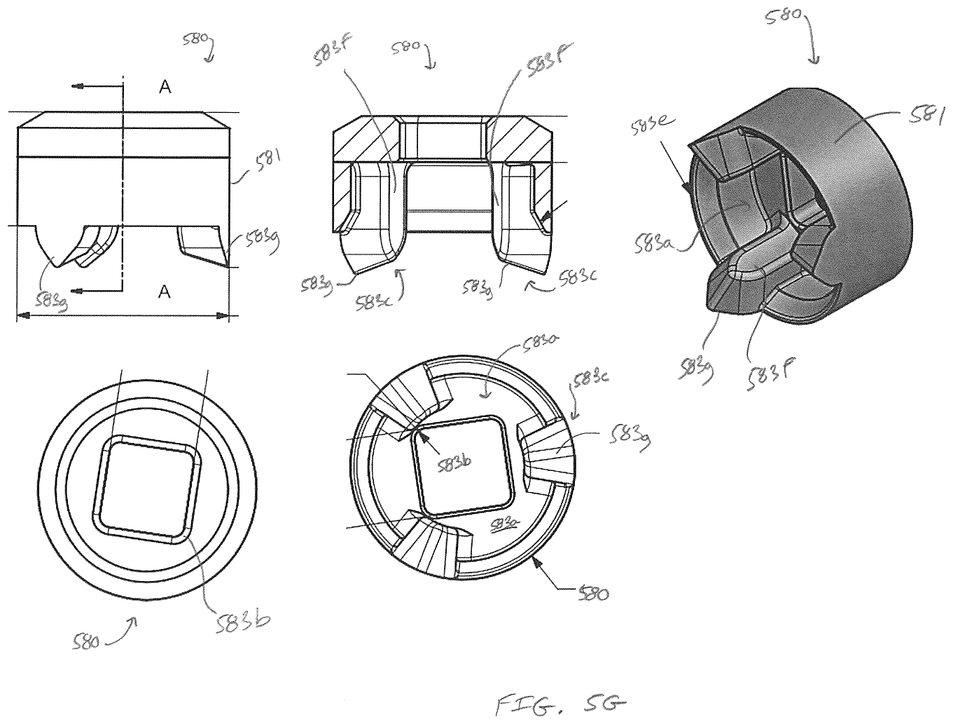

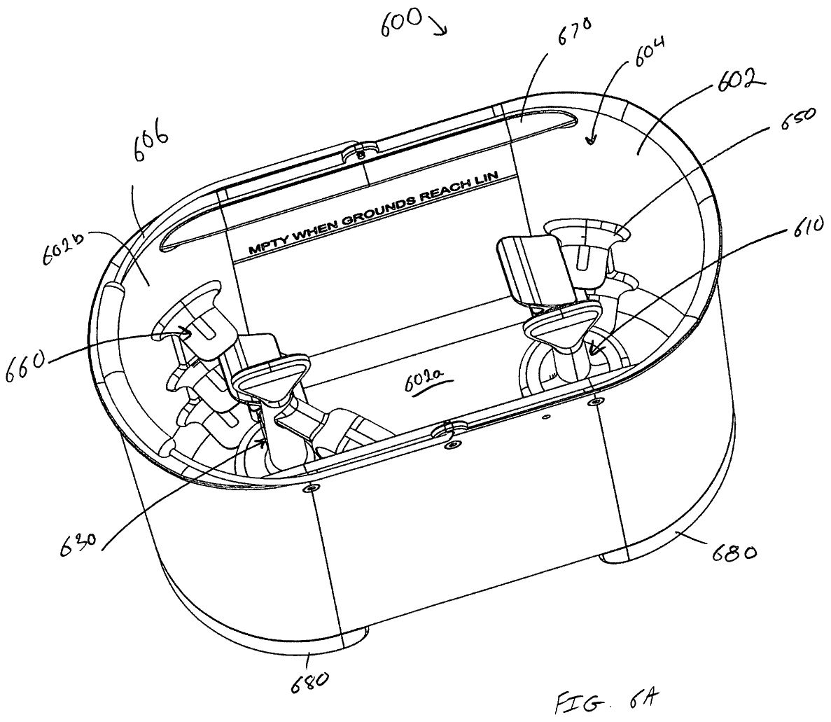

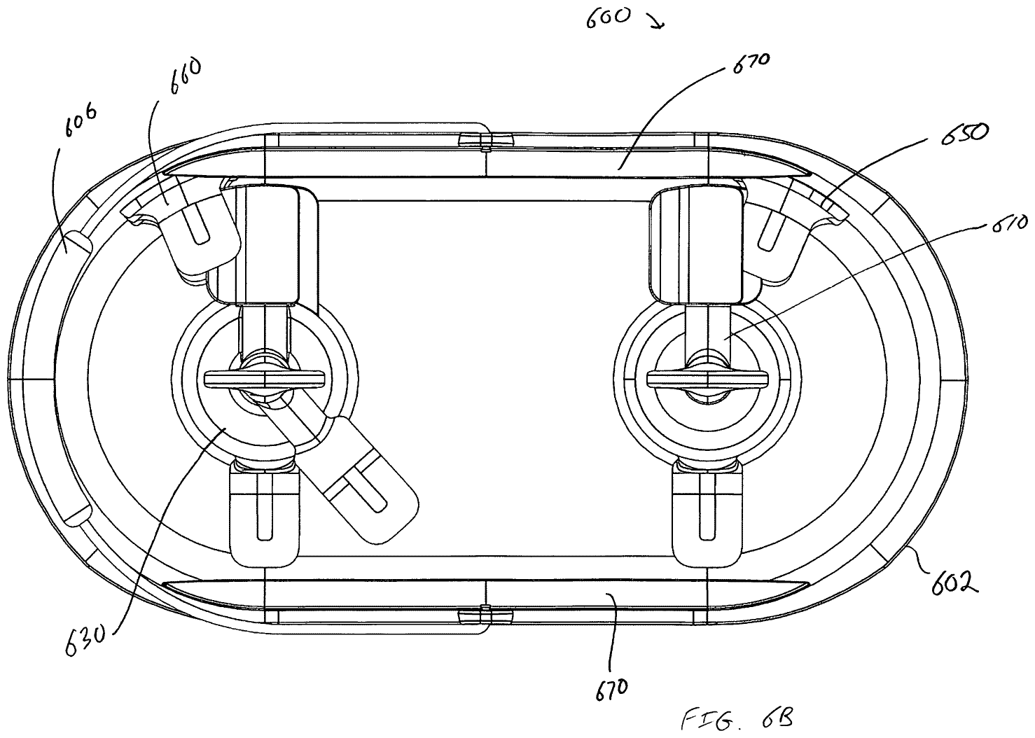

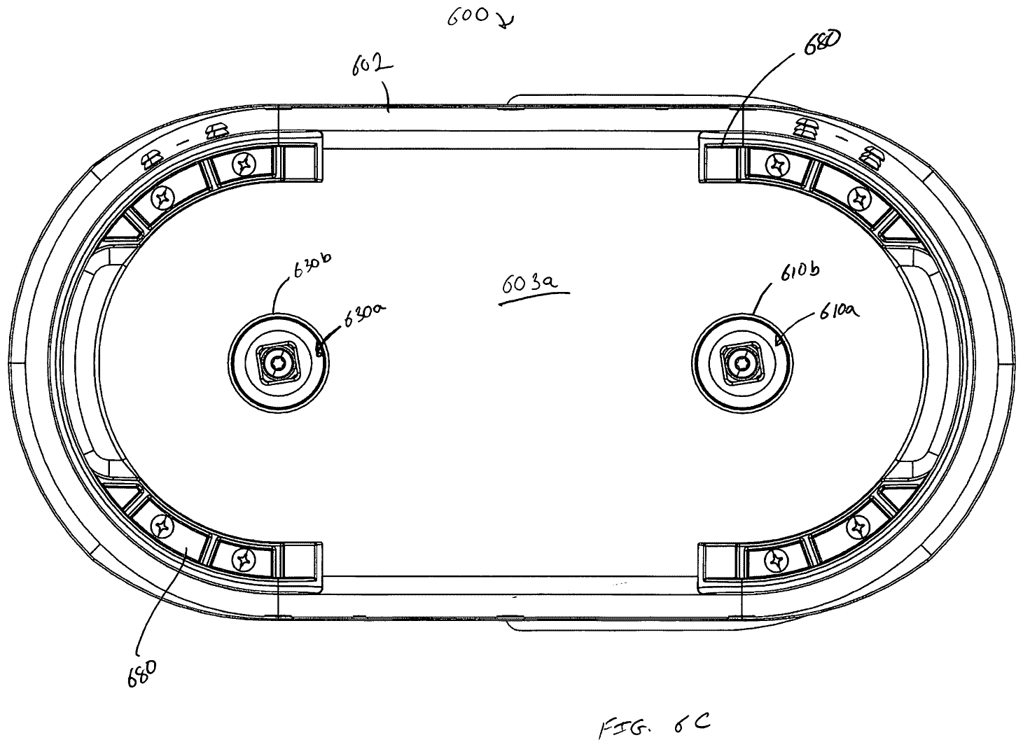

FIGS. 4A-4E show different views of OMPA 200 with the durable housing 202 removed according to an embodiment. Removing housing 202 from the figures shows various support structures and subsystems of OMPA 200 that are discussed in more detail throughout the specification. FIGS. 4F-4J show different views of OMPA 200 with housing 202, spine member 203, cover 211, air treatment components, and inlet fan components all removed. The following discussion may reference one or more of FIGS. 4A-4K. Many of the components shown in FIGS. 2A-2F and FIGS. 3A-3C are also shown in FIGS. 4A-4L, as evidenced by use of the same reference numbers. Starting at the bottom of OMPA 200 and working up to lid 204, exists housing base 410, midframe structure 412, mass bracket structure 414, and liner structure 310. These four components can form the structural framework of OMPA 200 that supports all other components and subsystems thereof. Midframe structure 412 is secured to housing base 410 and to mass bracket structure 414. Mass bracket structure 414 is secured to liner structure 310. Lid 204 is mounted to a hinge plate 440 (shown in FIGS. 4H-4I) and is configured to sit on top of liner structure 310 when in the closed position.

The air treatment subsystem can include exhaust airflow adapter 421, exhaust duct 422, exhaust fan housing 423, air dispersion manifold 424, a media chamber, sensors (not shown), and exhaust ports 210. Exhaust airflow adapter 421 is secured to liner structure 310 such that air is drawn from the bucket assembly via port 312. A gasket (e.g., rubber or foam gasket) may exist between the interface of airflow adapter 421 and liner structure 310. Exhaust duct 422 is coupled to airflow adapter 421 and can be mounted to liner structure 310. If desired, a gasket can exist at the coupling between airflow adapter 421 and exhaust duct 422. Alternatively, exhaust duct 422 may be configured to be press fit within airflow adapter 421 to form a substantially airtight seal. Exhaust duct 422 is also coupled to exhaust fan housing 423. If desired, a gasket can exist at the coupling between duct 422 and housing 423. In addition, duct 422 can be configured to be press fit around housing 423 to further create an airtight seal. Exhaust fan housing 423 can be secured to midframe structure 412. A fan (not shown) is contained in exhaust fan housing 423. This fan draws untreated air in from the bucket assembly via port 312, adapter 421, and duct 422 and redirects the air to the media chamber (not shown) by blowing the untreated air into air dispersion manifold 424, which evenly distributes the untreated air to ensure uniform airflow upwards through the media chamber. The untreated air is treated by media (e.g., activated carbon) contained in the media chamber and expelled via exhaust ports 210 as treated air. A sensor may be incorporated within airflow adapter 421 to monitor characteristics (e.g., humidity, temperature, VOCs, etc.) of exhaust air being drawn from the bucket assembly.

The air inlet system can include air intake manifold 431, fan 432, heater (not shown), and sensor (not shown). Air intake manifold 431 can be secured to liner 310 and to fan 432. Liner 310 may have integrated features that, together with manifold 431, form an air duct that conveys ambient air drawn in from fan 432 to be injected into the bucket assembly via openings 308. In one embodiment, a gasket is not needed to form a seal between manifold 431 and liner 310. Fan 432 can draw in ambient air via air inlet and handle structures 206. The heater can be selectively activated to heat ambient air prior to being injected into the bucket assembly. A sensor may be incorporated within air intake manifold 431 to monitor characteristics (e.g., humidity, temperature, VOCs, etc.) of the ambient air (or heated ambient air) being injected into the bucket assembly.

The air inlet system and the air treatment system are configured to accommodate the relatively large height to relatively small width and depth dimensions of the OMPA. The configurations can result in thinly profiled and vertically oriented systems that have minimal impact on OMPA sizing and industrial design, as generally shown in FIGS. 4A-4D. Additional details of these systems are discussed below in connection with FIGS. 29A-35.

Mass bracket structure 414 can support a mass sensor (not shown) that is designed to weigh the bucket assembly (not shown), drive train (not shown), heat plate (not shown), and other components that free float within OMPA 200 between liner structure 310 and mass bracket structure 414. The mass sensor can measure the mass of the free floating components. This is in contrast with other systems that measure the weight of the entire unit (e.g., by placing weight sensors in the feet structures supporting the device). The mass sensor arrangement of embodiments discussed herein can be less susceptible to heat, errors, zeroing issues, and other issues, and therefore can provide more accurate readings.

Linkage rod 450 may couple pedal 290 to a hinge pusher (not shown) that causes hinge plate 440 to rotate up and down depending on whether peal 290 is depressed. Hinge bracket 442 may be secured to liner structure 310 and provides support for enabling hinge plate 440, the hinge pusher (not shown), and the bezel (not shown) to rotate. If desired, the user may, after depressing pedal 290, or by manually lifting lid 204 and/or bezel 205, push lid 204 and/or bezel 205 to a locked position that keeps lid 204 and/or bezel 205 in an open locked position even if pedal 290 is not depressed. A detent structure embedded in hinge bracket 442 may interface with hinge plate 440 and/or bezel 205 to cause the lid and bezel to remain in a fixed open position.

Liner structure 310 resides in the top portion of the OMPA and provides support for the lid and lid associated components, a first fan and associated components (e.g., heater and manifold), openings 308, untreated air inlet port 312, and various other components that are attached to liner structure 310. In particular, FIG. 4H shows interface region 310a configured to receive air intake manifold 431 and interface region 310b configured to receive fan 432. FIG. 4I shows interface region 310c configured to receive exhaust airflow adapter 421.

Referring now to FIGS. 5A-5E, various perspective views, a top view, and cross-sectional views of liner structure 310, heat plate 502, overmold structure 510, mass bracket 414, load cell 544 (e.g., mass sensor), drivetrain 550, and other components are shown. An insulation layer 504 (shown in FIG. 5D) may exist between heat plate 502 and drivetrain 550 to protect drivetrain 550 and other components from relatively high hot plate temperatures (e.g., temperatures exceeding 90° C.). Heat plate 502 can include two through-holes 502a and 502b through which parts of drivetrain 550 exist. Heat plate 502 may be constructed to sit on top of a cutout portion of overmold structure 510 and on top of insulation layer 504. In some embodiments, heat plate 502 may have registration members that align with reciprocal registration structures of insulation layer 504.

The interior volume of liner structure 310 is configured to accept a bucket assembly or the processing chamber and retain the bucket assembly therein during operation of the OMPA. When the bucket assembly is inserted into liner structure 310, a bottom surface of the bucket assembly directly engages heat plate 502, registration members fit around respective portions of heat plate 502, and impeller couplers engage reciprocal couplers 553 and 554 that are connected to drivetrain 550. Heat plate 502 imparts heat into the bucket assembly during different stages of an OMPA processing cycle. Drivetrain 550 causes driveshafts 551 and 552 to rotate respective couplers 553 and 554, which cause the impeller couplers to rotate, which then cause impeller tree assemblies to rotate within the bucket assembly. Impeller tree assemblies are at least partially responsible for mixing, grinding, and cutting OMPA input.

Drivetrain 550 can include driveshafts 551 and 552, couplers 553 and 554, a gearbox 555, and motor 558. Drivetrain 550 can include various seals to prevent air leaks and/or moisture and debris penetration. For example, referring to FIG. 5E, seal 506 (e.g. a Nidec seal) may exist in through-holes 502a and 502b to prevent air from passing through heat plate 502 via couplers 553 and 554. Drivetrain 550 can be positioned below heat plate 502, insulation layer 504, and liner structure 310.

Liner structure 310, taken alone as an independent part, has a top aperture 501 and a bottom aperture 503 (shown in FIG. 5D). That is, liner structure 310 has an elliptical shaped through-hole when considered as an independent part. Bottom aperture 503 is sealed substantially airtight with a combination of heat plate 502, overmold structure 510, and various components of drivetrain 550. Overmold structure 510 surrounds the periphery of bottom aperture 503 and has a cutout to accommodate heat plate 502. An airtight seal may be achieved by gasket 511 that exists between liner structure 310 and overmold structure 510. Heat plate 502 may sit on top of the cutout and an airtight seal can be established by gasket 505 existing between overmold structure 510 and heat plate 502. Additional airtight seals 506 can exist around couplers 553 and 554 and within through-holes 502a and 502b. Maintaining an airtight seal at the bottom of liner structure 310 may be necessary to ensure untreated air is property treated by the air treatment system and that any air that is treated by the air treatment system is not fed back into liner structure 310 as undesired feedback. Furthermore, maintaining the airtight seal also supports operation of a mass sensor (e.g., mass sensor 544) responsible for measuring the mass of any contents contained in the bucket assembly. In some embodiments, the mass sensor may be sensitive to pressure changes within housing 602/bucket assembly 600, therefore it is desirable to prevent air leakage out of bucket assembly 600 or the bottom of liner structure 310 to eliminate any potential for errant mass sensor readings.

Heat plate 502 is secured to insulation layer 504. Insulation layer 504 is secured to drivetrain 550. A portion (e.g., a loading structure) of drivetrain 550 is secured to a first mounting portion of load cell 544. A second mounting portion of load cell is secured to mass bracket structure 414. Load cell 544 can function as a cantilevered strain gauge in which the second mounting portion is anchored to mass bracket structure 414 and the first mounting portion supports the mass of drivetrain 550, insulation layer 504, heat plate 502, overmold structure 510, and the bucket assembly (when said bucket assembly is inserted into liner structure 310). In this configuration, the combination of drivetrain 550, insulation layer 504, heat plate 502, overmold structure 510, and the bucket assembly (when inserted into liner structure 310) float relative to liner structure 310 and mass bracket structure 414, and load cell 544 can measure the mass thereof. For example, when the bucket assembly is inserted into liner structure 310 and a user adds OMPA input, load cell 544 can detect how much mass is added.

FIG. 5F shows multiple views of drivetrain coupler 553 or 554 according to an embodiment. Coupler 553 is designed to receive a reciprocal impeller coupler (e.g., coupler 615 of FIG. 7). Coupler 553 can have a cylindrical shape having cavity portion 553a, through-hole 553b (e.g., shaped as a square), three rib structures 553c that are each spaced 120 degrees away from each other within cavity portion 553a. Each rib structure 553c can span the depth of cavity portion 553a such that it extends from bottom wall 553d to aperture 553e. In addition, each rib structure 553c has a cuboid portion 553f and a partial pyramid portion 553g that are both integrally formed as part of the interior wall of cavity portion 553a. Cuboid portion 553f spans from bottom wall 553d and transitions to partial pyramid portion 553g. Partial pyramid portion 553g can terminate at aperture 553e. In addition, partial pyramid portion 553g can guide a respective impeller coupler into place when the bucket assembly is inserted into the liner structure. Coupler 553 or 554 can be constructed from a metal such as stainless steel or aluminum.

FIG. 5G shows multiple views of another drivetrain coupler 580 according to an embodiment. Coupler 580 can have a cylindrical shape having cavity portion 583a, through-hole 583b (e.g., shaped as a square), three rib structures 583c that are each spaced 120 degrees away from each other within cavity portion 583a. Each rib structure 583c can span the depth of cavity portion 583a such that it extends from bottom wall 583d to beyond aperture 583e. In addition, each rib structure 583c has a cuboid portion 583f and a partial pyramid portion 583g that both integrally formed as part of the interior wall of cavity portion 583a. Cuboid portion 583f spans from bottom wall 583d and transitions to partial pyramid portion 583g. Partial pyramid portion 583g can extend beyond side wall 581 and aperture 583e. In addition, partial pyramid portion 583g can guide a respective impeller coupler into place when the bucket assembly is inserted into the liner structure. Coupler 580 can be constructed from a metal such as stainless steel or aluminum. Drivetrain coupler 580 is similar to couplers 553/554 but has reduced side wall 581 height such that partial pyramid portions 583g of each rub structure 583c extend beyond side wall 581 and aperture 583e. The configuration of coupler 580 can result in more tooth on tooth interfacing when the bucket is inserted into the OMPA, thereby providing for more consistent bucket alignment as the partial pyramid portions of each rib guide the respective ribs of the bucket couplers into place. The use of coupler 580 or coupler 553, in conjunction with an autorotation feature, can ensure that the bucket and drivetrain couplers are properly seated with respect to each other when the bucket is inserted into the OMPA.

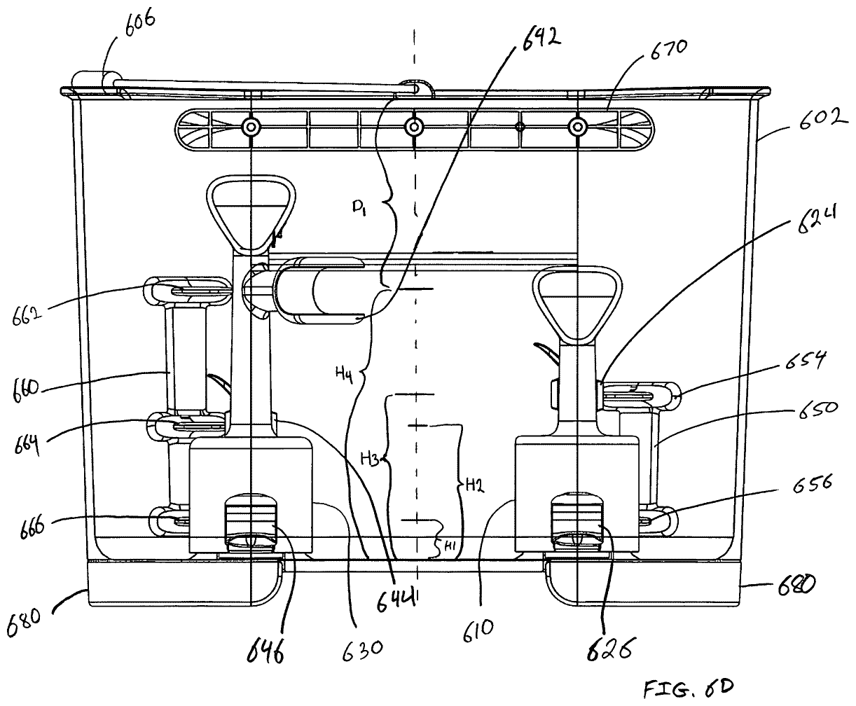

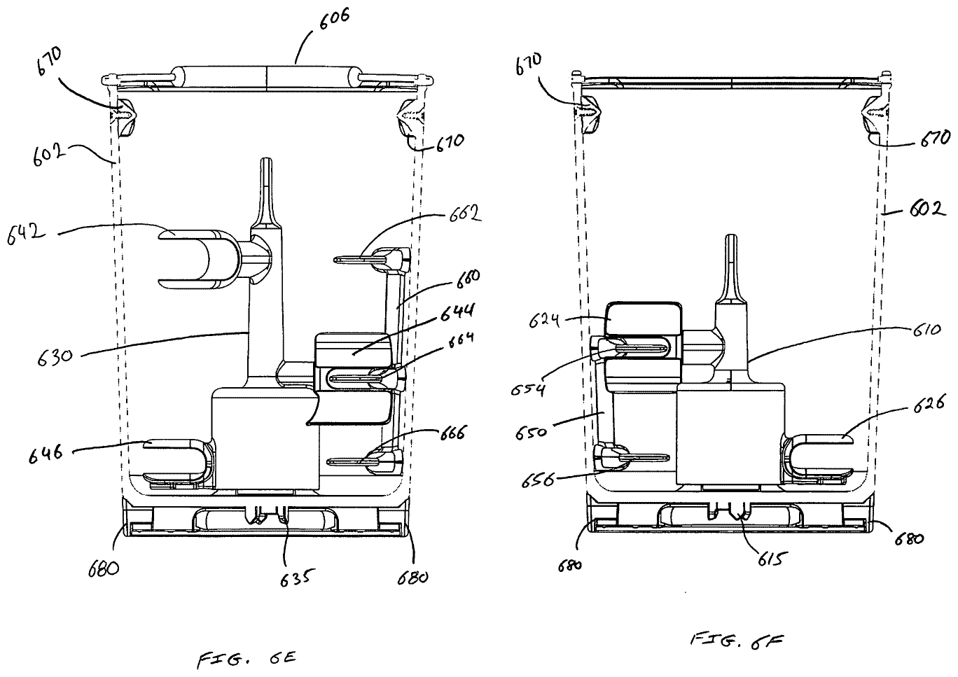

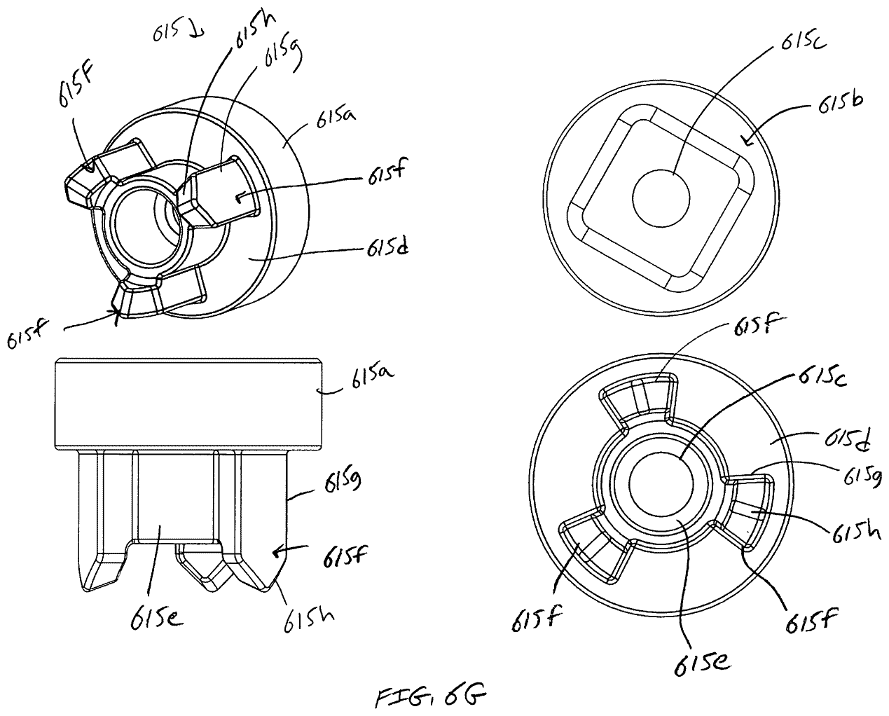

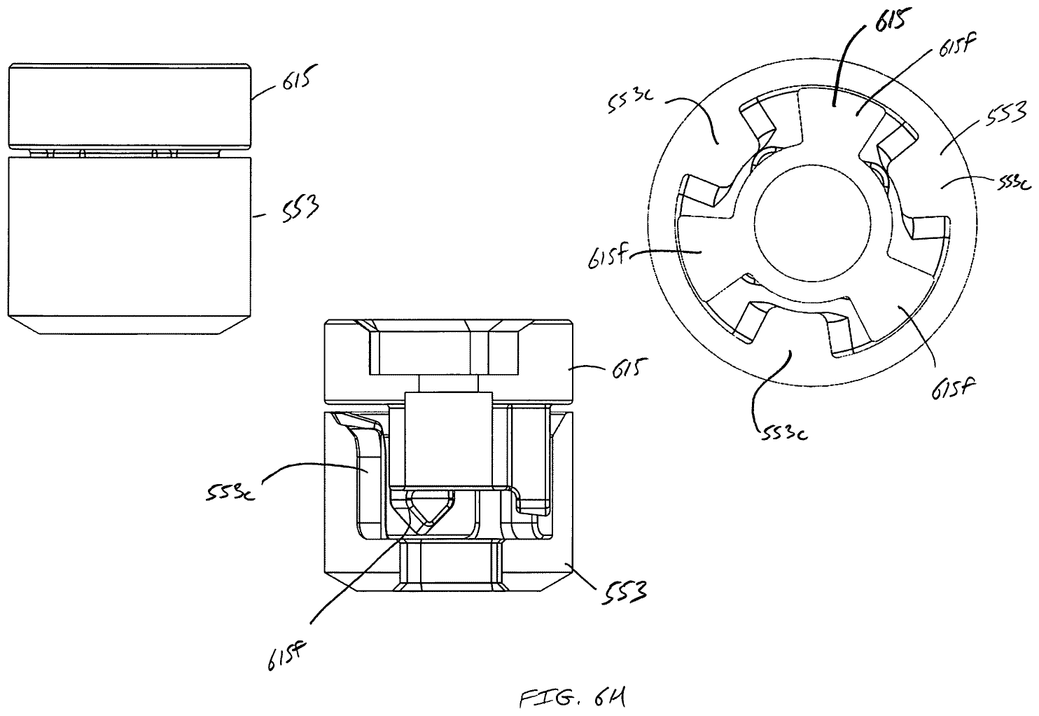

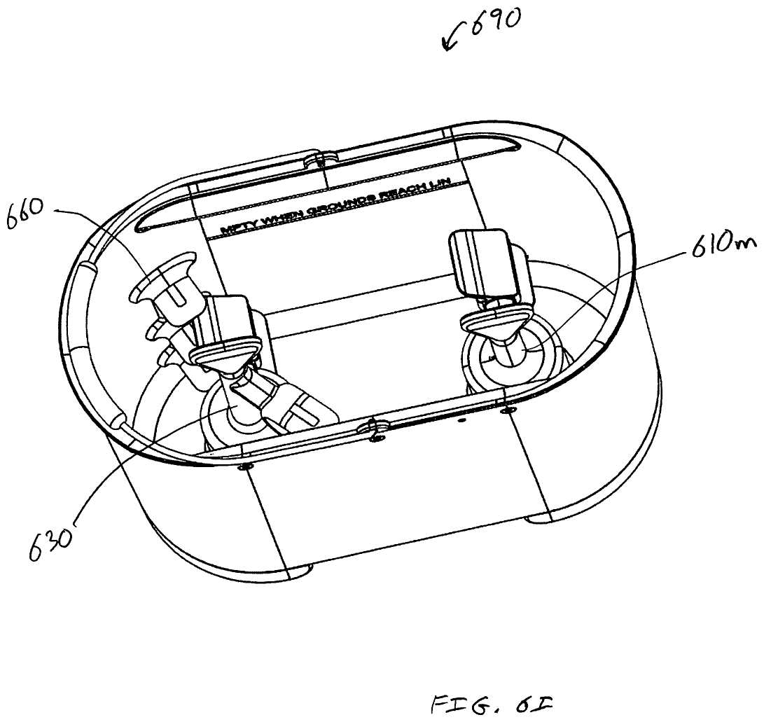

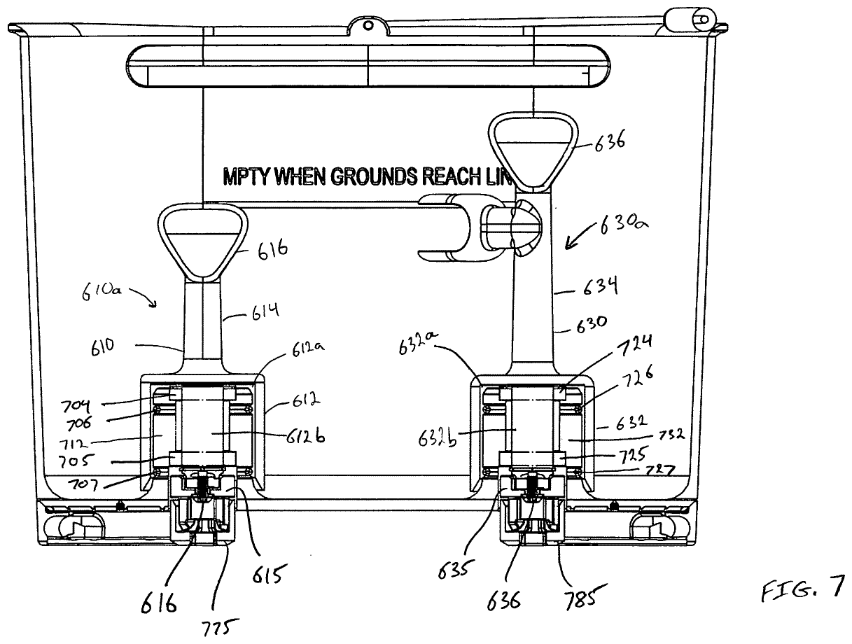

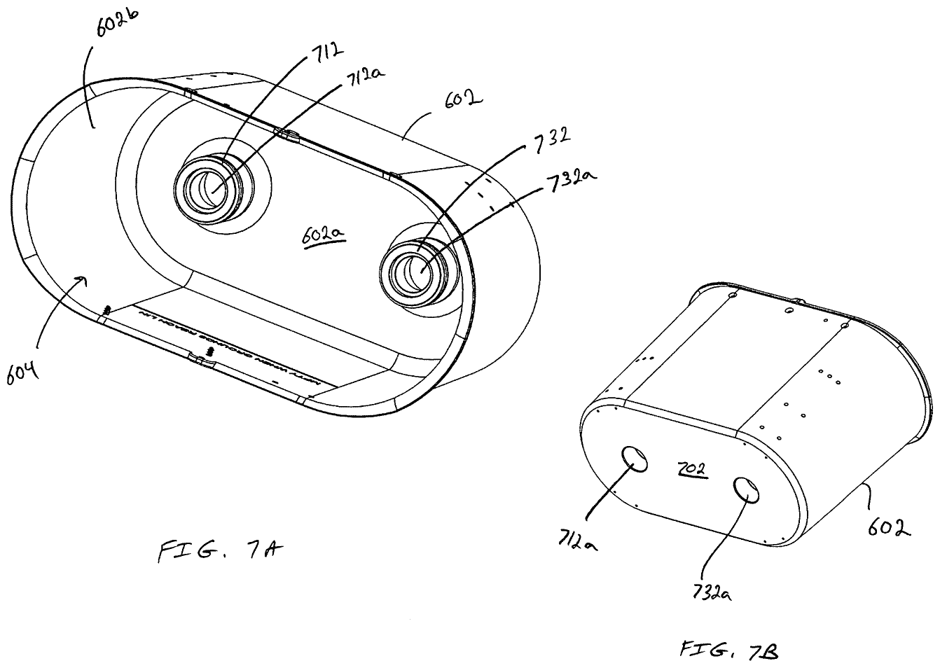

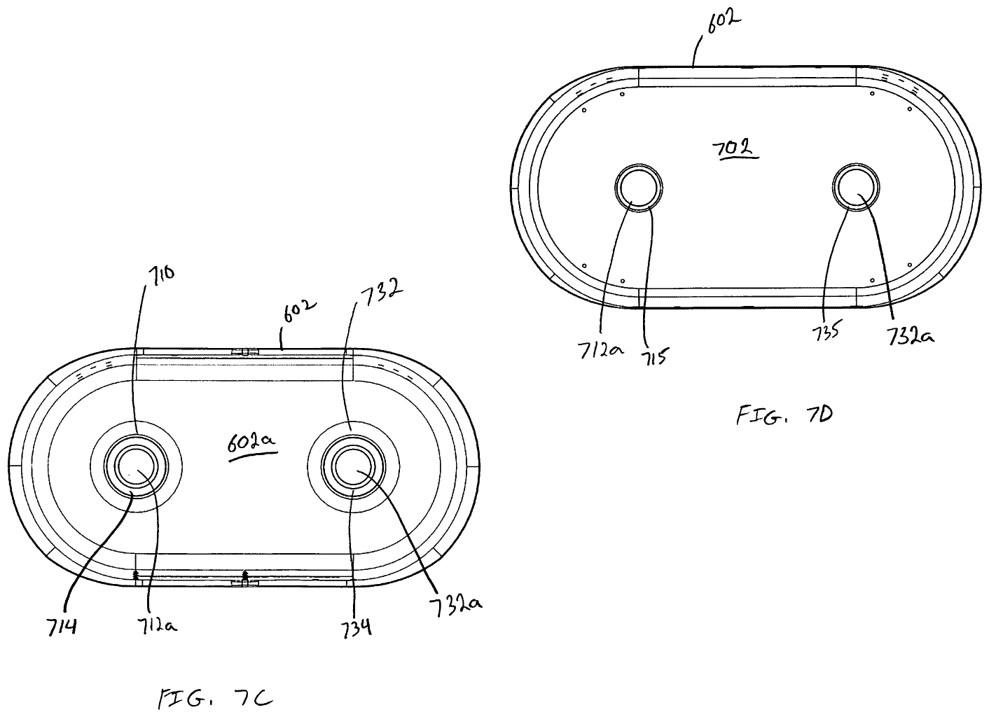

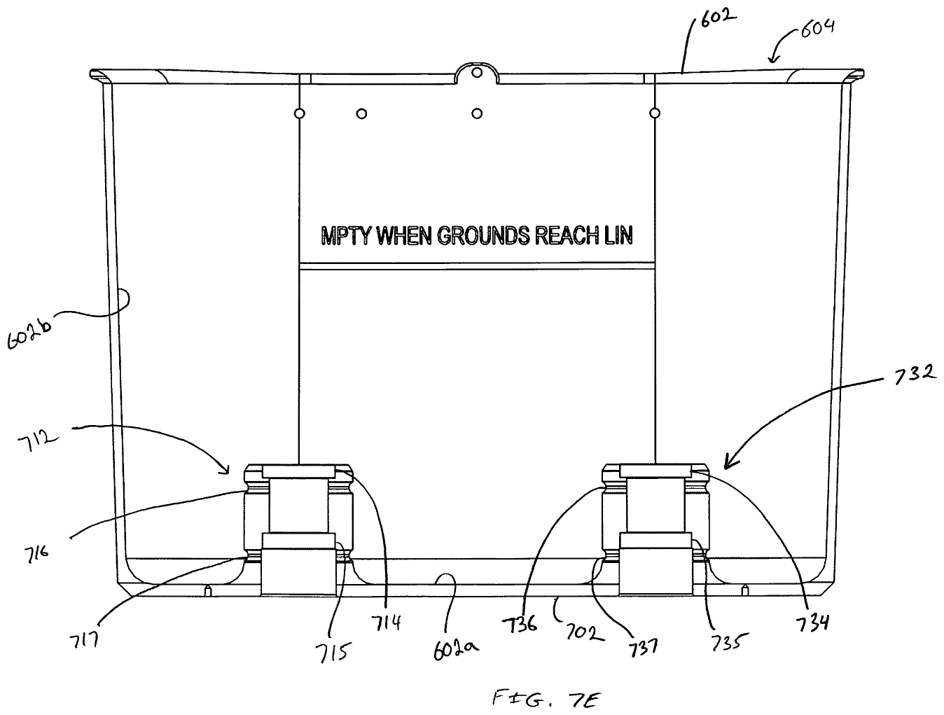

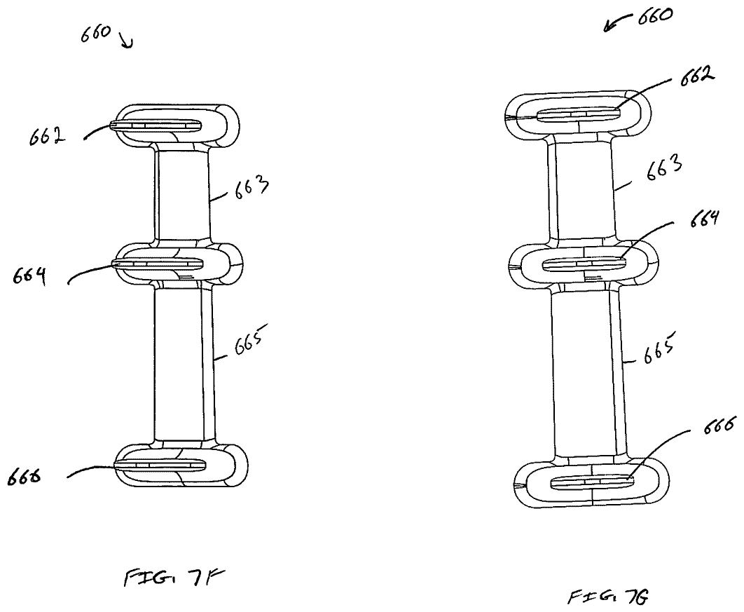

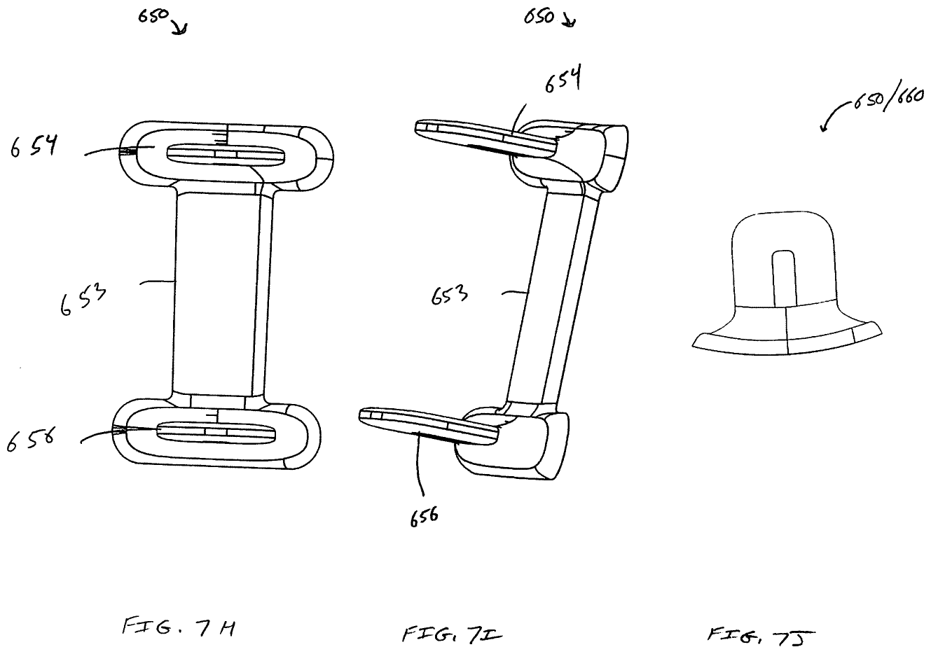

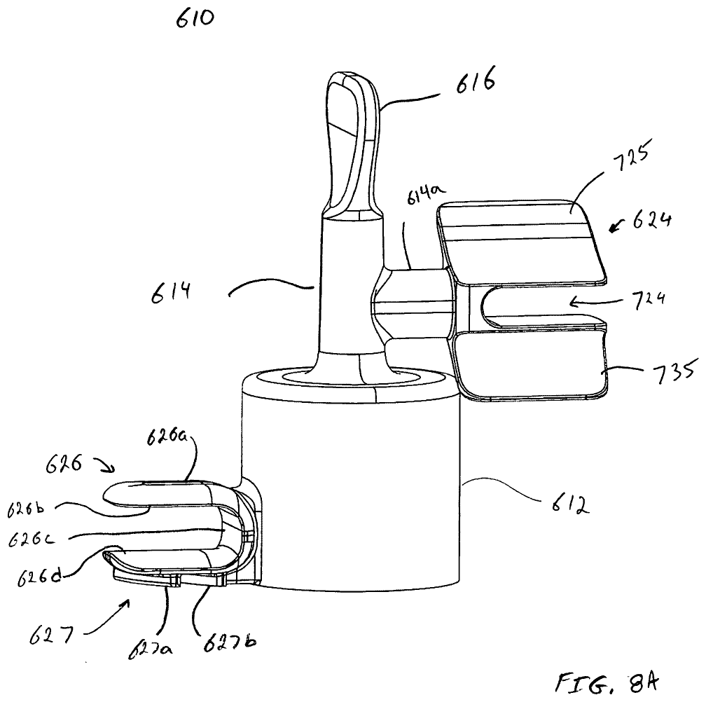

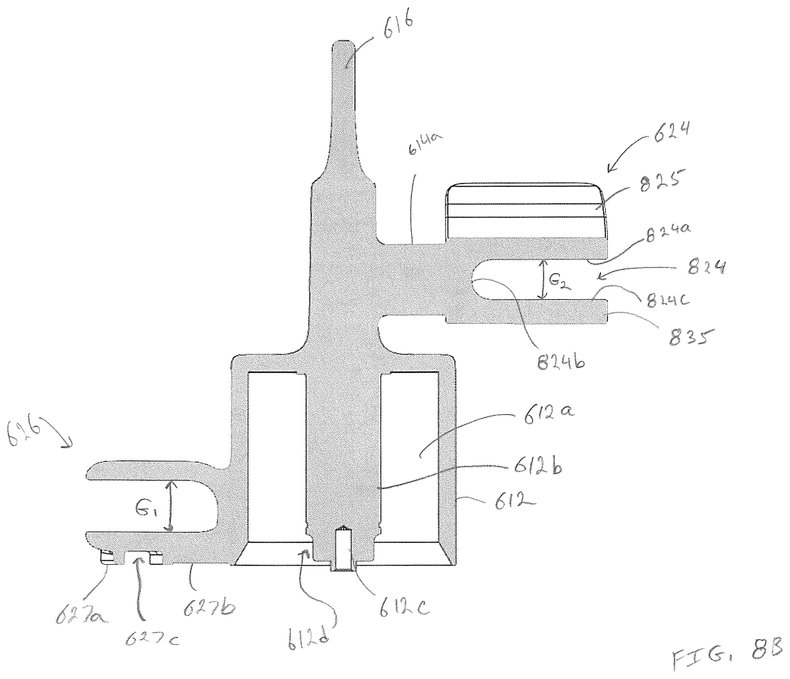

Another core aspect of the OMPA is providing a processing chamber or bucket assembly that not only allows OMPA input to be processed in a consistent, predictable manner, but is also easy to use by various individuals. FIG. 6A shows a perspective view of a bucket assembly 600 that includes a metal housing 602 (e.g., a receptacle or bucket) designed to fit securely within the liner structure of an OMPA. Housing 602 has an interior volume defined by a bottom wall 602a and peripheral wall 602b. Additional details of housing 602 features are shown and described in connection with FIGS. 7A-7E. Bucket assembly 600 is preferably user-removable from the OMPA. For example, bucket assembly 600 may be placed on the counter during food preparation and then reinstalled in the durable housing afterwards. Bucket assembly 600 may rest on feet members 680 when sitting on a counter or other surface. Feet members 680 may also serve as registration elements to assist in aligning bucket assembly 600 on top of heat plate 502. As another example, bucket assembly 600 may be removed from the durable housing after production of the product is complete to allow for easier handling (e.g., disposal, storage, or use) of the product.

Generally, bucket assembly 600 is designed so that, when installed in the liner structure, OMPA input can be easily deposited by simply opening the lid of the OMPA. Bucket assembly 600 can include an aperture 604 along its top end that is sized to allow for various forms of OMPA input. In some embodiments, aperture 604 can have elliptical form that is 150-500 millimeters (mm) (5.91-19.68 inches) in length and 150-300 mm (5.90-11.81) in width. For example, aperture 604 may have a length of roughly 350 mm (13.78 inches) and a width of roughly 175 mm (6.89 inches). Metal housing 602 may have three-dimensional ellipsoid form characterized as having two half columnar-like structures joined together by two planar walls. In some embodiments, metal housing 602 can have a pill shape. The width between the two planar walls and the diameter of the inside surface of the columnar structures can range between (X and Y), the length between the inside surfaces of both columnar-like structures can range between (X and Y), and the height from a bottom wall of housing 602 and the top planar surface of aperture 604 can range between (X and Y). For example, metal housing 602 may have an overall internal length of roughly 320 mm (12.60 inches), an overall internal width of roughly 150 mm (5.9 inches), and an internal height of roughly 240 mm (9.4 inches).

Moreover, bucket assembly 600 may be designed to be easily washable (e.g., in a dishwasher or wash in the sink). Thus, the bucket assembly 600 may be constructed of one or more durable materials that can withstand prolonged exposure to OMPA input in various states (e.g., moist and dry), as well as repeated washings. Examples of durable materials can include aluminum and stainless steel, aluminum and steel cladding, plastics, ceramics, and other metals.

As shown in FIG. 6A, handle 606 may be pivotably connected to opposing sides of bucket assembly 600. Such a design allows handle 606 to be pivoted downward when bucket assembly 600 is installed in the structural body of the OMPA. Handle 606 may be designed to not impede the deposition of OMPA input into bucket assembly 606. Handle 606 may be designed to allow a user to easily carry bucket assembly 606, with either one or two hands. To ensure that bucket assembly 600 can be transported without issue, it may be designed so that, when loaded with product, the weight does not exceed a threshold. The threshold may depend on the size of metal housing 602 and/or the material(s) from which the metal housing 602 and other components of bucket assembly 600 are made, though it may be desirable to limit the weight to no more than 10-25 pounds (and preferably 15-20 pounds).

FIG. 6B includes a top view of bucket assembly 600. The following discussion may reference one or both of FIGS. 6A and 6B. This view shows metal housing 602, handle 606 pivotably connected thereto, first impeller tree 610, second impeller tree 630, first blade array 650, second blade array 660, and deflectors 670. First impeller tree 610, second impeller tree 630, first blade array 650, second blade array 660 may collectively represent one or more grinding mechanisms responsible for cutting, crushing, grinding, mixing, or otherwise separating OMPA input deposited into housing 602 into fragments. First impeller tree 610 and second impeller tree 630 are part of respective impeller tree assemblies that secure impeller trees 610 and 630 to metal housing 602 and to respective drive shafts of a drivetrain. The drivetrain can include a gearbox and a motor that rotate the drive shafts, thereby causing first impeller tree 610 and second impeller tree 630 to rotate about respective vertical axes within bucket 602. Blade arrays 650 and 660 are arranged vertically within bucket 602 and can both be positioned on the same side of bucket 602 or can be positioned on opposite sides of bucket 602. In some embodiments, it may be preferred to mount blade arrays 650 and 660 along a curved portion of the peripheral wall of bucket 602. As first impeller tree 610 and second impeller tree 630 rotate, the cutting members that extend radially away from the respective vertical axes pass by their associated blade array (e.g., the cutting members of first impeller tree 610 pass by first blade array 650 and the cutting members of second impeller tree 630 pass by second blade array 660). Each cutting member may have a u-shaped groove or channel that is bisected by a blade associated with one of blade arrays 650 and 660 during each rotation of the impeller trees. In one embodiment, bucket 602 may be dimensioned and the vertical axis positions of the impeller trees may be such that none of the cutting members associated with impeller tree 610 overlap any of the cutting members associated with impeller tree 630 during any point of the rotations thereof. In this embodiment, despite the existence of a cutting member free zone in the middle portion of bucket 602, the configuration of one or more cutting members and a size of the free zone promote cross-flow of OMPA input/OMPA output from one side (e.g., left side) to the other side (e.g., right side) of bucket 602. In some embodiments, the flow of material contained in bucket 602 can resemble the figure eight (8) or infinity (00) shape when impeller trees 610 and 630 are both rotating (e.g., in the same direction). Moreover, as will be explained in more detail below, the configuration of one or more cutting members is designed to pull material down to the bottom of bucket 602. The downward migration of material may be preferable because higher leverage cutting members exist near the bottom of bucket 602. Higher leverage cutting members have more cutting, grinding, and shearing power than lower leverage cutting members and thus have a greater capacity to break up relatively harder objects (e.g., avocado pits, bones, shells, etc.). In some embodiments, a cutting member of one impeller may be configured to extend beyond a middle portion of bucket 602 such that it overlaps at least one of the cutting members of the other impeller.

Impellers 610 and 630 may rotate at the same or different rates of rotation and at the same direction or opposing directions. The design configuration of bucket assembly 600 may enable a user to manually rotate one or both impellers or to remove and re-insert one or both impellers (e.g., to enable better exfiltration of OMPA output from the bucket assembly, to clean, or service). As a potential consequence of the manual rotation or re-insertion of one or more impellers, both impellers may be positioned in a rotation sync that would result in simultaneous cutting member/blade array interactions for every rotation cycle if both impellers spin at a synchronous rotation rate. In one embodiment, impellers 610 and 630 may both rotate in the same direction at any given time but at an asymmetric rotation rate. The asymmetric rate of rotation can ensure that both impellers 610 and 630 are not always simultaneously passing by their respective blade arrays. This limits occurrence of simultaneous matter engagement (e.g., slicing, cutting, grinding) of both impellers with their respective blade arrays. This prevents undue stress on the motor powering the drivetrain and maximizes torque loading for each cutting member/blade array interaction. In other words, it is desirable for only one cutting member to interact with its respective blade array at any given time during the rotation cycle of both impellers. This way, all available motor torque is available to engage in just one cutting member/blade array interaction as opposed to simultaneously distributing motor torque across two separate cutting member/blade array interactions.

The asymmetric rotation of impellers 610 and 630 can be provided by a gearbox (e.g., part of drivetrain 550) that is connected to both impellers 610 and 630 and to a motor (also part of drivetrain 550). The gears in the gear box may be configured such the rotational input provided by the motor is translated into a different rotation speed for each impeller. For example, if one impeller rotates at a rate of X, the other impeller may rotate at rate of Y, where Y is different than X. The difference between X and Y can be relatively small such as 0.1 to 3 percent. The motor may operate under the control of a control system that can run an algorithm that is supplied with a multitude of inputs that can cause the motor to operate differently. For example, at the beginning of an OMPA processing cycle, the motor may operate at a relatively slower speed such that the impellers rotate at a relatively slower rotational rate (e.g., to provide sufficient time to grind and cut OMPA input). After a beginning period of the OMPA processing cycle has come to completion (e.g., after a fixed period of time or one or more sensors indicate that the relatively more difficult grinding and cutting actions are complete), the motor may operate at relatively higher speed such that the impellers rotate at a relatively faster rotational rate (e.g., to promote enhanced mixing and drying of contents contained in bucket 602). For example, both impellers may rotate at a rate of 1-2 rotations per minute (RPM), but with a difference of 0.25-1 RPM between the two impellers. As a specific example, one impeller may rotate at a rate of 1.2 RPMs, while the other rotates at 1.6 RPMs.

FIG. 6C shows a bottom view of bucket assembly 600, which shows housing 602, heat plate interfacing surface 603a, impeller assembly 610a, impeller assembly 630a, and feet members 680. Heat plate interfacing surface 603a is designed to sit directly on top of heat plate 502. Through-holes 610b and 630b exist in heat plate interfacing surface 603a to allow for respective portions of impeller assemblies 610a and 630a to extend through the bottom of housing 602 to interface with respective drivetrain components. The portions of impeller assemblies 610a and 630 extending through through-holes 610b and 630b extend beyond a plane of interface surface 603a but may not extend beyond feet members 680. This way, when bucket assembly 600 is removed from the OMPA and set on a counter or floor, feet members 680 fully support bucket assembly 600 without any stress being applied to impeller assemblies 610a and 630a. This spatial relationship is shown more clearly in FIGS. 6D-6F, discussed below. As also shown in FIG. 6C, feet members 680 are shown to have a semi-circular shape and are mounted to opposite ends of housing 602. The semi-circular shape of feet members 680 resemble the semi-circular shape of the ends of housing 602. If desired, feet members 680 can form a perimeter that completely surrounds surface 603a.

FIG. 6D shows a side view of bucket assembly 600 with housing 602 shown in a hidden configuration. This view does show that no portion of impeller assemblies 610a and 630a extend beyond feet members 680. The other components shown in FIG. 6D are self-explanatory. FIG. 6E shows a cross section of bucket assembly 600 with emphasis on impeller 630 and blade array 660. FIG. 6F shows a cross section of bucket assembly 600 with emphasis on impeller 610 and blade array 650. Both FIGS. 6E and 6F show deflectors 670, feet members 680, as well as interior surfaces of metal housing 602. Deflectors 670 are designed to prevent contents contained in the bucket from splashing up and over the sidewall of housing 602. Deflectors 670 are shown to span the long sides of housing 602. This is merely illustrative. If desired, a deflector member may span the entire inside surface of housing 602. As another example, additional deflectors may be added along a portion of the entirety of the curved portions of housing 602. As shown, metal housing 602 has a slight convex shape where the aperture is larger than the bottom wall. Moreover, impeller coupling member 615 and impeller coupling member 635 extend through the bottom wall of housing 602 but do not extend beyond feet members 680.

In FIGS. 6D and 6E, it is apparent that during a rotation of impeller 630, cutting member 642 passes by or interfaces with blade 662, integrated cutting and paddle member 644 passes by blade 664, and cutting member 646 passes by blade 666. During each rotation, blades 662, 664, and 666 can intersect a gap existing within respective members 642, 644, and 646. An interaction of organic matter and one of the of member/blade combination can result in cutting, grinding, or splitting thereof. Each cutting member may also mix and agitate organic matter contained in housing 602. Integrated cutting and paddle member 644 may have enhanced mixing capacity relative to cutting members 642 and 646 due to the paddle configuration of member 644. The paddle configuration of member 644 is designed to pull or push organic matter downward towards the bottom surface of housing 602 during rotations thereof. A more detailed explanation of each cutting member is discussed below. It is desirable to push matter down to the bottom surface so that the higher leverage/stronger cutting members (e.g., member 646 and/or cutting member 626) can engage in grinding/cutting work. Moreover, cutting member 646 can include one or more bottom wall scrapers that are designed to break up and redistribute any organic matter that is resting on the bottom wall within the circular path of the bottom wall scrapers. In addition, the bottom wall scrapers can also serve as treads or plows to facilitate rotational movement of cutting member 646 through and over organic matter residing on or near the bottom wall of housing 602.

As also shown FIGS. 6D and 6F, during a rotation of impeller 610, integrated cutting and paddle member 624 passes by blade 654 and cutting member 626 passes by blade 656. During each rotation, blades 654 and 656 can intersect a gap existing within respective members 624 and 626. An interaction of organic matter and one of the of member/blade combination can result in cutting, grinding, or splitting thereof. Each cutting member may also mix and agitate organic matter contained in housing 602. Integrated cutting and paddle member 624 may have enhanced mixing capacity relative to cutting member 626 due to the paddle configuration of member 624. The paddle configuration of member 624 is designed to pull or push organic matter downward towards the bottom surface of housing 602 during rotations thereof. A more detailed explanation of each cutting member is discussed below. It is desirable to push matter down to the bottom surface so that the higher leverage/stronger cutting members (e.g., member 626 and/or cutting member 646) can engage in grinding/cutting work. Moreover, cutting member 626 can include one or more bottom wall scrapers that are designed to break up and redistribute any organic matter that is resting on the bottom wall within the circular path of the bottom wall scrapers. In addition, the bottom wall scrapers can also serve as treads or plows to facilitate rotational movement of cutting member 626 through and over organic matter residing on or near the bottom wall of housing 602.

The relative heights of each cutting member are now discussed. As shown, impeller 610 has two cutting members 626 and 624 that have center lines that exist at heights H1 and H3, respectively (from the bottom wall). Heights H1 and H3 also correspond to the centerlines of blades 656 and 654, respectively. Impeller 630 has three cutting members 646, 644, and 642 that have center lines that exist at heights H1, H2, and H4, respectively (from the bottom wall). Heights H1, H2, and H4 also correspond to the centerlines of blades 666, 664, and 662, respectively. Heights H1, H2, H3, and H4 all have different numerical values. Cutting members 626 and 646, and blades 656 and 666 can all correspond to height H1. As a result, cutting members 626 and 646 can rotate along the same plane as each other. Integrated paddle and cutting members 654 and 664 may be slightly offset with respect to each other as shown, with member 624 existing at height H3, and cutting member 644 existing at height H2. This difference in height may be 15 mm or range between 5-30 mm, depending on internal height of the metal housing, and can promote cross bucket mixing and downward pushing of organic matter. Cutting member 642 rotates at height H4 and is designed to chop relatively large OMPA input (e.g., corn) or other OMPA input sitting on top of other organic matter existing in bucket assembly 600.

Another dimension within bucket assembly 600 is depth D1 from the planar surface of the aperture opening of housing 602 to the center line of cutting member 642. In some embodiments, it may be desirable to maintain a minimum depth D1 to minimize upward splashing of contents and to promote downward pushing of material to the bottom wall. It should be understood that the depths of each cutting member and blade relative to the top of housing 602 can be determined by doing simple math with D1 and height values H1-H4. For example, the depth of cutting member 646 can be determined by the following formula: D1+H4−H1. As another example, the depth of cutting member 624 can be determined by the following formula: D1+H4−H3.

FIG. 6G shows multiple views of impeller coupling 615 or 635 according to an embodiment. For the purposes of this discussion, the impeller coupler will be referred to as impeller coupler 615. Impeller coupler 615 has cylindrical portion 615a that forms the outer dimension thereof. The top part of cylindrical portion 615a may have cavity 615b dimensioned to fit around a distal end of the extension portion of an impeller tree (as shown in FIG. 7). Through-hole 615c may exist a center axis of coupler 615 and configured to receive a fastener to secure coupler 615 to the impeller tree (via the extension portion). The bottom side of cylindrical portion 615 can include tubular structure 615e that extends from surface 615d to a first fixed distance and includes through-hole 615c. Also extending from surface 615d are three tooth members 615f that are integrally formed with tubular structure 615e and are arranged at 120 degrees with respect to each other. Tooth members 615f can extend from surface 615d a second fixed distance that is greater than the first fixed distance associated with tubular structure 615e. Tooth members 615f can include a cuboid portion 615g and partial pyramidal portion 615h (e.g., both of which exhibit similarities to rib structure 553c. Partial pyramidal portion 615h can help align impeller 615 with a respective drivetrain coupler when the bucket assembly is inserted into the liner. The side walls of cuboid portion 615g are designed to engage a reciprocal side wall of cuboid portion 553g when couplers 553 and 615 are mated together. In some embodiments, tooth members 615f can touch or be designed to be offset by a fixed gap distance from bottom wall 553d of coupler 553 when couplers 553 and 615 are coupled together. Conversely, rib structures 553d can touch or be designed to be offset by another fixed gap from surface 615d when couplers 553 and 615 are coupled together.

FIG. 6H shows several views, including cross-sectional views of impeller coupling 615 engaged with coupler 553. As shown in the cross-sectional views, each tooth member 615f exists between rib structures 553c. It should be understood that if impeller coupling 615 is engaged with coupler 580, the cross-sectional views would be different, but each tooth member 615f would exist between rib structures 583c.

It should be noted that the design of the impellers and fixed blade arrays shown and discussed herein are illustrative and that various modifications and configuration can be made. For example, in one embodiment, the bucket assembly can be constructed with just one fixed blade array so that more motor torque is available for cutting actions between an impeller and the lone remaining blade array. FIG. 6I shows an alternative bucket assembly 690 to bucket assembly 600. Bucket assembly 690 can be similar to bucket assembly 600, but eliminates blade array 650 and can modify a shape of impeller 610 to be more conducive mixing to contents contained in the bucket (e.g., integrated cutting and paddle member 624 can be modified to eliminate the cutter element and include a single integrate paddle member). In bucket assembly 690, impeller 630 is operative to cut and grind in conjunction with blade array 660 and impeller 610m is operative to mix and agitate only because there is no blade array/impeller 610m interaction. In embodiments that use just one blade array is used in the bucket assembly (e.g., bucket assembly 690), both impellers may synchronously rotate (because there is no need to avoid dual impeller loading events to ensure maximum distributed cutting torque is available for both impellers-only one impeller is engaged in active cutting with respect to a blade array).

In some embodiments, when the bucket assembly is inserted into the OMPA, and the insertion thereof is detected, the motor may autorotate the drive couplers 553 and 554 to ensure that impeller couplers 615 and 635 fully seat into respective drive couplers 553 and 554. Autorotating may prevent couplers from stack interfacing with each in a manner that could potentially prevent the bucket assembly from being seated into its proper insertion position. If, after insertion of the bucket assembly, the couplers stack up on top each other, the bucket assembly may not be fully seated. The autorotation of driver couplers 553 and 554 will enable the impeller couplers 615 and 635 to fall into place to ensure the bucket assembly is properly seated. It should be understood that couplers 553 and 554 can be replaced with coupler 580.

FIG. 7 shows an illustrative cross-sectional view of bucket assembly 600 with emphasis on impeller assemblies 610a and 630a, impeller couplings 615 and 635, and drive train couplings 775 and 785. FIGS. 7A-7E show different views of only housing 602. In particular, FIGS. 7A and 7B show different perspective views, FIG. 7C shows a top view, FIG. 7D shows a bottom view, and FIG. 7E shows a cross-sectional view of housing 602. The following discussion collectively references FIGS. 7 and 7A-7E. Housing 602 has bottom wall 602a, peripheral wall 602b, aperture 604, heat plate interfacing surface 702, and support structures 712 and 732. Each of these components comprising housing 602 may be die cast as a single unitary structure out of aluminum, steel, or other metal material. Support structures 712 and 732 are ring shaped structures extending upwards from bottom wall 602a. Support structure 712 includes through-hole 712a, which extends through bottom wall 602a and heat plate interfacing surface 702. Support structure 712 can include bearing retaining cutouts 714 and 715 that are configured to hold bearings 704 and 705 (shown in FIG. 7). Support structure 712 can include gasket groves 716 and 717 that are configured to retain gaskets 706 and 707 (shown in FIG. 7). Support structure 732 includes through-hole 732a, which extends through bottom wall 602a and heat plate interfacing surface 702. Support structure 732 can include bearing retaining cutouts 734 and 735 that are configured to hold bearings 724 and 725 (shown in FIG. 7). Support structure 732 can include gasket groves 736 and 737 that are configured to retain gaskets 726 and 727 (shown in FIG. 7). Though-holes 712a and 732a can each have a minimum diameter portion configured to accept respective extension members of impellers 610 and 630 and a maximum diameter portion configured to accommodate drivetrain components.

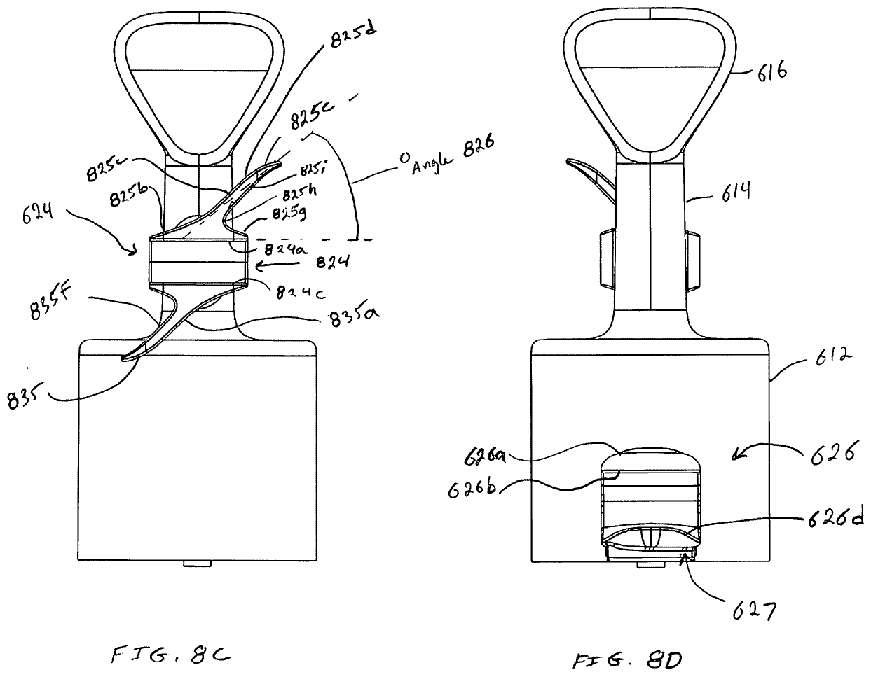

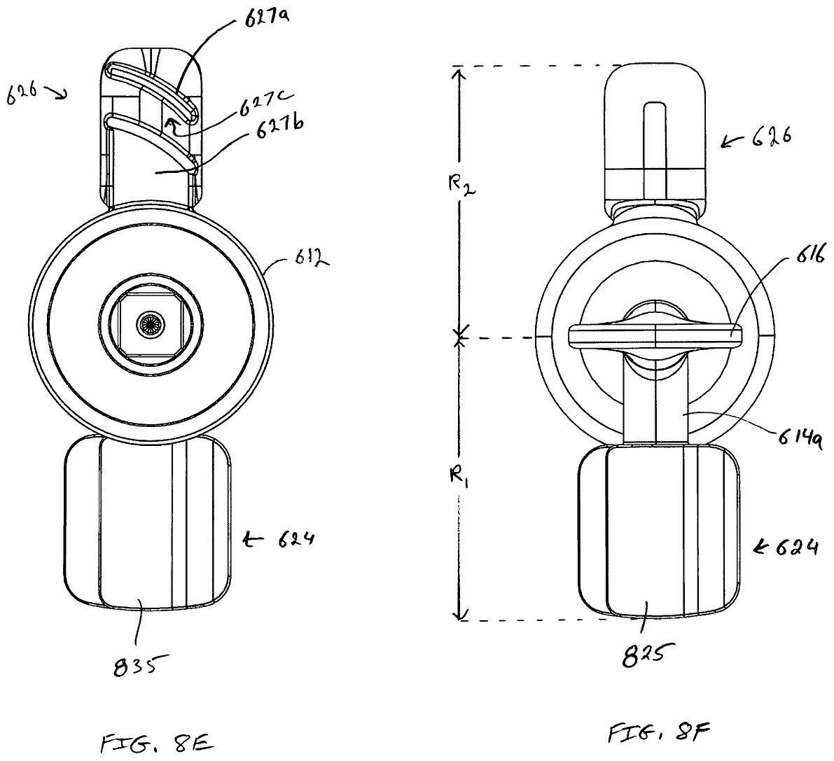

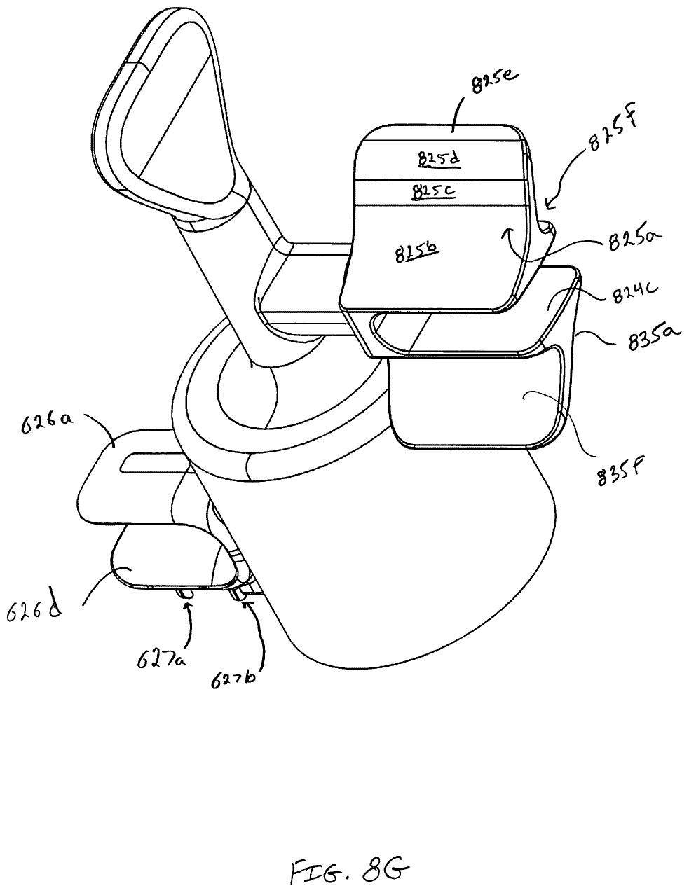

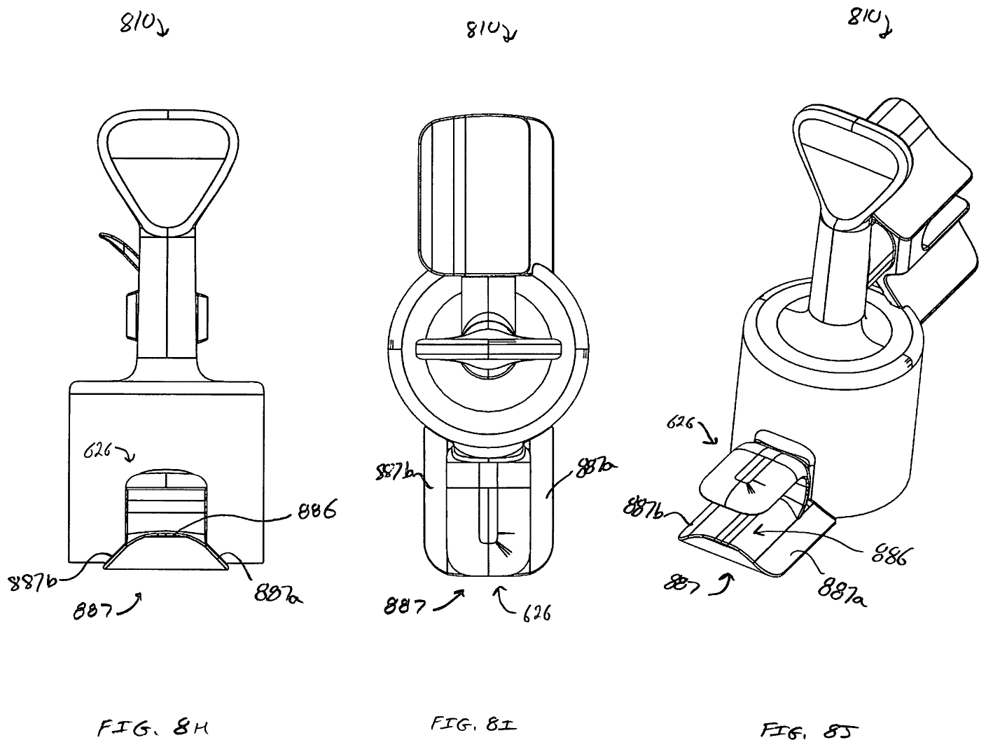

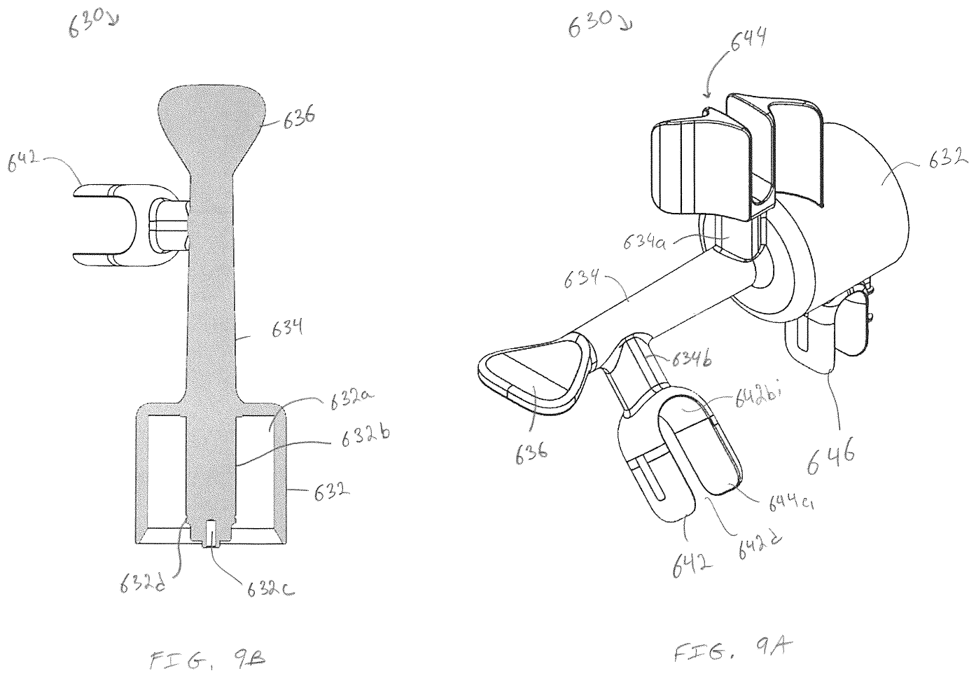

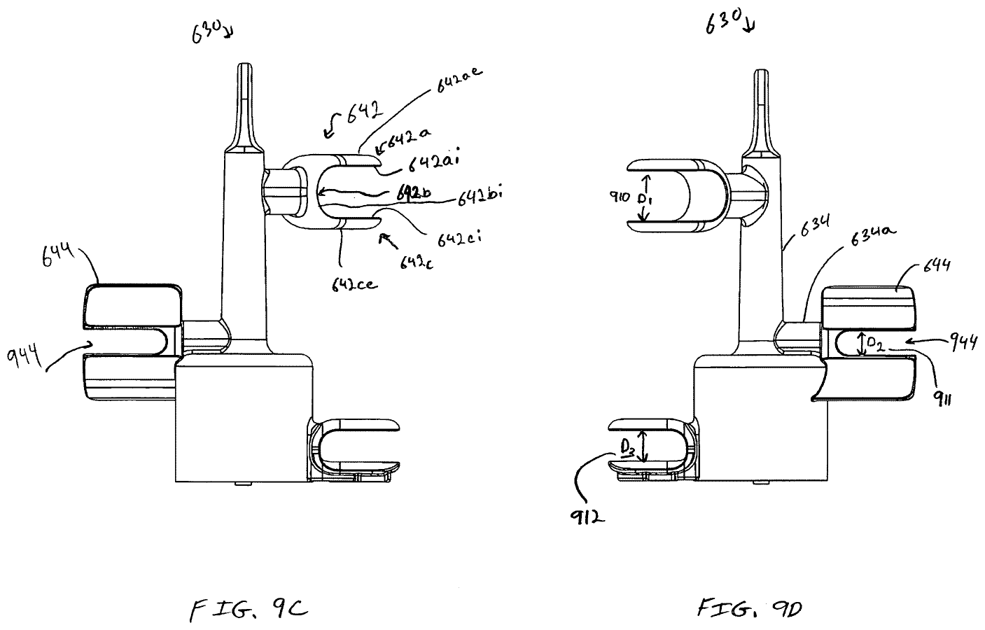

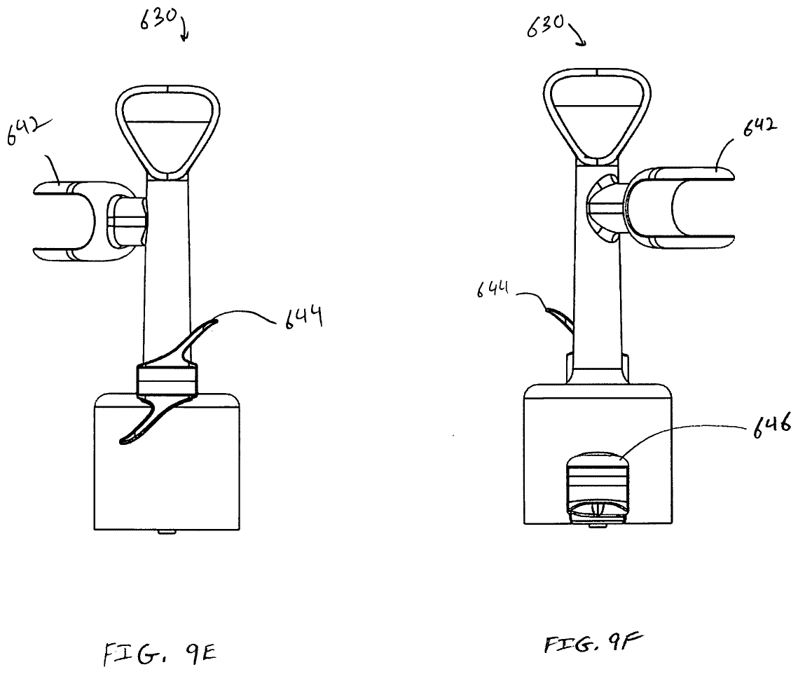

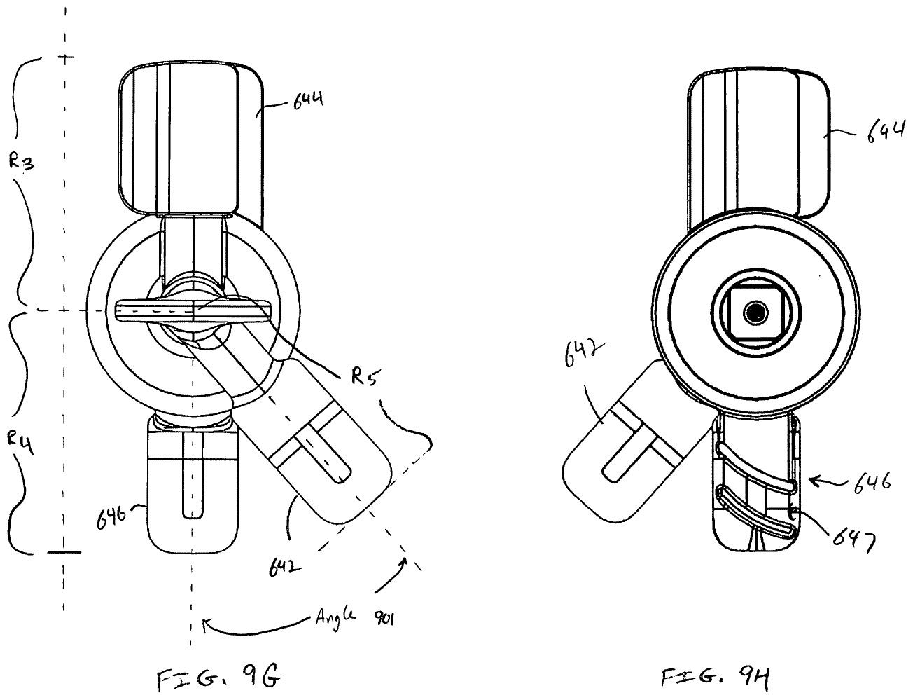

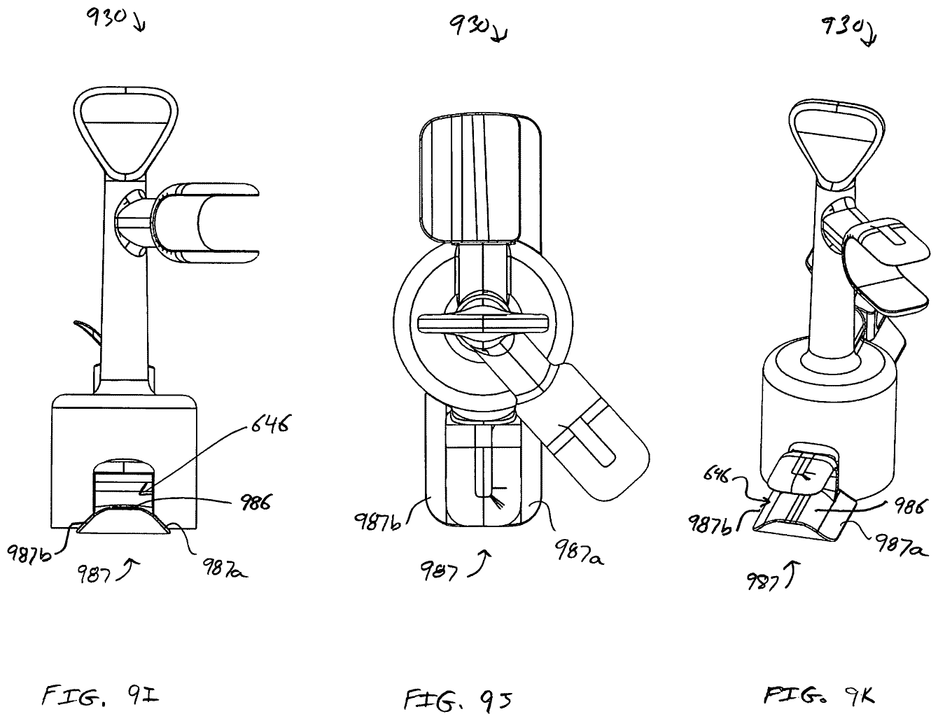

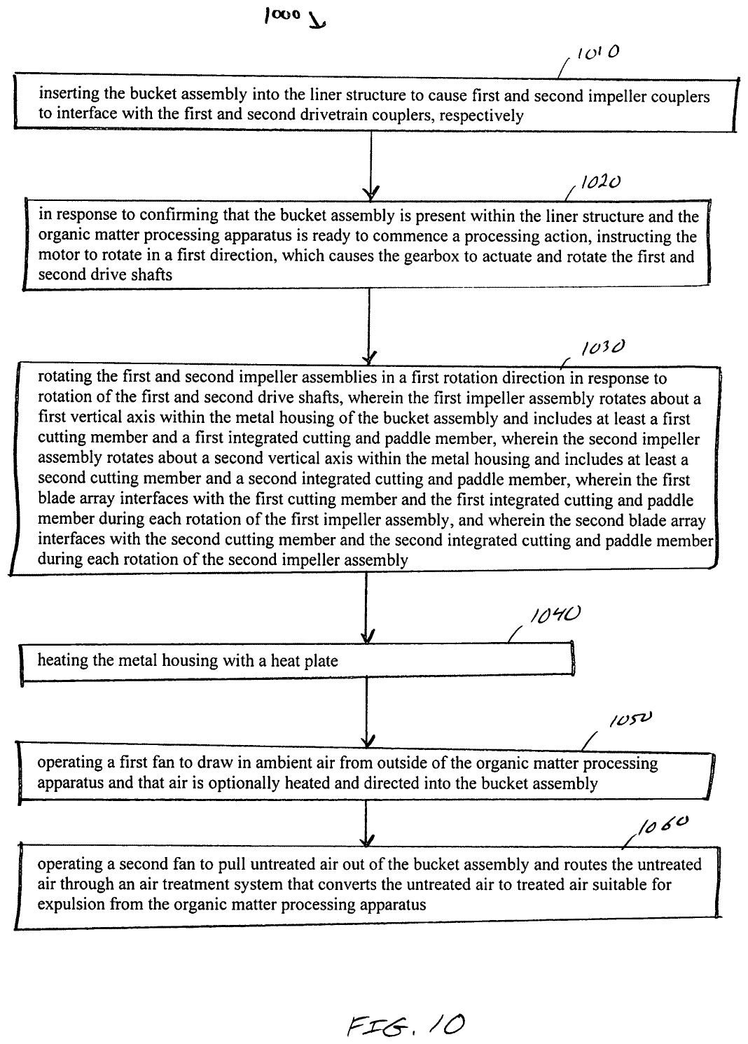

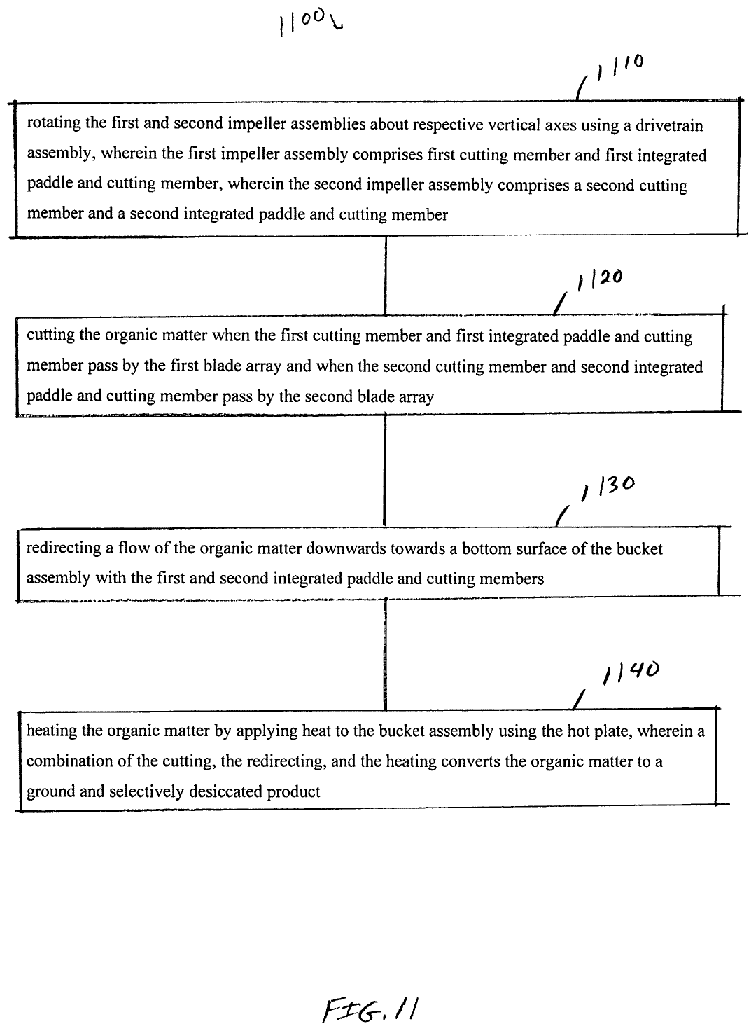

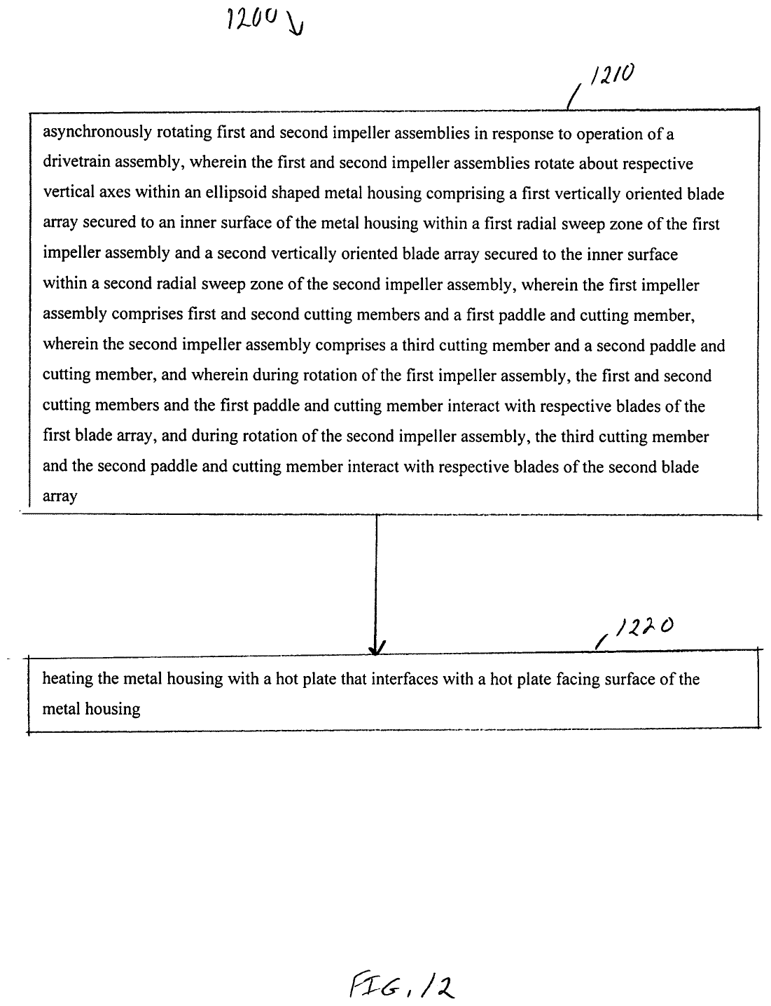

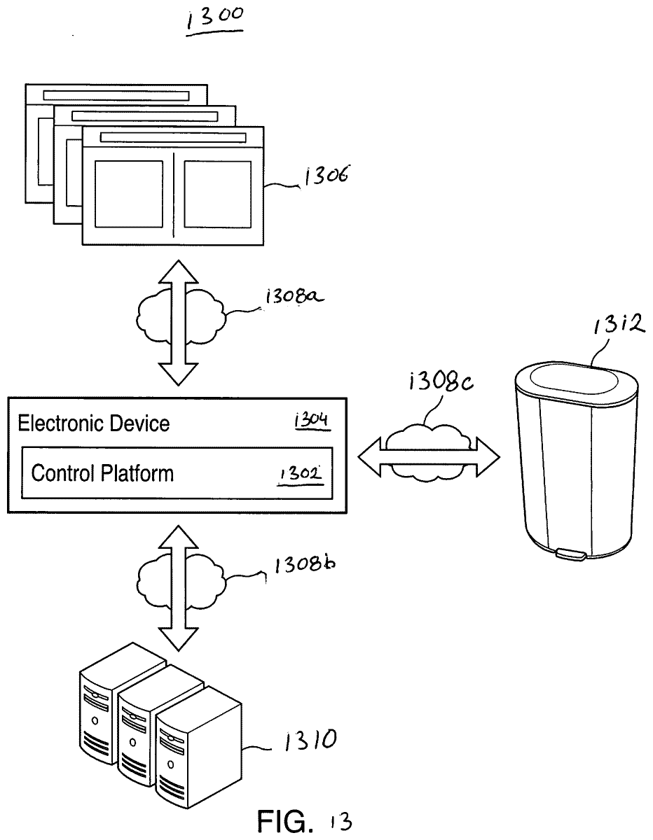

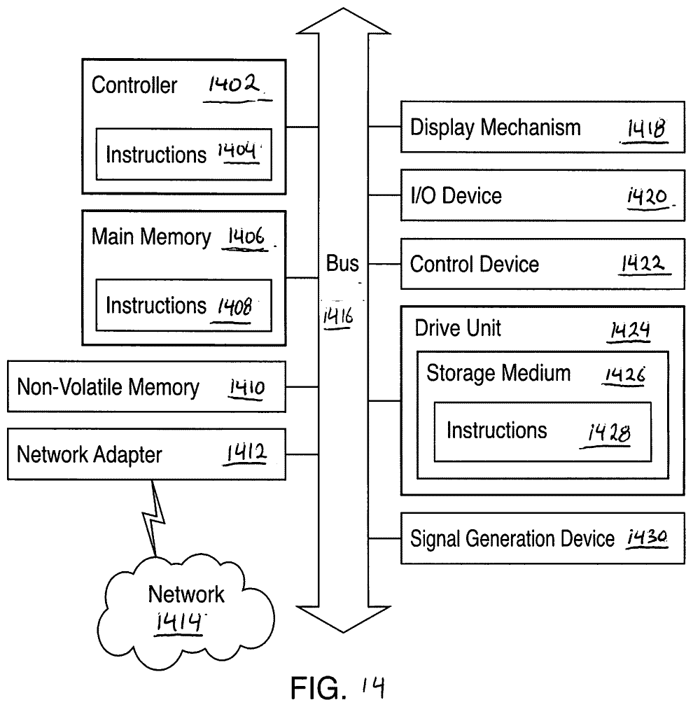

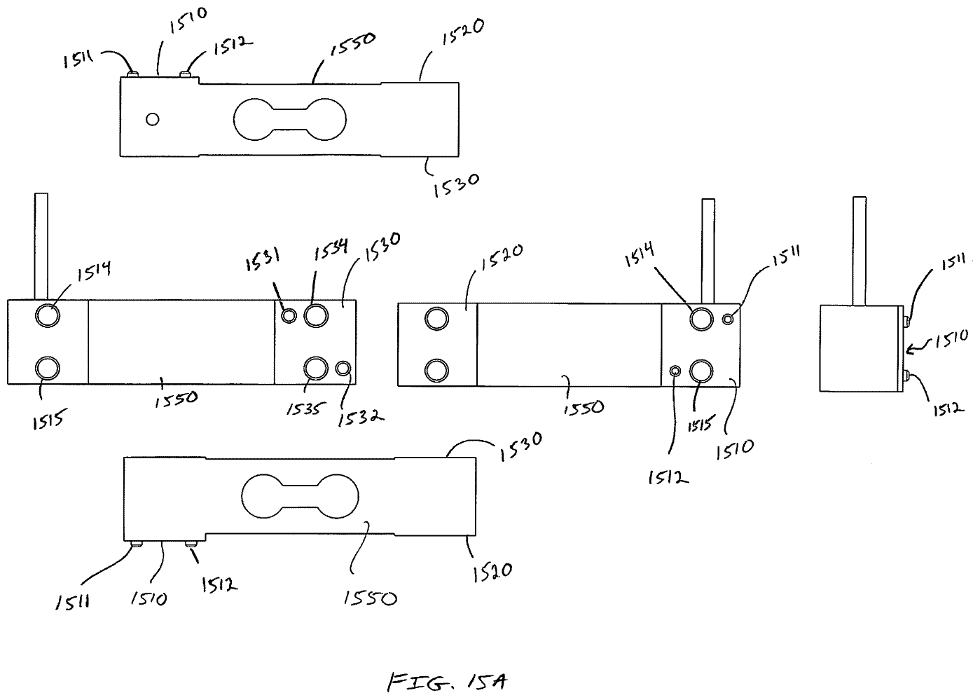

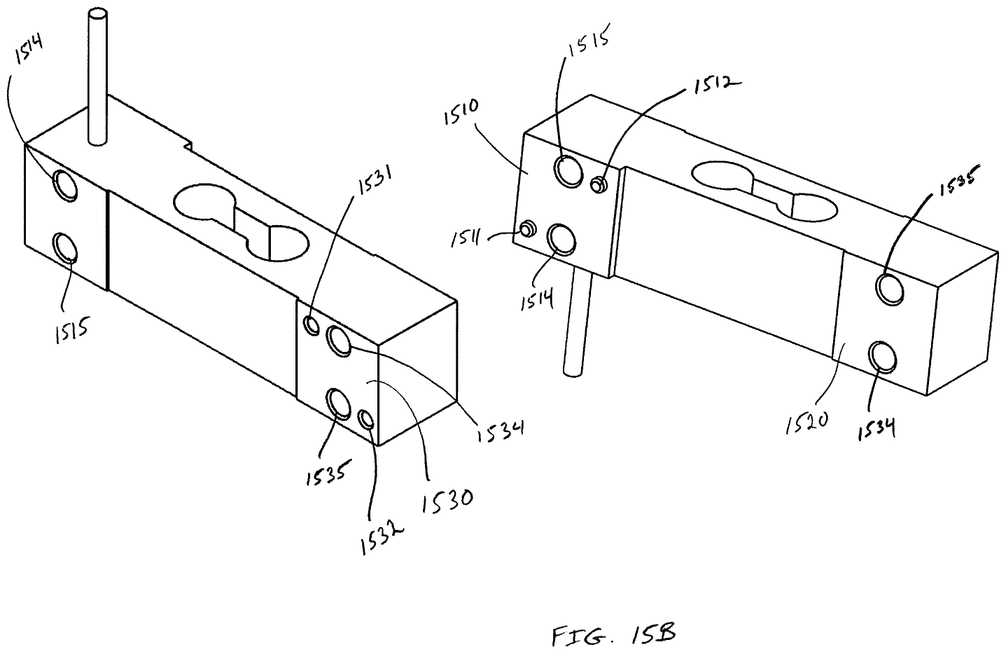

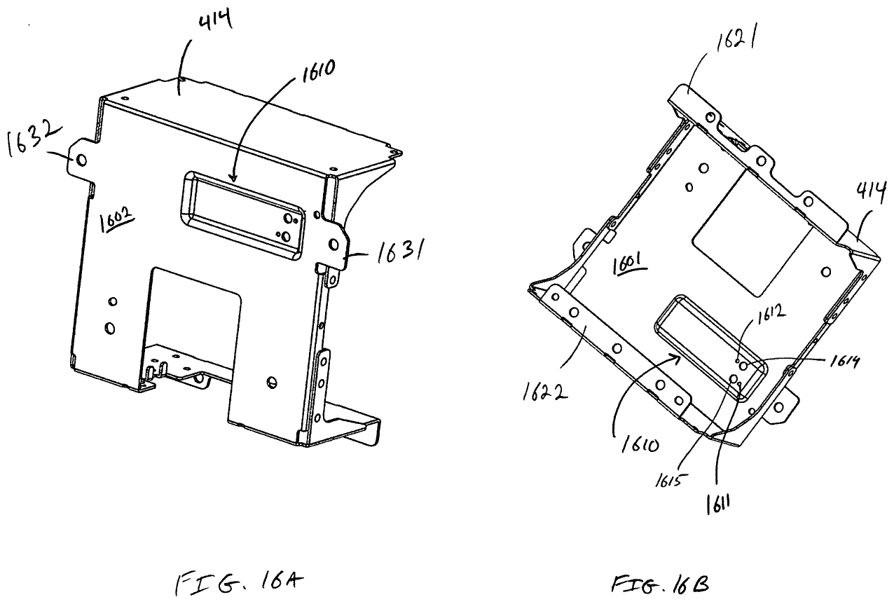

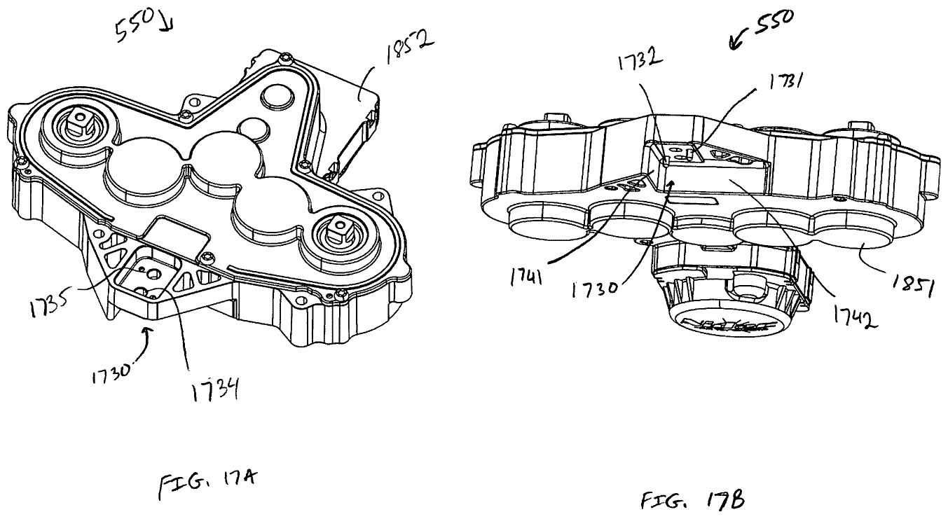

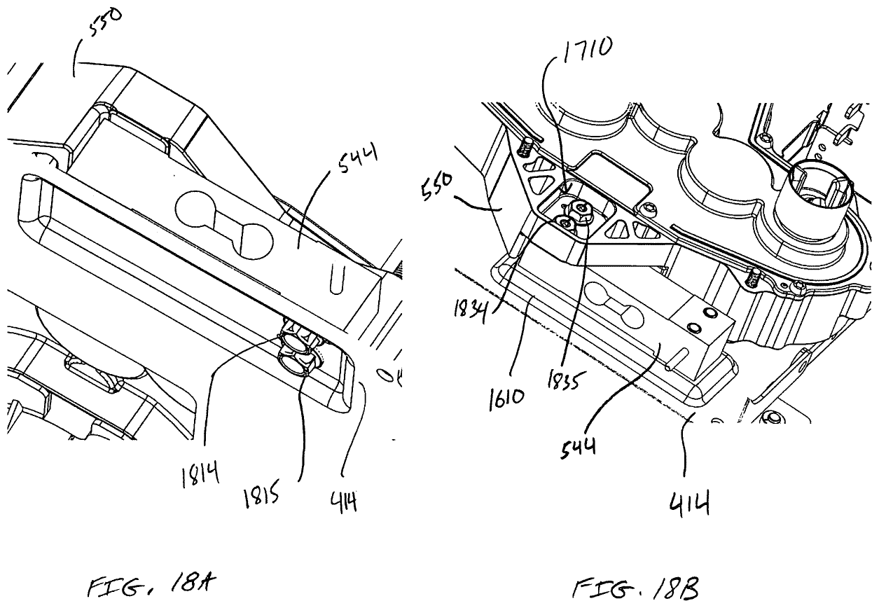

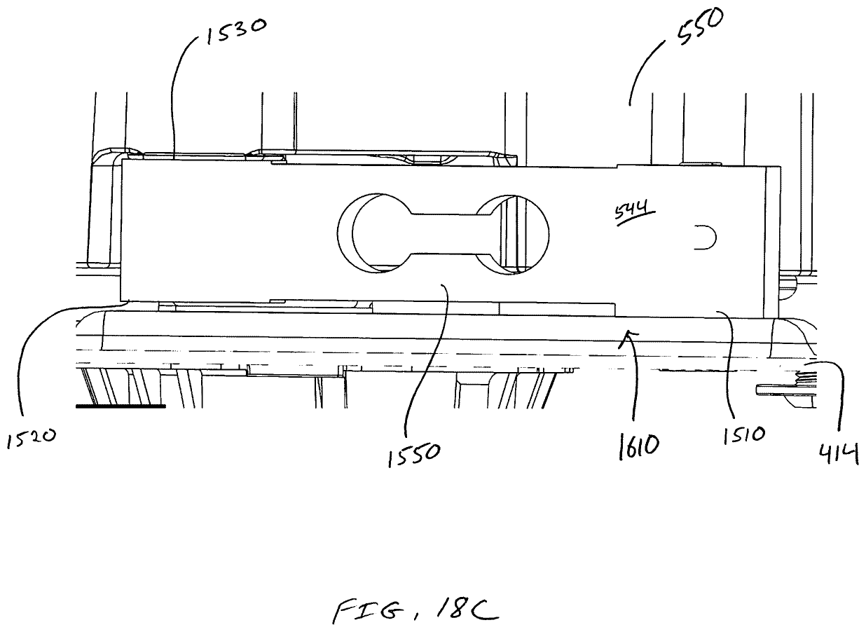

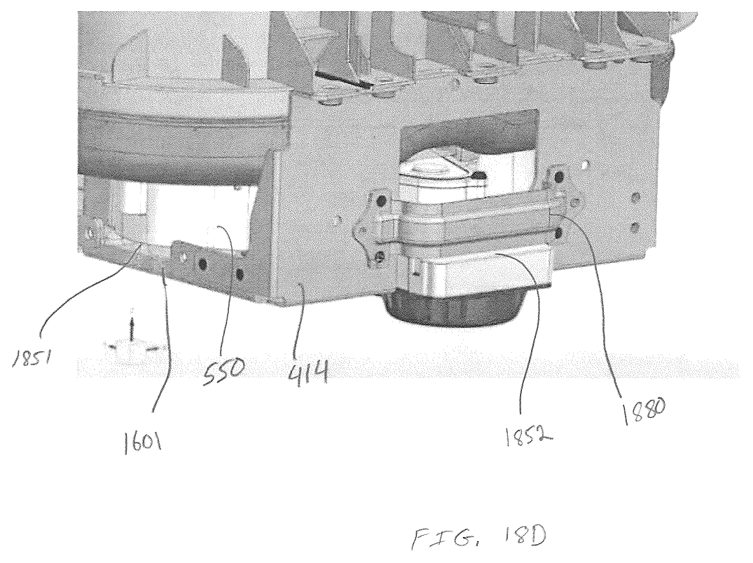

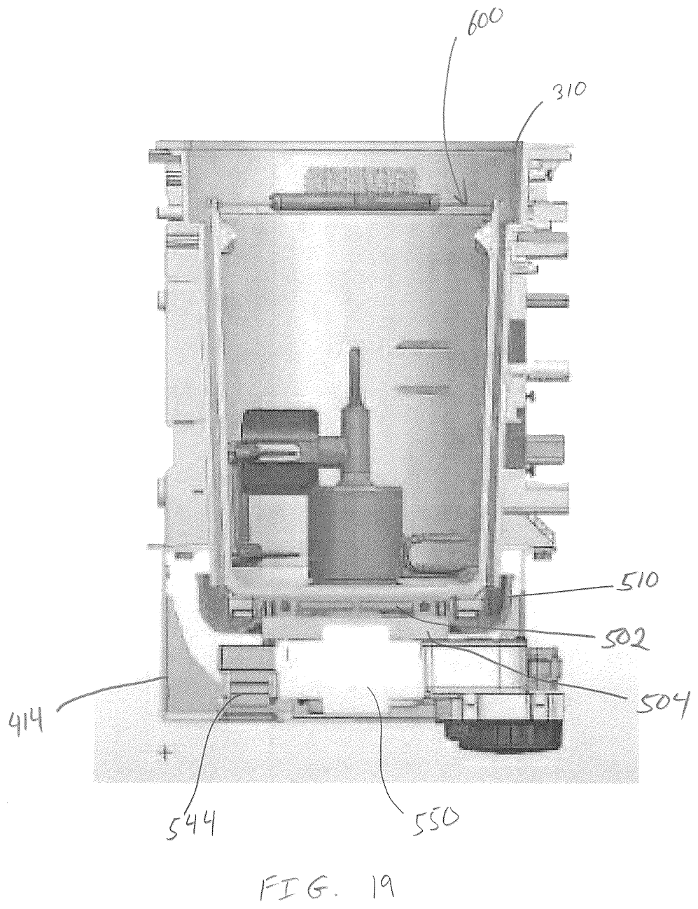

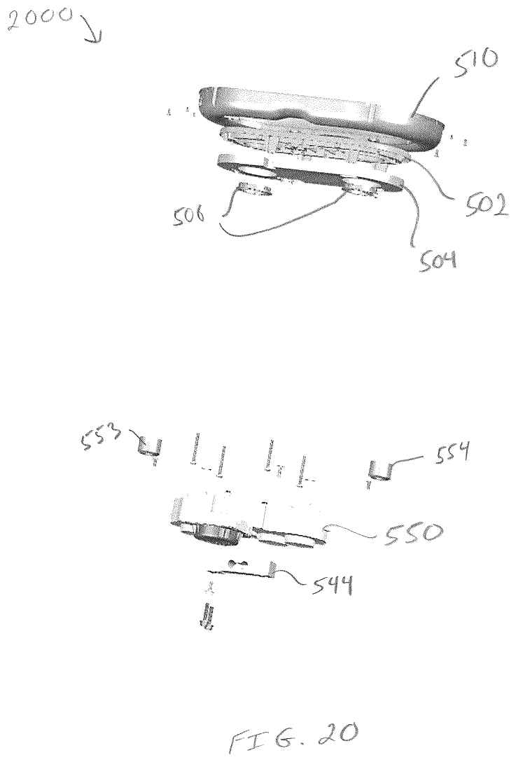

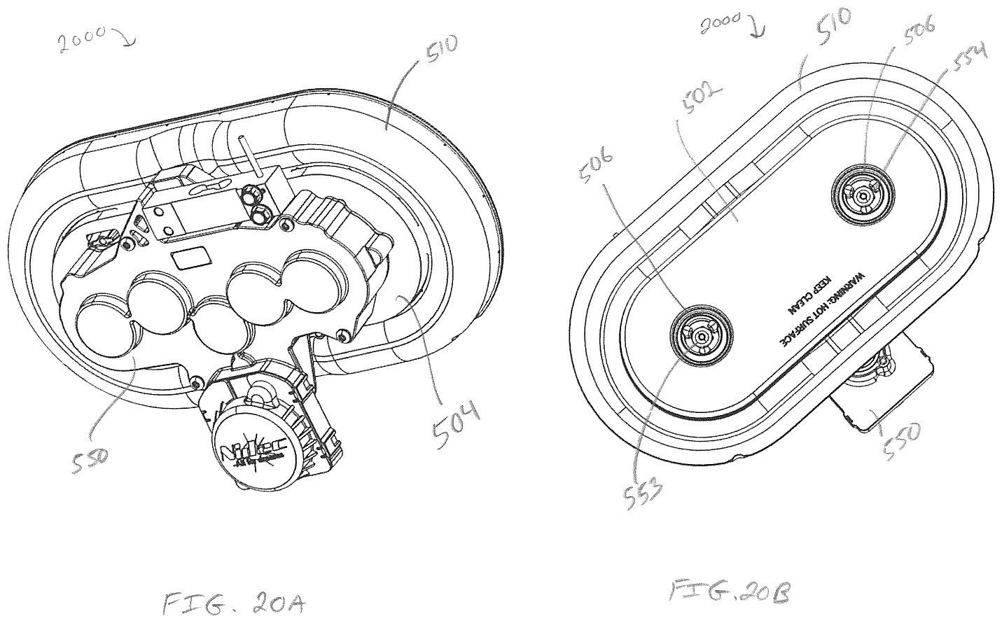

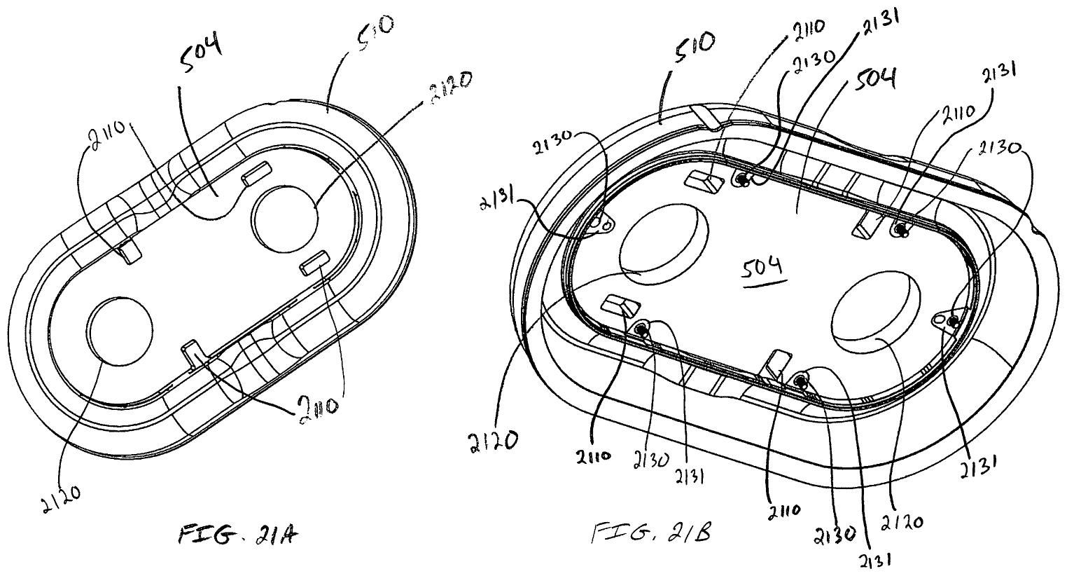

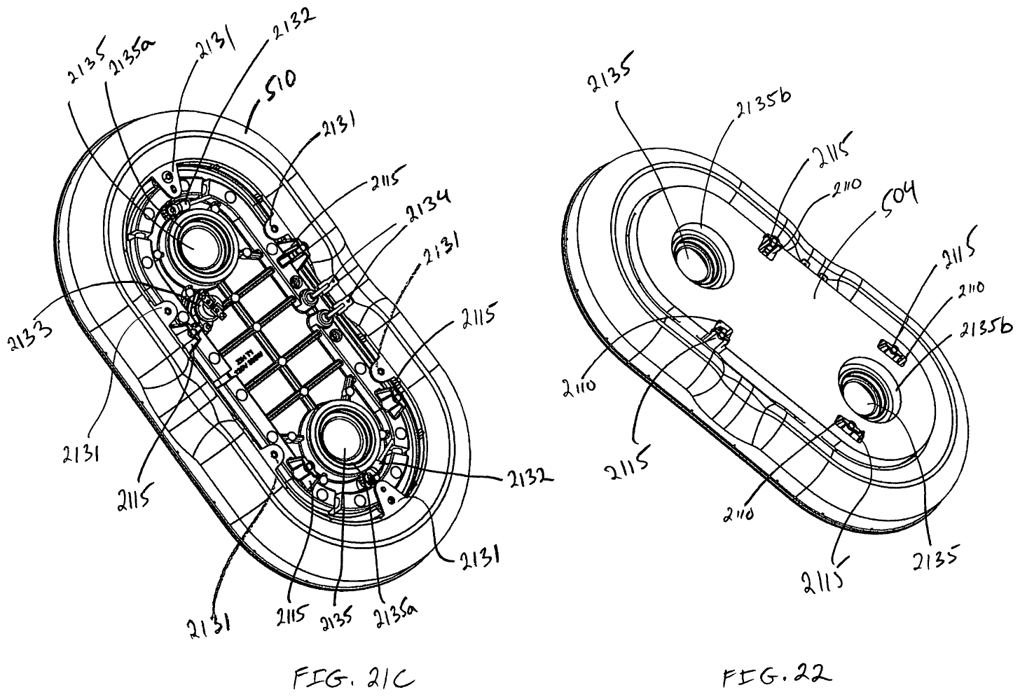

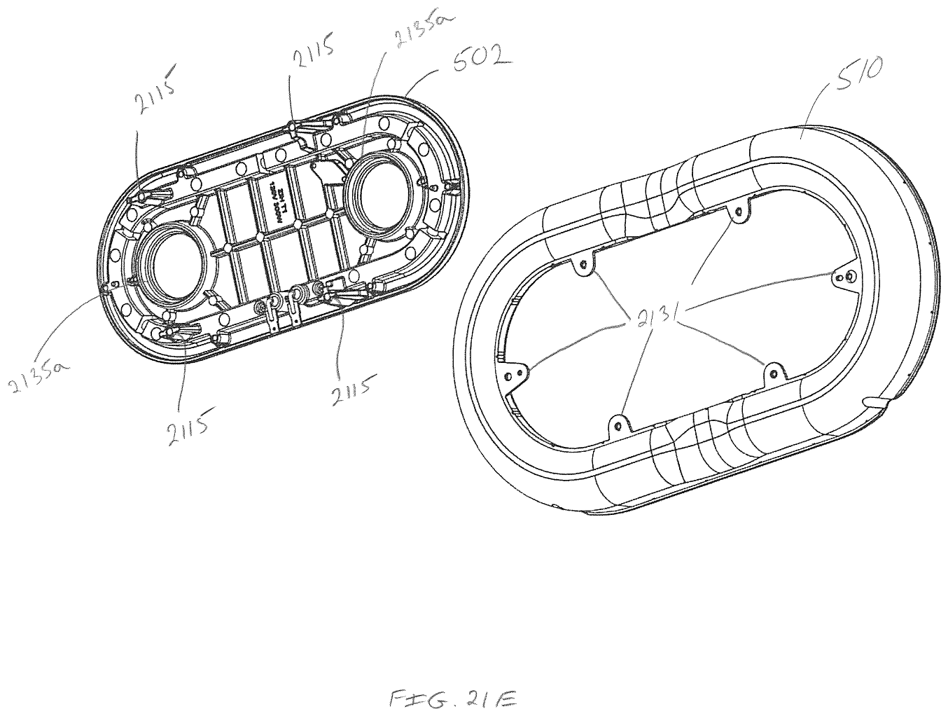

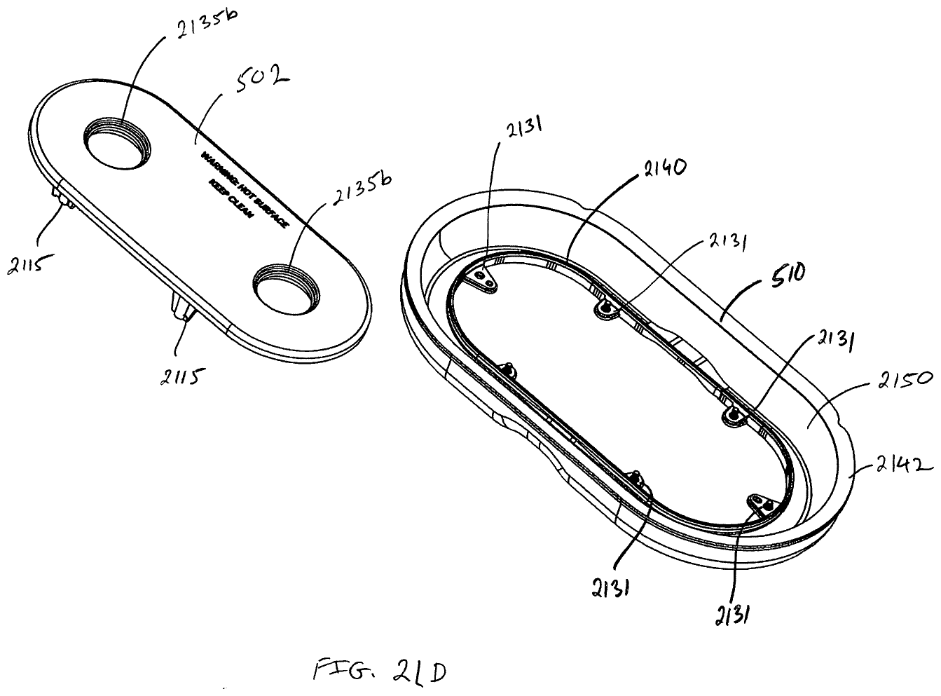

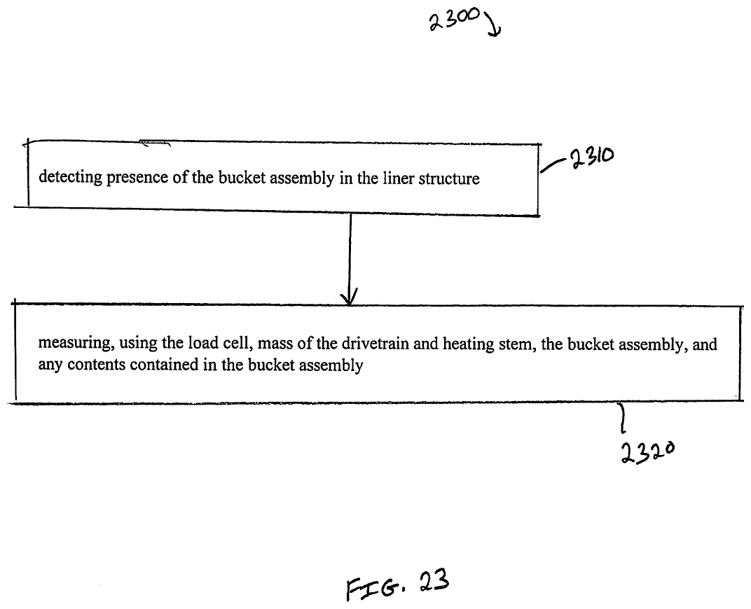

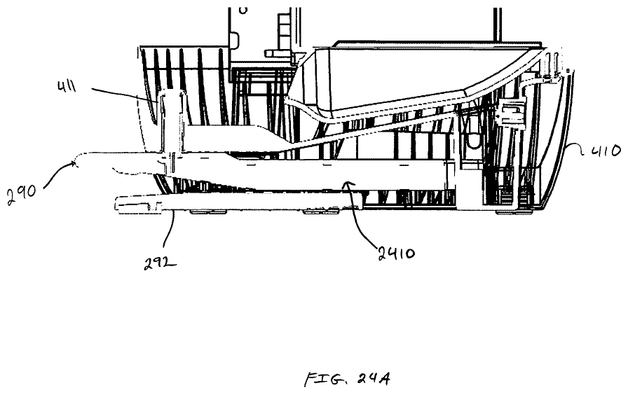

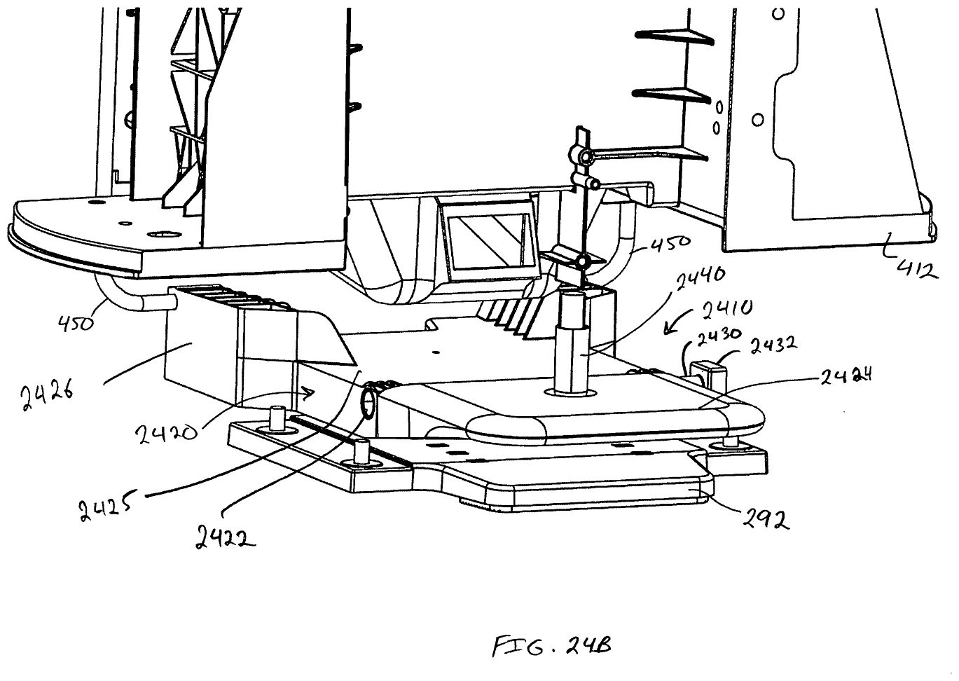

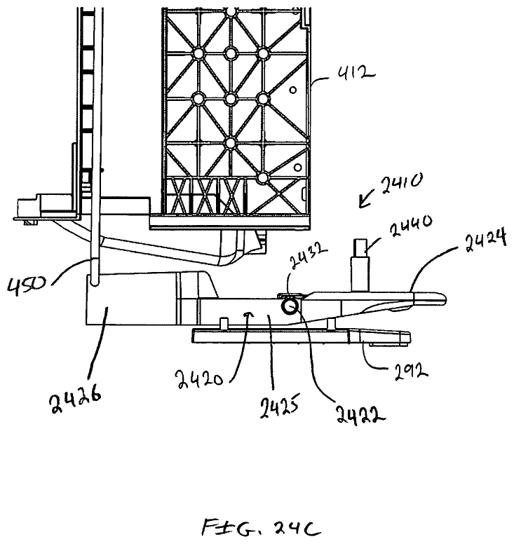

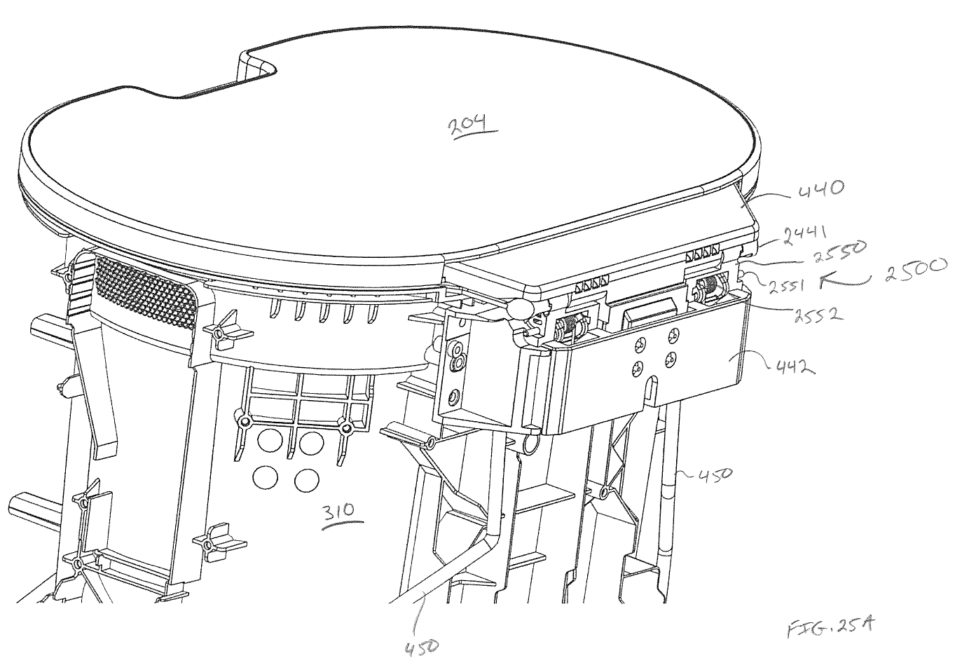

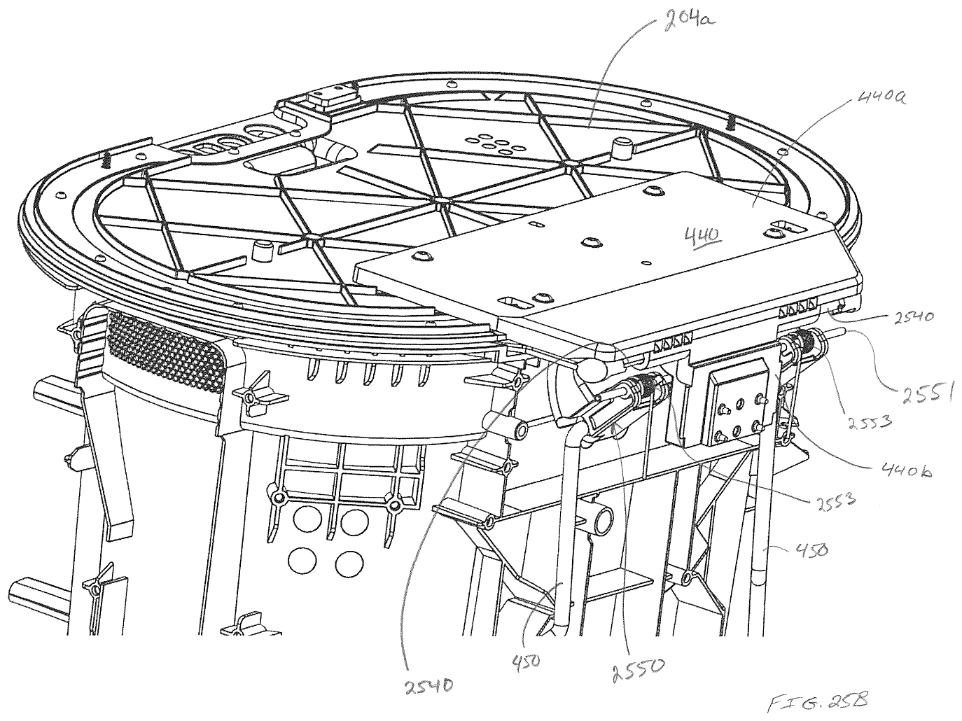

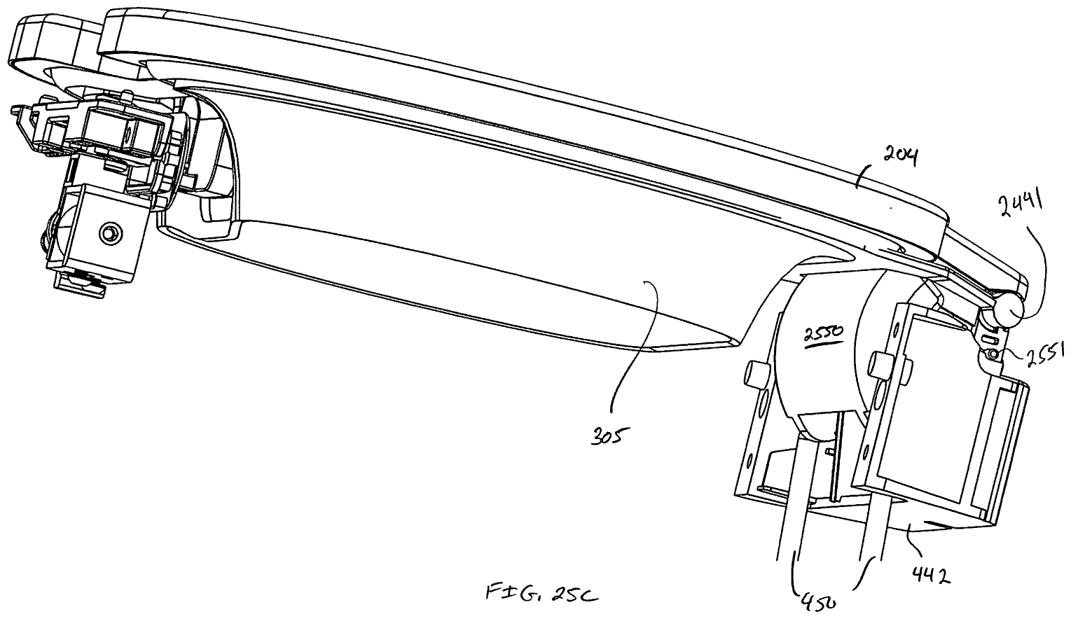

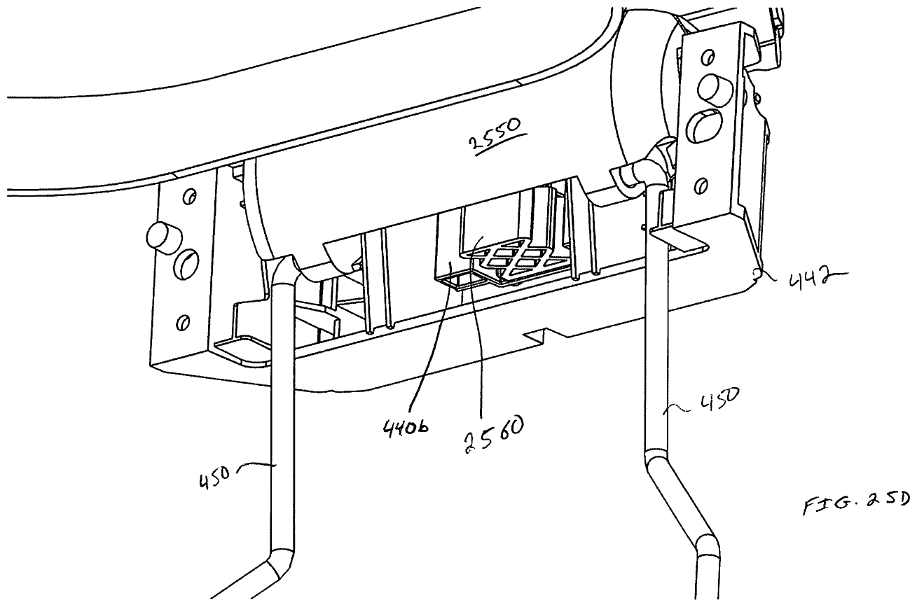

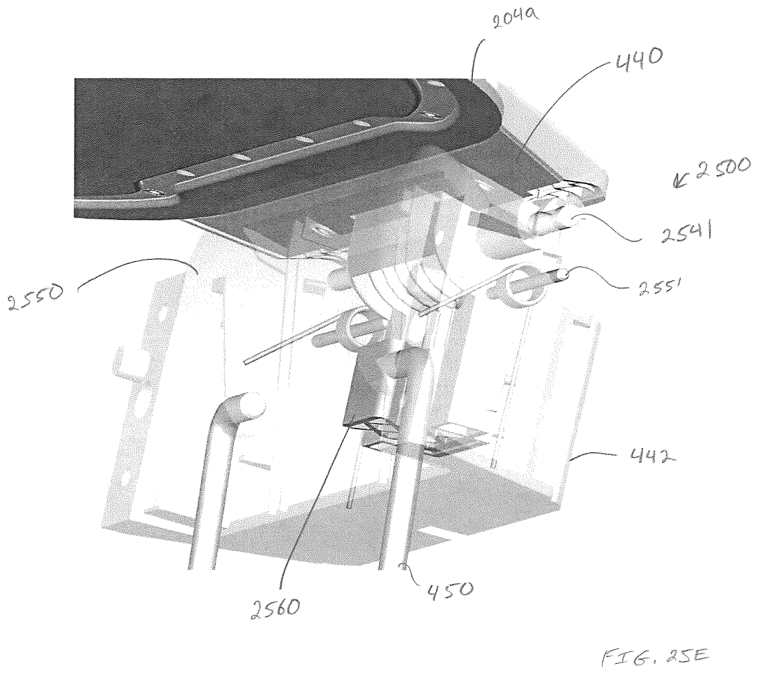

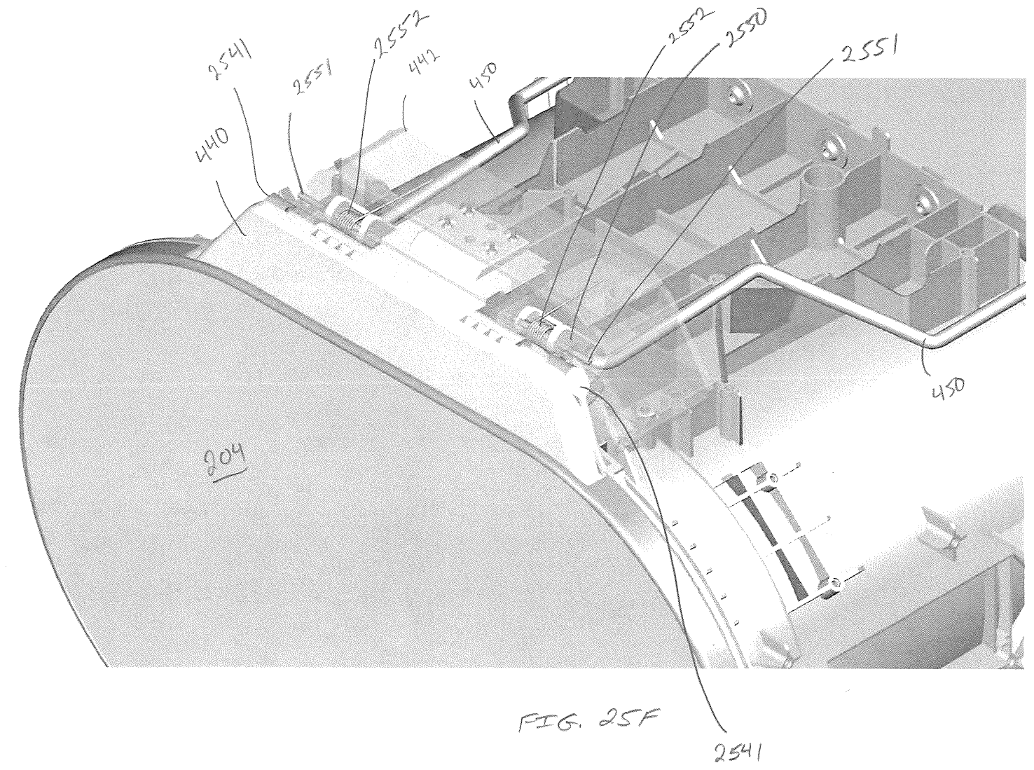

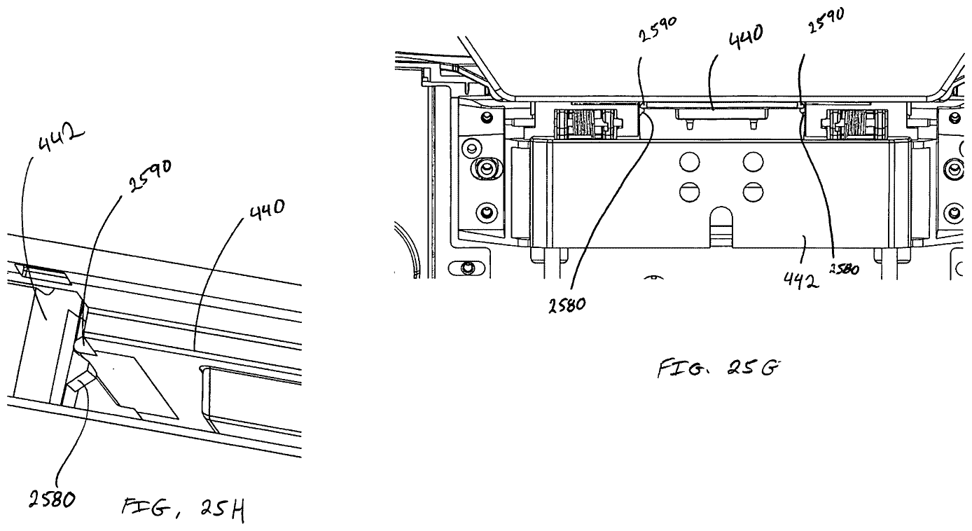

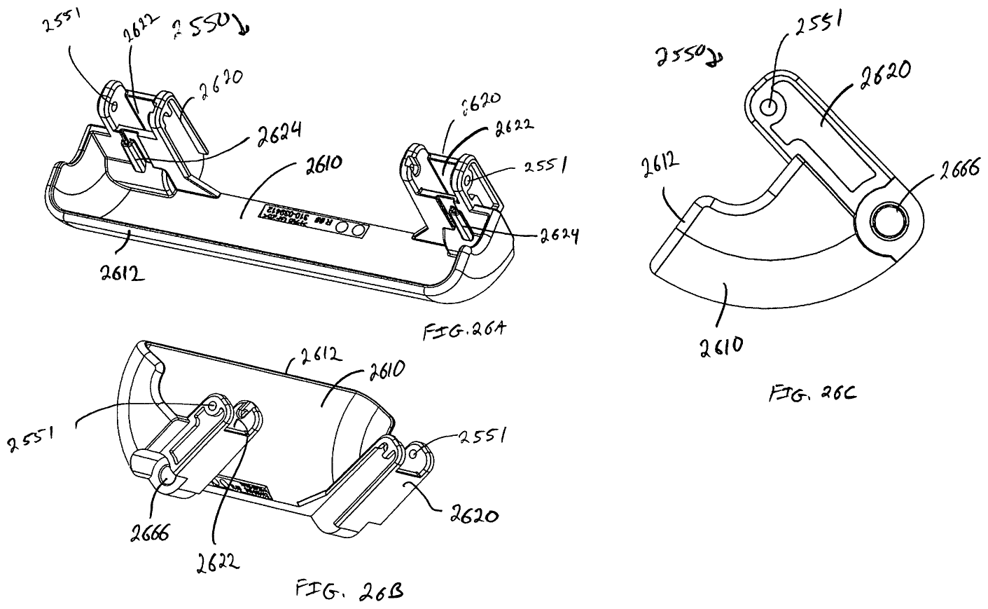

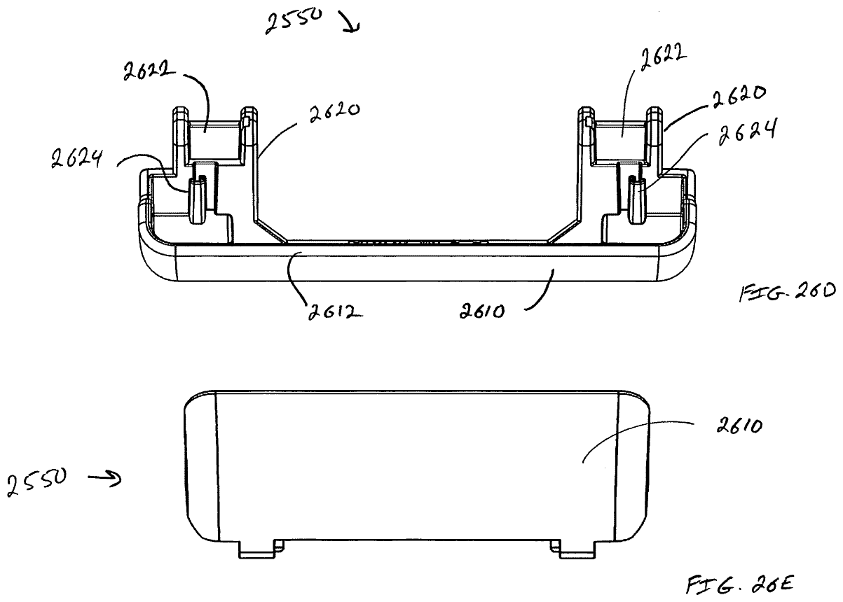

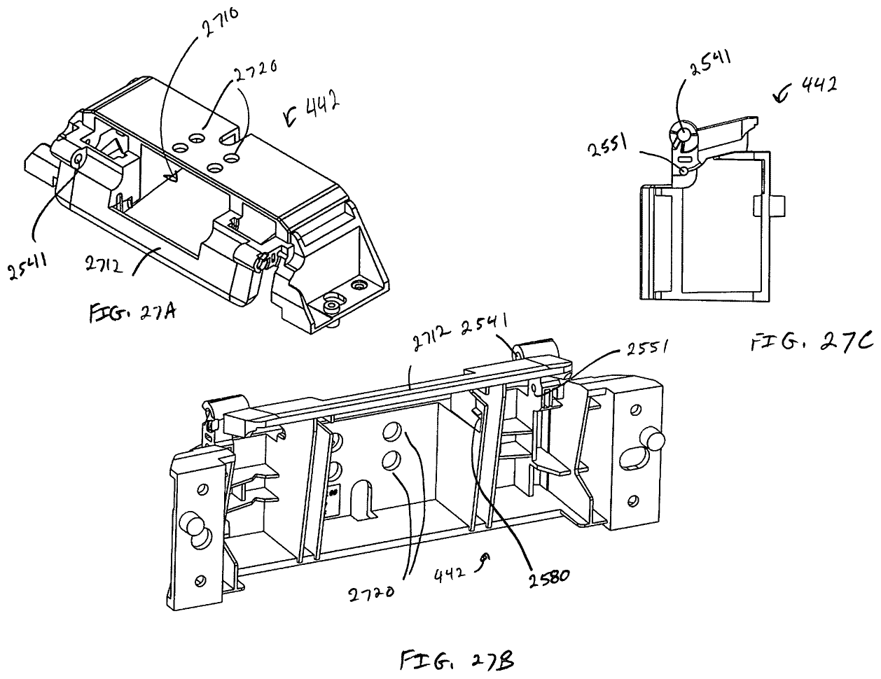

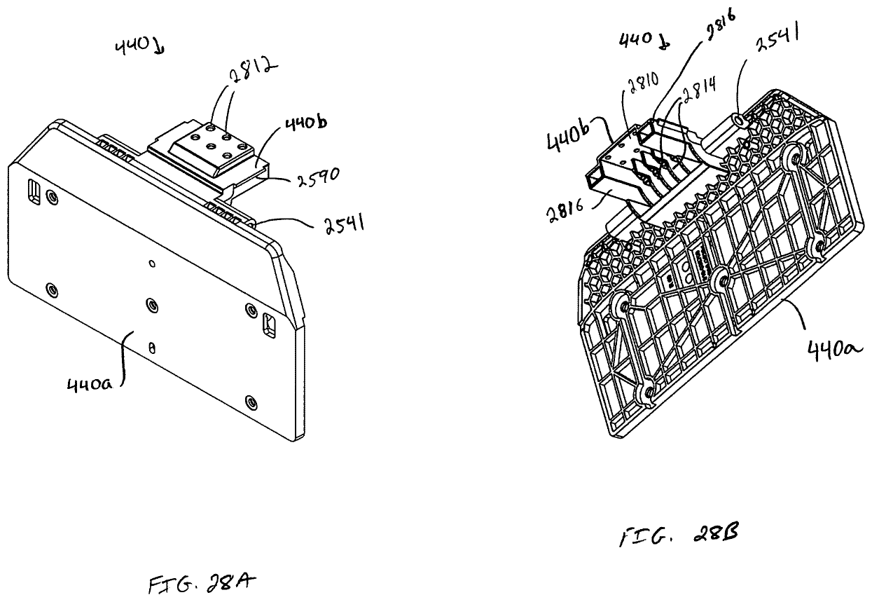

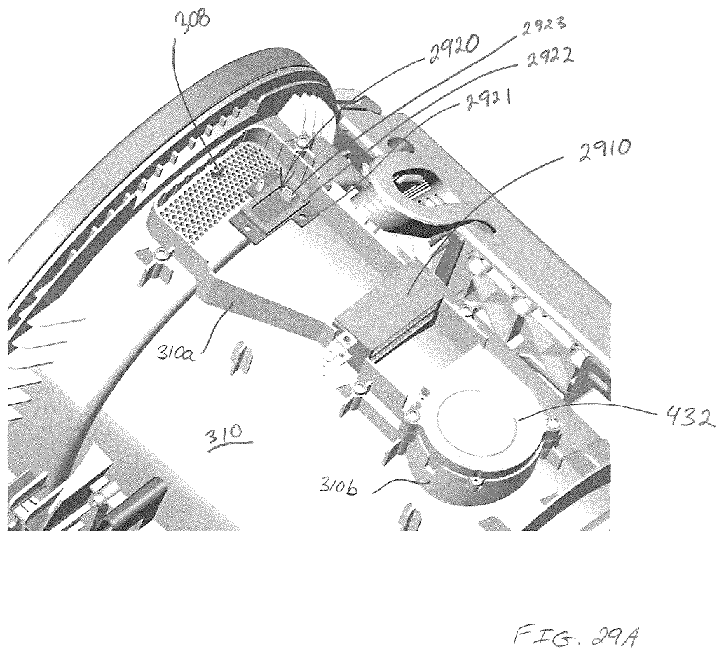

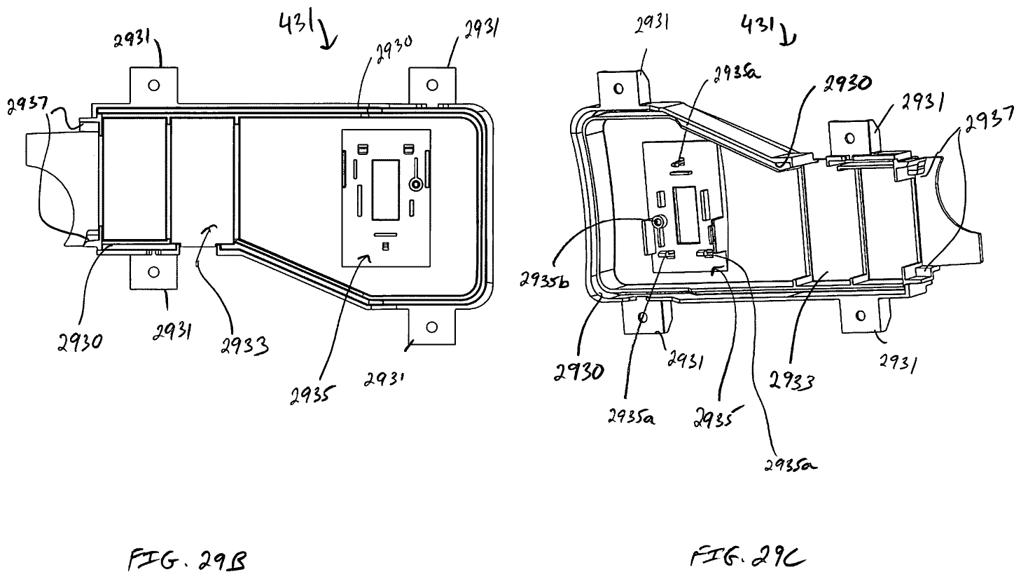

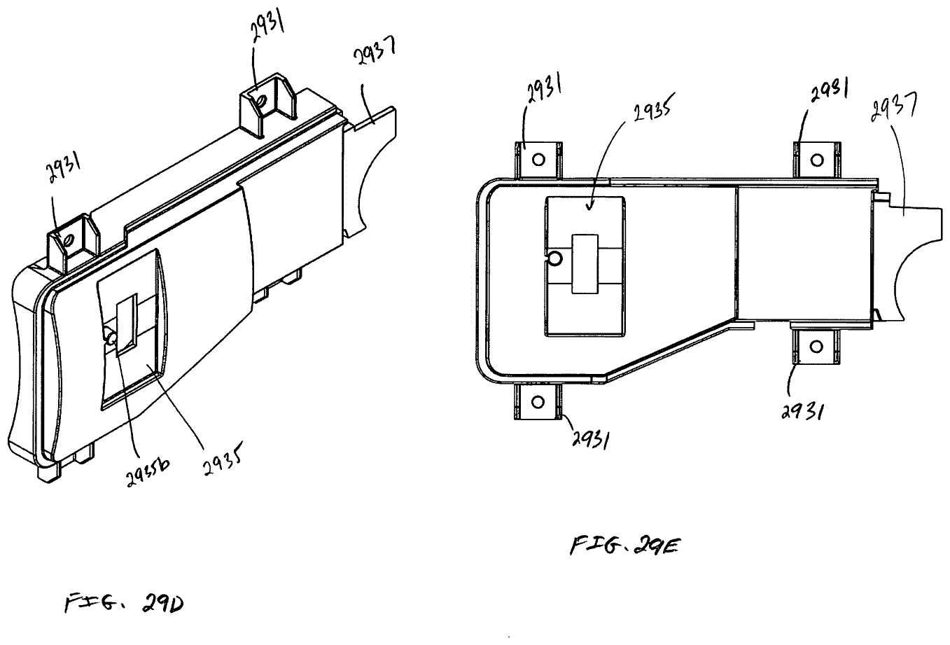

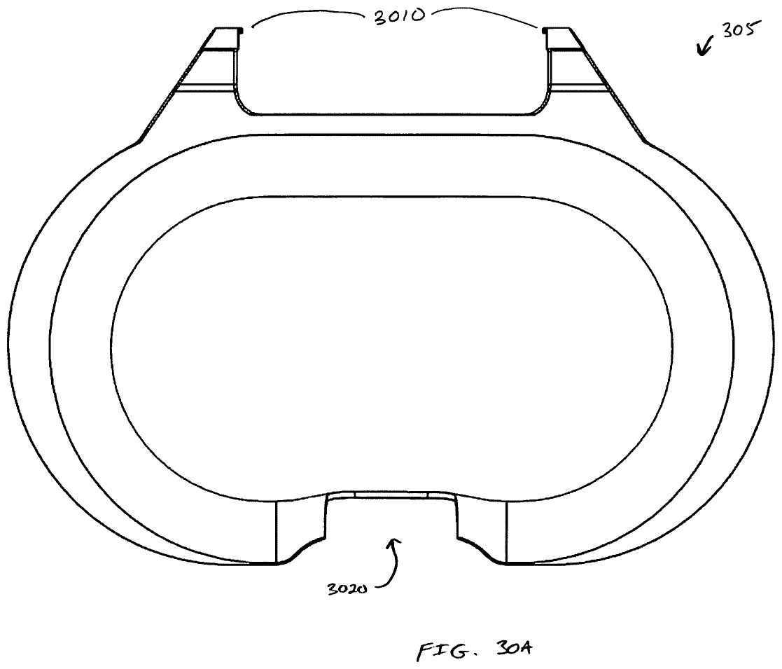

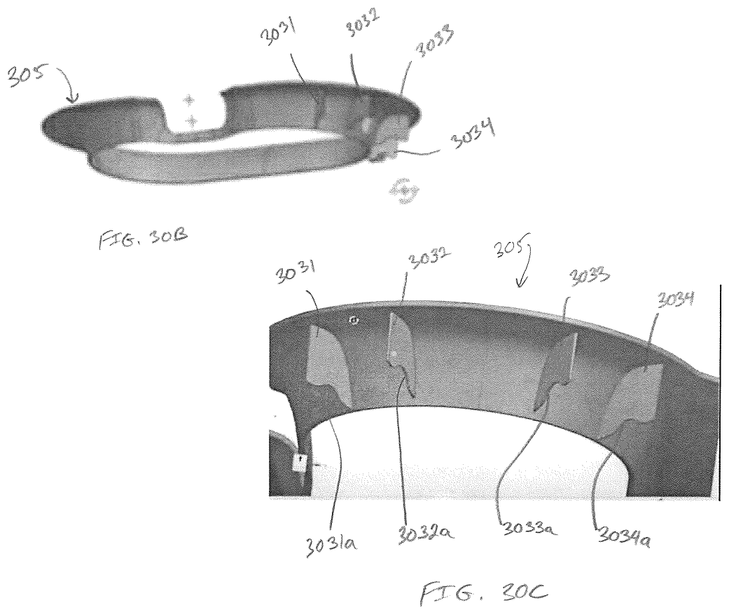

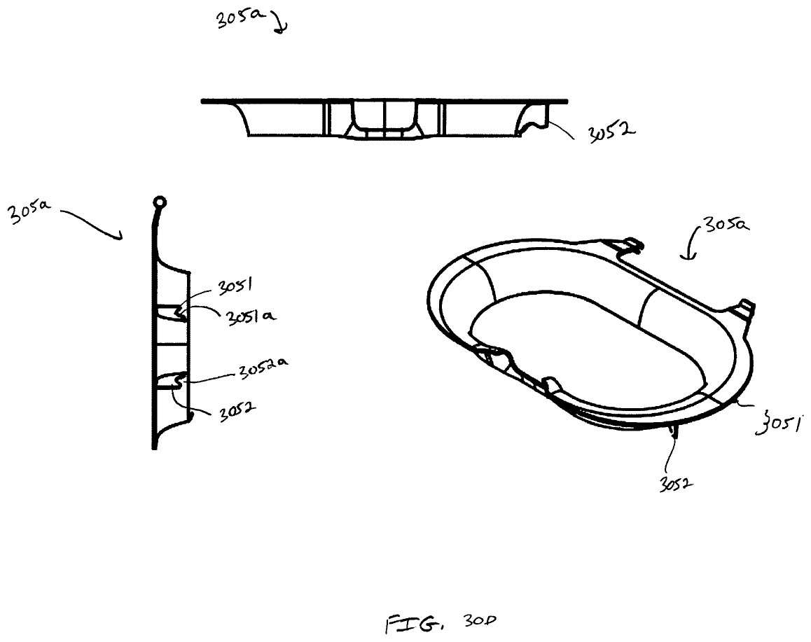

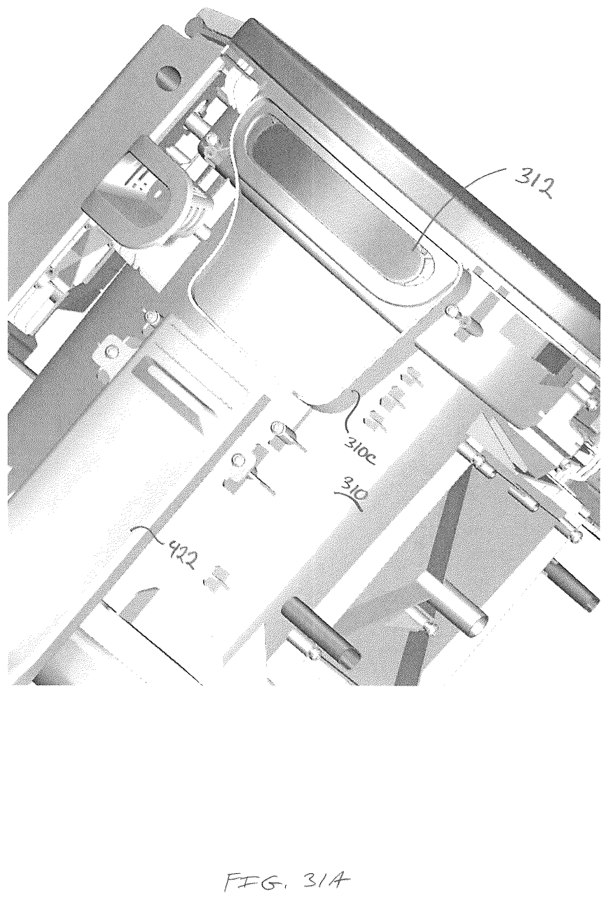

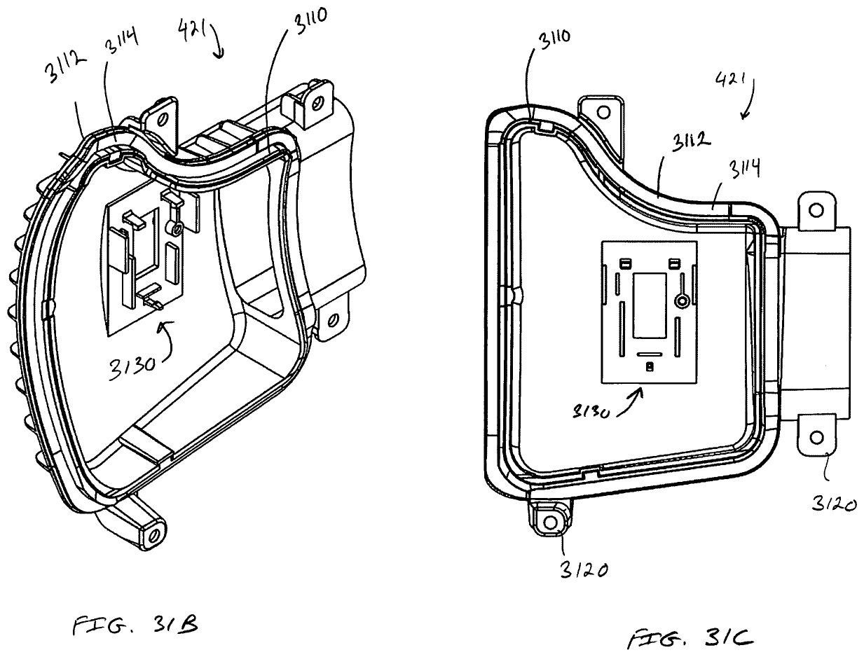

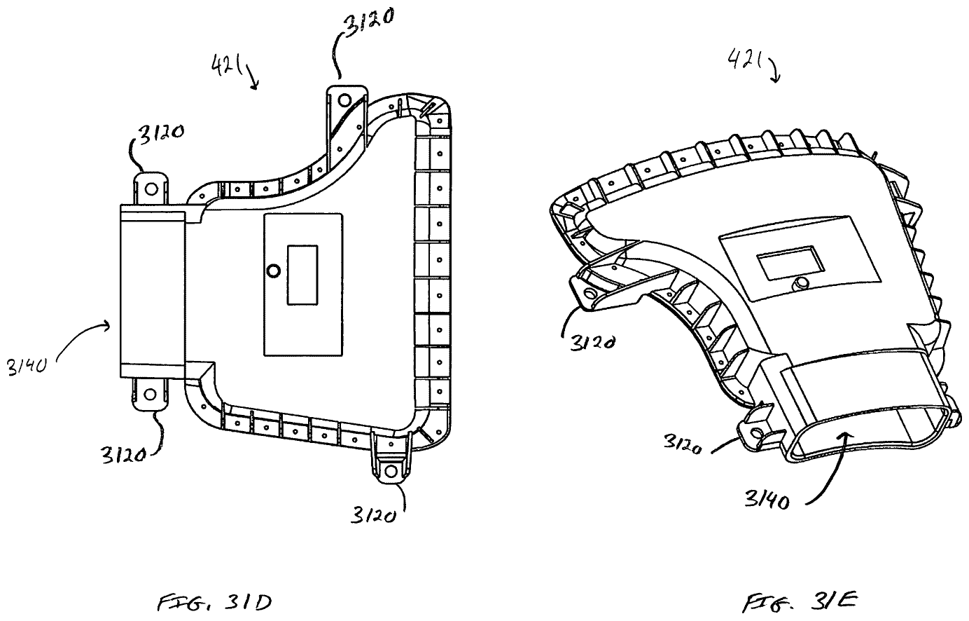

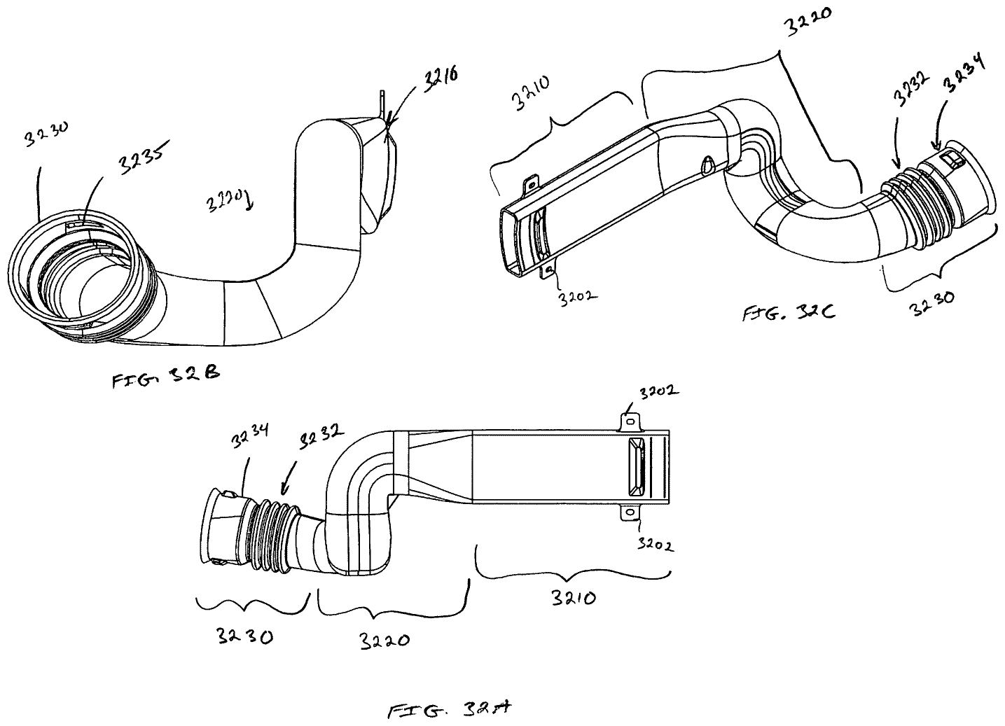

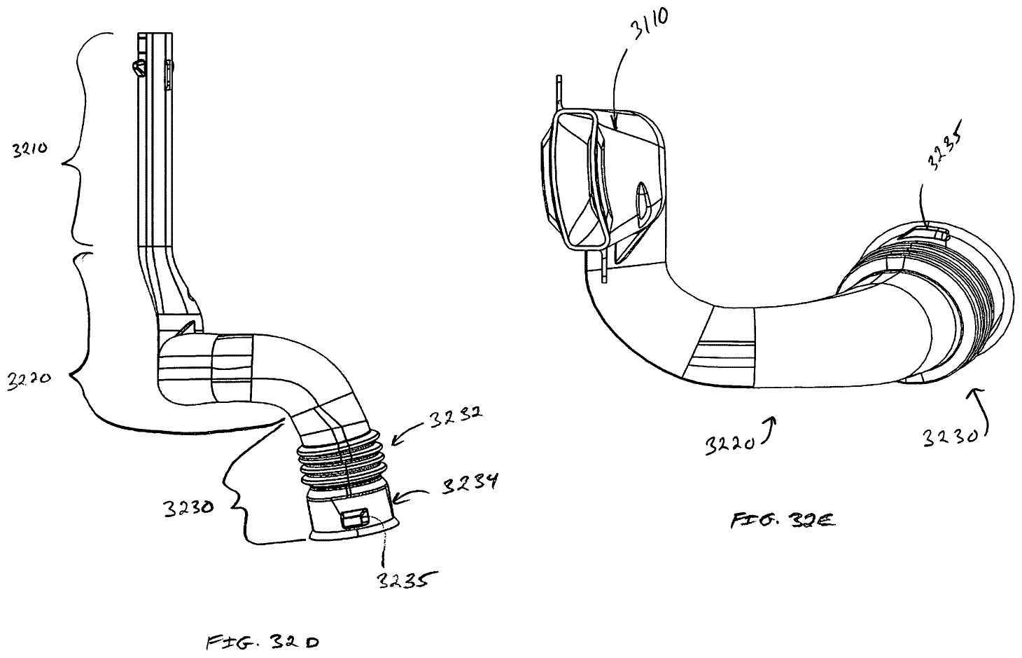

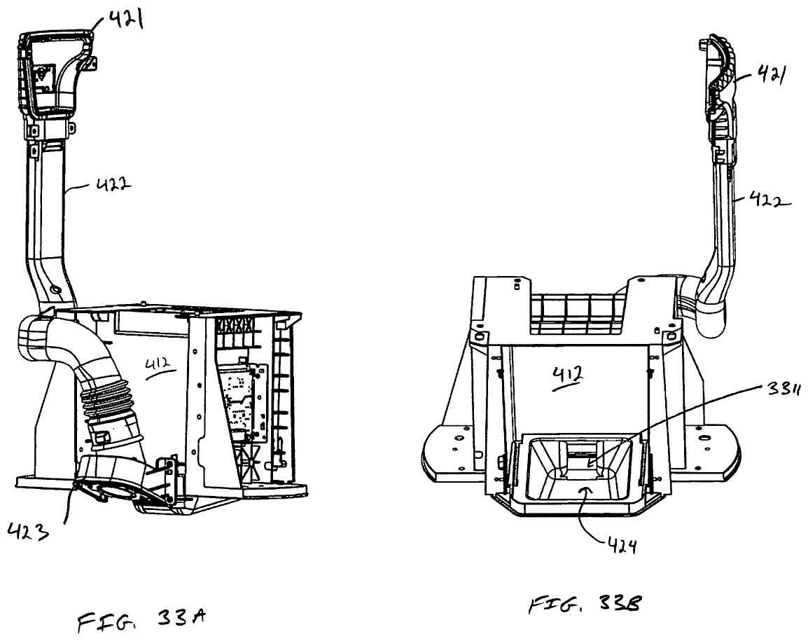

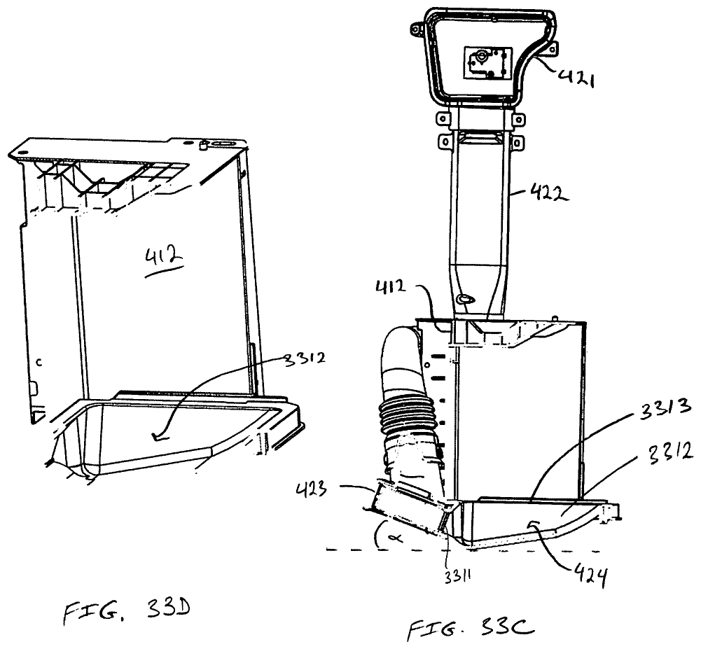

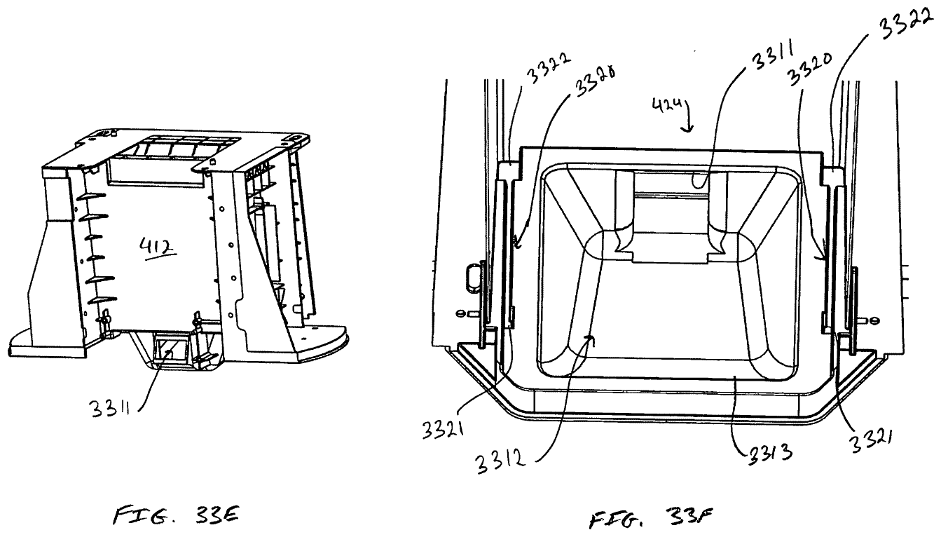

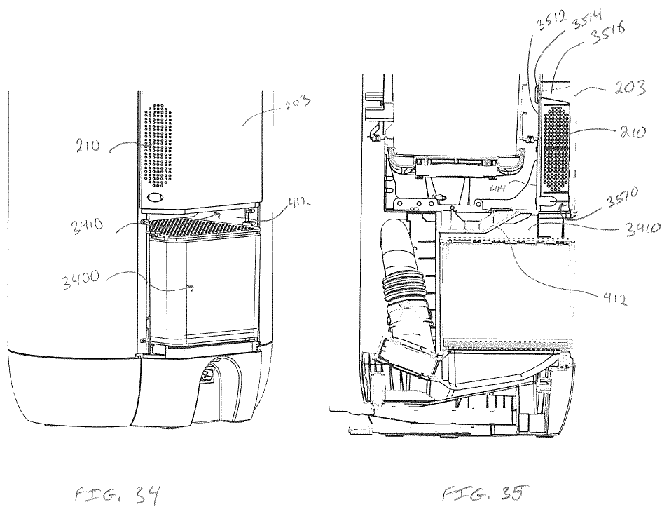

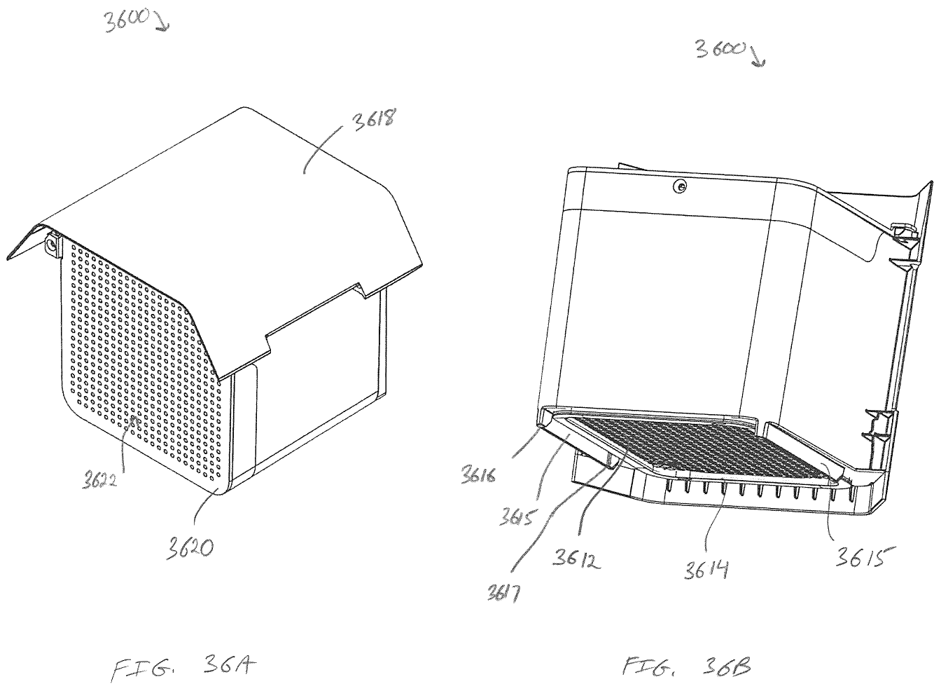

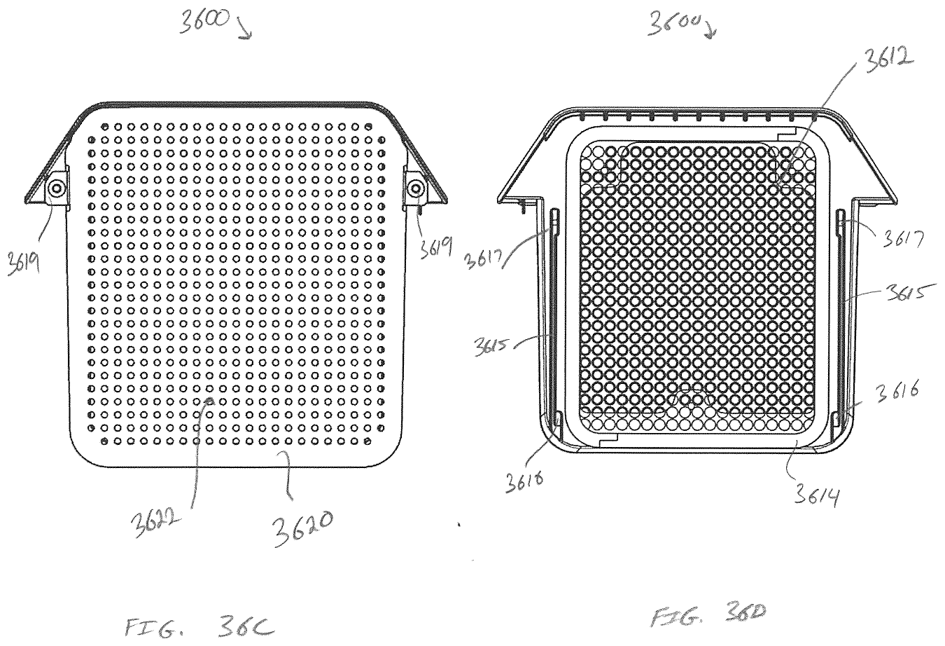

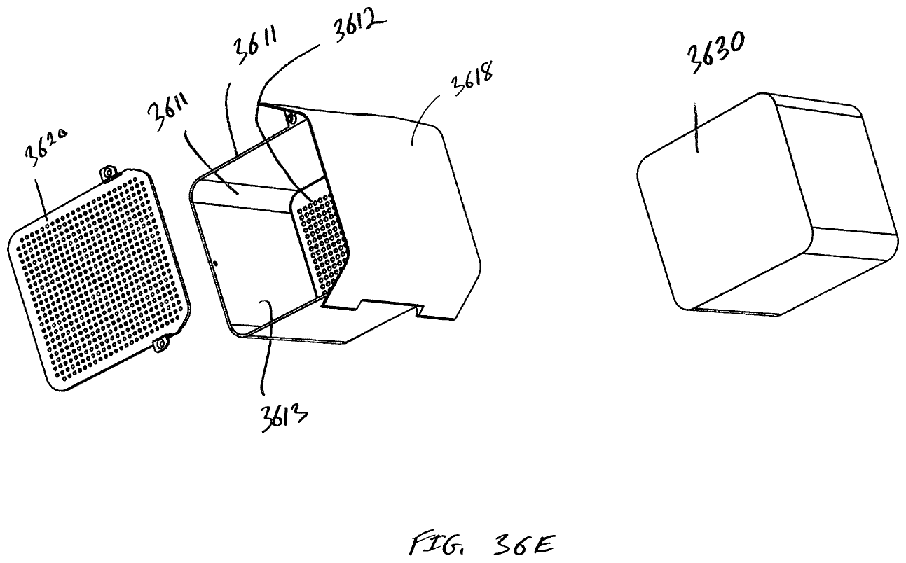

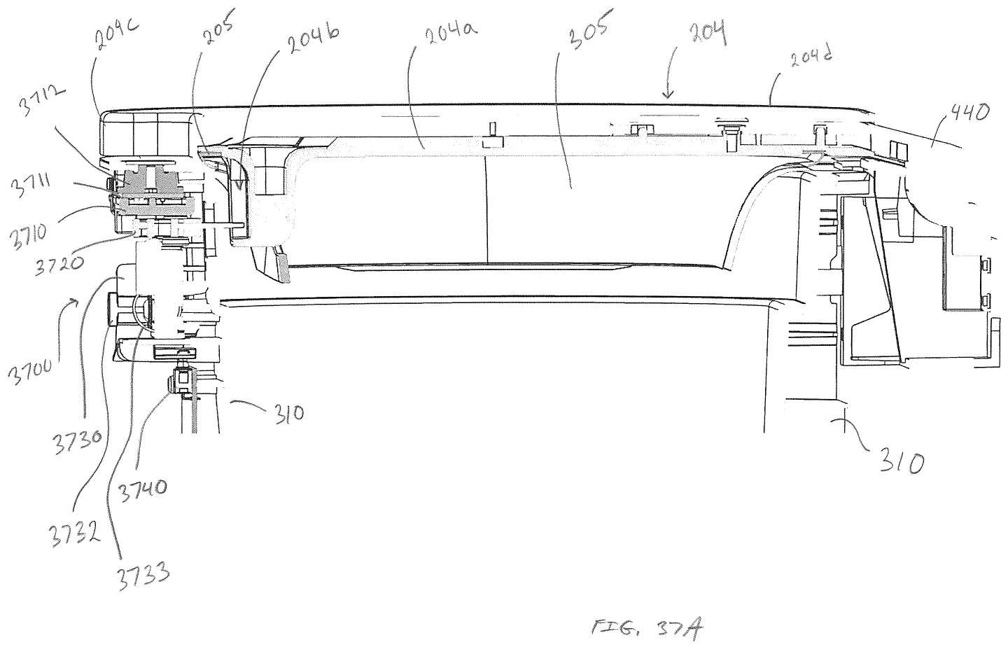

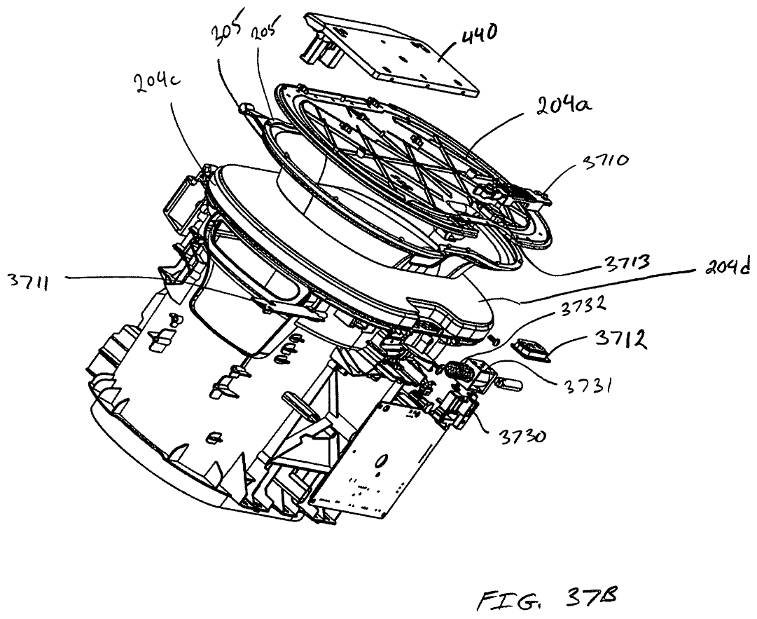

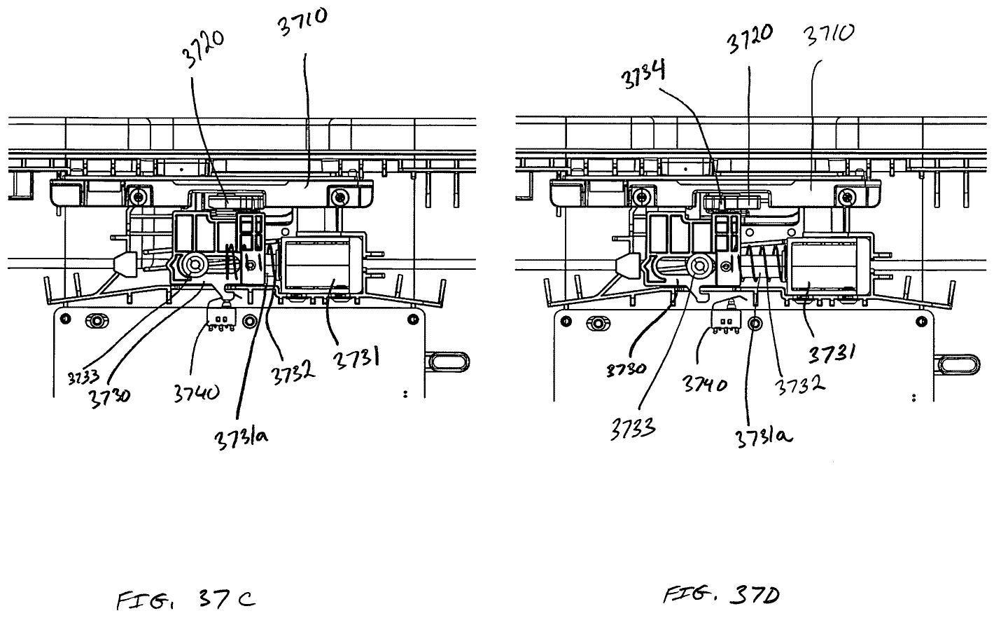

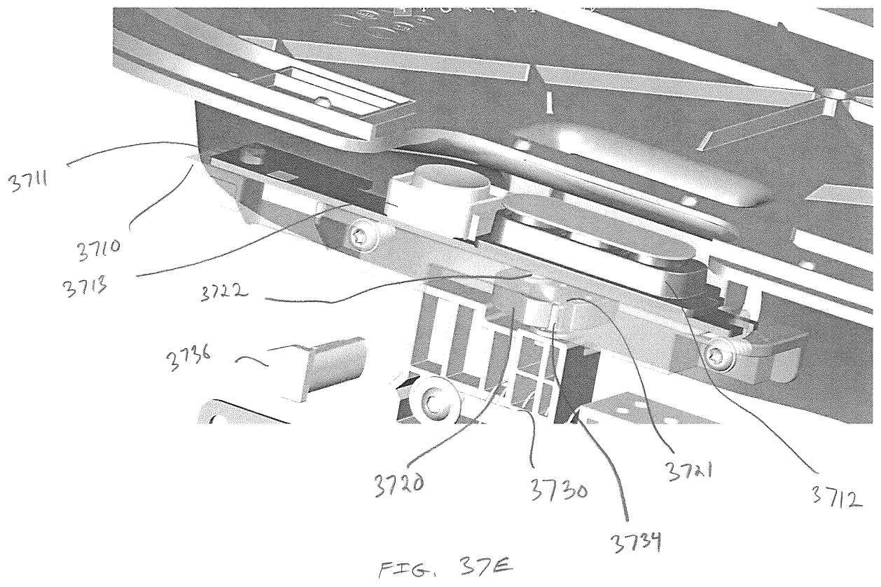

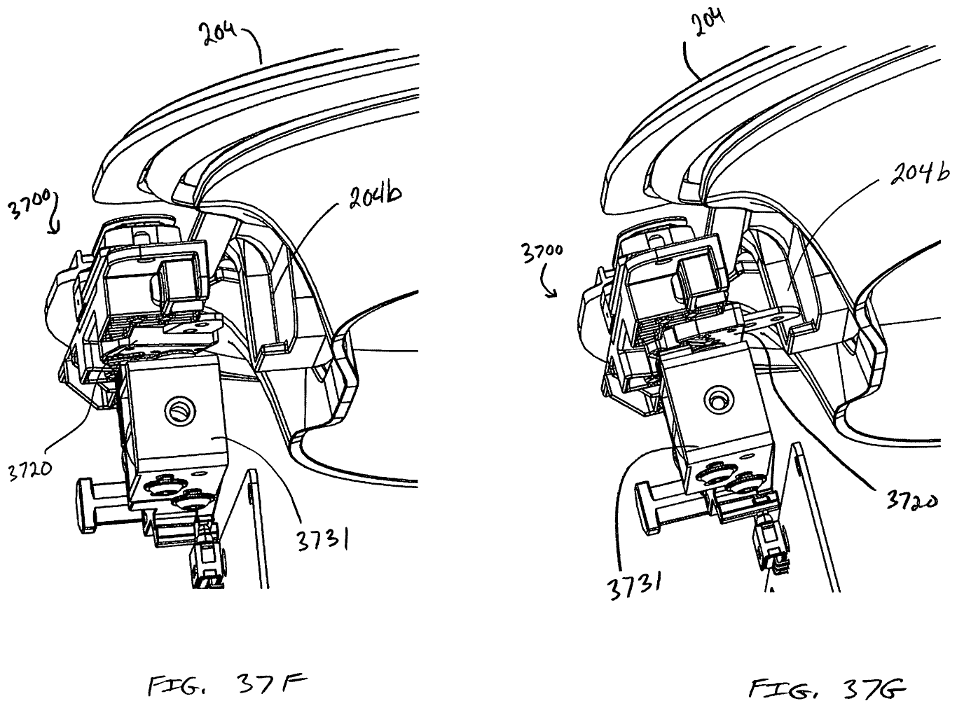

Referring now specifically to FIG. 7, the impeller assemblies 610a and 630a are shown interacting with support structures 712 and 732 and drivetrain components 775 and 785. Impeller assembly 610a can include impeller 610, impeller coupling 615, fastener 616, bearings 704 and 705, gaskets 706 and 707, and other components such as spring clips (not shown). Impeller assembly 630a can include impeller 630, impeller coupling 635, fastener 636, bearings 724 and 725, gaskets 726 and 727, and other components such as spring clips (not shown). Impellers 610 and 630 may be investment cast from a stainless steel into a single integrated body structure. FIGS. 8A-8G and 9A-9G show various views of impellers 610 and 630, respectively. Although impeller 610 is a single integrated structure, it includes many distinct features. For example, impeller 610 may have a base portion 612, a telescoping portion 614, and optional thumb screw member 616, as shown. Base portion 612 is cylindrical in shape, has a partially hollow internal cavity 612a (shown more clearly in FIG. 8B) with extension member 612b existing therein. Base portion 612 is configured to fit over support structure 712. Extension member 612b is designed to be inserted into through-hole 712a of support structure 712. Extension member 612b may be supported by bearings 704 and 705. Gaskets 706 and 707 may each provide a seal between internal cavity 612a and an outer surface of support structure 712. Extension member 612b also be coupled to impeller coupler 615 with fastener 616. Impeller 630 may have a base portion 632, a telescoping portion 634, and optional thumb screw member 636, as shown. Base portion 632 is cylindrical in shape, has a partially hollow internal cavity 632a (shown more clearly in FIG. 9B) with extension member 632b existing therein. Base portion 632 is configured to fit over support structure 732. Extension member 632b is designed to be inserted into through-hole 732a of support structure 732. Extension member 632b may be supported by bearings 724 and 725. Gaskets 726 and 727 may each provide a seal between internal cavity 632a and an outer surface of support structure 712. Extension member 632b also be coupled to impeller coupler 635 with fastener 636.

As also shown in FIG. 7 are parts of the drivetrain. In particular, drivetrain coupler 775 is shown to be interfacing with impeller coupler 615 within the maximum diameter portion of through-hole 712a. In one embodiment, impeller coupler 615 can be the male coupler and drivetrain coupler 775 can be the female coupler. In addition, drivetrain coupler 785 is shown to be interfacing with impeller coupler 635 within the maximum diameter portion of through-hole 732a. In one embodiment, impeller coupler 635 can be the male coupler and drivetrain coupler 785 can be the female coupler.

The engagement between impeller assembly 610a and support structure 712 and the engagement between impeller assembly 630a and support structure 732 are designed to prevent or at least substantially mitigate moisture and debris intrusion into cavities 612a and 633a and drivetrains 775 and 785. In addition, these engagements may also assist in maintaining an airtight seal to prevent air transfer through heat plate 502 and overmold structure 510. The air sealing of various interfaces among liner 310, overmold structure 510, heat plate 502, and drive train couplings are discussed above.

FIGS. 7F-7J show different view of various blade arrays according to various embodiments. In particular, FIGS. 7F and 7G show different views of blade array 660 with blades 662, 664, and 666 and FIGS. 7H and 7I show different views of blade array 650 with blades 654 and 656. FIG. 7I shows an illustrative side view of either blade array 650 or 660 and which view shows the profile blade geometry. In some embodiments, such as those shown, blades 662 and 664 can be connected by member 663, blades 664 and 666 can be connected by member 665, and blades 654 and 656 can be connected by member 653. Members 653, 663, and 665 may be integrally formed with their respective blades of blade arrays 650 and 660. In addition, members 653, 663, and 665 may be curved to match the curvature of the inside surface of metal housing 602. Members 653, 663, and 665 may enhance the structural rigidity of blade array 650 and 660 by distributing any loading force along the length of respective blade arrays 650 and 660. In contrast, if blade array did not include members 653, 663, and 665, any loading would be borne by each blade (e.g., blade 666) individually when a cutting member and that blade are jointly cutting or grinding organic matter. In some embodiments, members 663 and 665 may exhibit a tapered shape from one blade to another. For example, member 665 may be wider at blade 666 than at blade 664. In addition, member 663 may be wider at blade 664 than at blade 662. In some embodiments, member 653 may be uniform in shape between blades 654 and 656 and not exhibit a tapered shape. The shape and configuration of blades 662, 664, 666, 654, and 656 can be selected to enable cutting or grinding to be performed when the impellers rotate in both the clockwise and counterclockwise directions. In addition, the contours and radii thereof can minimize matter accumulation thereon during OMPA processing of organic matter.

FIGS. 8A-8G show different views of impeller 610 according to an embodiment. Impeller 610 may have base portion 612, telescoping portion 614, optional thumb screw member 616, integrated cutting and paddle member 624, and cutting member 626. Base portion 612 is cylindrical in shape, has a partially hollow internal cavity 612a with extension member 612b existing therein. Base portion 612 has dimensions suitable to fit over support structure 712 of metal housing 602 and to accommodate bearings 704 and 705 and gaskets 706 and 707. Cutting member 626 extends from the outer surface of base portion 612. Extension member 612b includes fastener receptacle 612c for receiving fastener 616 to secure impeller coupler 615 thereto. Extension member 612b can also include interface features 612d for interfacing with reciprocal features of impeller coupler 615. Telescoping portion 614 extends up from base portion 612 and integrates with optional screw member 616. Telescoping portion 614 may have a tapered shape where its base is slightly larger than its top. Support arm 614a can extend from telescoping portion 614 to interface with integrated cutting and paddle member 624. Support arm 614a be may co-axially aligned with a center cutting axis of member 624 (e.g., aligned with height H3 of FIG. 6D). Optional screw member 616 may be triangular in shape and configured to enable a person to use his or her thumb and fingers to rotate impeller 610, remove impeller 610 from the bucket assembly, and re-insert impeller 610 into the bucket assembly. In some embodiments, when optional thumb screw member 616 is omitted, telescoping member 614 may terminate the top of impeller 610.

FIG. 8F shows the radial distances, R1 and R2, of distal edges of cutting members 624 and 626, respectively, from a center axis. In some embodiments, R1 and R2 may be substantially the same. In other embodiments, R1 and R2 can be marginally different such as, for example, 1-3% different. In yet another embodiment, R1 is greater than R2. FIG. 8F also shows that cutting member 624 is aligned at 180 degrees with respect to cutting member 626 such that both cutting members 626 and 624 are directly opposite of each other. It should be understood that cutting members 626 and 624 can be aligned at another angle with respect to each other such as between 0 and 179.9 degrees.

Cutting member 626 has a general c-shape with various nuanced features that adorn each of the legs forming part of the c-shape. In particular, cutting member 626 has top leg defined by surfaces 626a and 626b, a bottom leg defined by surface 626d and bottom wall scraper 627, and curved surface 626c. The c-shaped channel of member 626 is formed by surfaces 626b-626d. Both the top and bottom legs may extend radially the same distance from a common rotation axis (not shown) of impeller 610. The shape and configuration of surfaces 626a-d and bottom wall scraper 627 are designed to enhance cutting action and ability to move through organic matter contained in the bucket. For example, the curved geometry of surface 626a may promote an ability to move through organic matter, whereas the flat surface geometry of surface 626b is designed to organic matter. Surface 626d can be curved to promote movement through organic matter and to push organic matter up a bit to engage with the sharp edges of surface 626b. Bottom wall scraper 627 can be defined by scraper member 627a and scraper member 627b that together form a curved channel 627c existing therebetween. Scrapers 627a and 626b both extend towards, but do not touch, bottom surface 602a. In some embodiments, the gap distance, G1, between bottom wall 602a and scraper 627 may range between 0.5 mm and 2 mm. In other embodiments, a gap distance of less than 0.5 mm is possible provided there is no collision with the bottom wall. Scraper members 627a and 627b may both exhibit the same curve geometry to ensure that curved channel 627c is uniform throughout the width of scraper 627.

Cutting member 626 has more cutting/grinding power than cutting member 624. Greater cutting/grinding power is based on physics. Cutting member 626 is located closer to the drivetrain and has less of a moment arm than cutting member 624.

Integrated paddle and cutting member 644 includes cutter cavity 944, which exhibits a c or u shaped profile having a top side and a bottom side, matter redirection member 825 integrally formed with and extending from the top side, and matter redirection member 835 integrally formed with and extending from the bottom side. Cutter channel 824 can have planer surface 824a, curved surface 824b, and planer surface 824c. The gap distance between surfaces 824a and 824c can be less than a gap distance between surfaces 626b and 626d of cutting member 626 (i.e., G2<G1). In some embodiments, the gap distances for cutting members 624 and 626 can be the same (e.g., G1=G2). In some embodiments, the gap distance, G2, for cutting member 624 can range between 10 mm and 40 mm depending on the internal height of the metal housing and the Z height (or vertical) position of the cutting member. If desired, in another embodiment, G1<G2.

Matter redirection members 825 and 835 can both exhibit the same geometry, but oriented in different directions, with member 825 generally pointing up and member 835 generally pointing down. Member 825 can have deflection surface 825a, which is designed to direct organic matter over cutting member 624 when member 624 is rotating in a first direction, and deflection surface 825f, which is designed to direct organic matter into cutter channel 824 when member 624 is rotating in a second direction. Member 835 can have deflection surface 835a, which is designed to direct organic matter over member 624 when member 624 is rotating in the second direction, and deflection surface 835f, which is designed to direct organic matter into cutter channel 824 when member 624 is rotating in the first direction. For example, during operation of impeller 610 during an OMPA processing cycle, impeller 610 may rotate in a clockwise direction for a fixed period of time and then rotate in a counter-clockwise direction for the same fixed period of time such that rotation direction oscillates after expiry of each fixed period of time. When impeller 610 rotates in the clockwise direction, deflection surface 825a may tend to direct organic matter upwards such that the matter flows over cutting member 624, and deflection surface 835f may tend to direct organic matter upwards to channel 824 and/or deflection surface 825a. When impeller 610 rotates in the counter-clockwise direction, deflection surface 835a may tend to direct organic matter downwards such that the matter flows towards cutting member 626, and deflection surface 835f may tend to direct organic matter downwards to channel 824 and/or deflection surface 835a.

Deflection surface 825a can be a multi-contoured surface having a general angle of 826 relative to planar surface 824a. The general angle 826 can range between 40-50 degrees, and in some embodiments, can be 45 degrees. Deflection surface 825a can have different surface contours 825b, 825c, 825d, and 825e that are designed to promote deflection of organic matter past member 624. Deflection surface 825f can have different surface contours 825g, 824h, and 825i that are designed to direct organic matter into cutter channel 824. The surface contours of surface 825f may be designed to prevent mitigate collection of organic matter in the approximate 90 degree curve. The same contours of defection surfaces 825a and 825f can apply to the defection surfaces 835a and 835f, respectively.

FIGS. 8H-8J show impeller 810 with a different scraper 887 according to an embodiment. Impeller 810 is essentially the same as impeller 610 but with a different scraper geometry. Scraper 887 is integrated with the lower cutting portion of cutting member 626 and resembles a double sided plow designed to push organic matter upwards into cutting member 626 when impeller 810 is rotating. Scraper 887 can include plow portion 887a and plow portion 887b that extend from both sides of lower cutting portion 886 of cutting member 626. During rotation of impeller 810, the leading edge of either plow portion 887a or plow portion 887b can impact any existing OMPA input and cause that OMPA input to slide up the plow portion to cutting member 626. The bottom surfaces of plow portions 887a and 887b and lower cutting portion 886 may be substantially flat. This flat potion may be positioned parallel to, but above, the bottom wall of the metal bucket housing by a fixed distance (e.g., 1-2 mm). The upper surface of plow portions 887a and 887b may have a curved surface, a flat planer surface, a multi-curved surface, a curvilinear surface, or any other suitable geometry. In some embodiments, the overall width of scraper 887 may be approximately the same width dimension as integrated paddle and cutting member 624.

FIGS. 9A-9H show different views of impeller 630 according to an embodiment. Impeller 630 may have base portion 632, telescoping portion 634, optional thumb screw member 636, cutting member 642, integrated cutting and paddle member 644, and cutting member 646. Base portion 632 is cylindrical in shape, has a partially hollow internal cavity 632a with extension member 632b existing therein. Base portion 632 has dimensions suitable to fit over support structure 732 of metal housing 602 and to accommodate bearings 724 and 725 and gaskets 726 and 727. Cutting member 646 extends from the outer surface of base portion 632. Extension member 632b includes fastener receptacle 632c for receiving fastener 636 to secure impeller coupler 635 thereto. Extension member 632b can also include interface features 632d for interfacing with reciprocal features of impeller coupler 635. Telescoping portion 634 extends up from base portion 632 and integrates with optional screw member 636. Telescoping portion 634 may have a tapered shape where its base is slightly larger than its top. Support arm 634a can extend from telescoping portion 634 to interface with integrated cutting and paddle member 644. Support arm 634a be may co-axially aligned with a center cutting axis of member 644 (e.g., aligned with height H2 of FIG. 6D). Support arm 634b can extend from telescoping portion 634 to support cutting member 642. Support arm 634b may be co-axially aligned with a center cutting axis of member 642 (e.g., aligned with height H1 of FIG. 6D). Optional screw member 636 may be triangular in shape and configured to enable a person to use his or her thumb and fingers to rotate impeller 630, remove impeller 630 from the bucket assembly, and re-insert impeller 630 into the bucket assembly. In some embodiments, when optional thumb screw member 636 is omitted, telescoping member 634 may terminate the top of impeller 630.

FIG. 9G shows the radial distances, R3, R4, and R5 of distal edges of cutting members 644, 646 and 642, respectively, from a center axis. In some embodiments, R3 and R4 may be substantially the same. In other embodiments, R3 and R4 can be marginally different such as, for example, 1-3% different. In yet another embodiment, R3 is greater than R4. In some embodiments R1 may be the same as R3 and R2 may be the same as R4. In some embodiments, R5 may be greater than R3 and R4 (and R1 and R2). For example, R5 may be 5-10% longer than R3. FIG. 9G also shows that cutting member 644 is aligned at 180 degrees with respect to cutting member 646 such that both cutting members 646 and 644 are directly opposite of each other. Cutting member 642 may be aligned somewhere between 0.1 and 179.0 degrees with respect to cutting member 644 or cutting member 646. In particular, angle 901 between cutting members 646 and 642 can be between 1 and 90 degrees, between 10 and 60 degrees, between 25 and 55 degrees, between 35 and 45 degrees, or between 37 and 43 degrees.

Cutting member 646 may have the same general c-shape as cutting member 626 and therefore includes the various nuanced features that adorn each of the legs forming part of the c-shape. Cutting member 646 also includes bottom wall scraper 647, which is similar to bottom wall scraper 627. The same attributes of cutting member 626 apply to cutting member 646 and therefore will not be repeated. That is, cutting member 646 can have the same surface geometries and bottom wall scraper as those existing in cutting member 626. For example, the gap distance between the legs can be the same as those in cutting member 626.

Cutting member 646 has more cutting/grinding power than cutting member 644 and cutting member 642. Greater cutting/grinding power is based on physics. Cutting member 646 is located closer to the drivetrain and has a shorter sweep radius than cutting member 642. As a result, cutting member 646 has less of a moment arm than cutting member 642.

Integrated paddle and cutting member 644 includes cutter channel 924, which exhibits a c or u shaped profile having a top side and a bottom side, matter redirection member 925 integrally formed with and extending from the top side, and matter redirection member 935 integrally formed with and extending from the bottom side. Cutter channel 924 and redirection members 925 and 935 may exhibit the same shape and geometries as those previously described in connection with cutting member 624. For example, matter redirection members 925 and 935 can both exhibit the same geometry as the redirection members of cutting member 624. As such, when impeller 630 rotates, cutting member 644 can move/direct organic matter similarly to how cutting member 624 can move/direct organic matter. The gap distance of channel 924 be the same as the gap distance in cutting member 624. In some embodiments, the gap distance for cutting member 624 can range between 10 mm and 40 mm depending on the internal height of the metal housing and the Z height (or vertical) position of the cutting member.

Cutting member 642 may have a general c shape including two leg portions 642a and 642c joined together with curved portion 642, wherein the curved portion is integrated with support arm 634b. Cutting member 642 may be designed to cut relatively tall objects that are inserted into the bucket, such as, for example, corn cobs, celery stalks, potatoes, etc. Channel 642d is formed with interior surface 642ai, curved surface 642bi, and interior surface 642ci. Interior surfaces 642ai and 642ci can have planer surfaces, similar to the planer surfaces of the leg portions of cutting member 644. Exterior surfaces 642ae and 642ce can be substantially flat with curved edges, as shown. The gap distance, D1, between interior surfaces 642ai and 642ci can range between 10 mm and 40 mm. Gap distance, D1, can be larger than gap distances, D2 and D3, of respective cutting members 644 and 642. In some embodiments, D1>D3>D2. In some embodiments, D2-G2 and D3=G1.

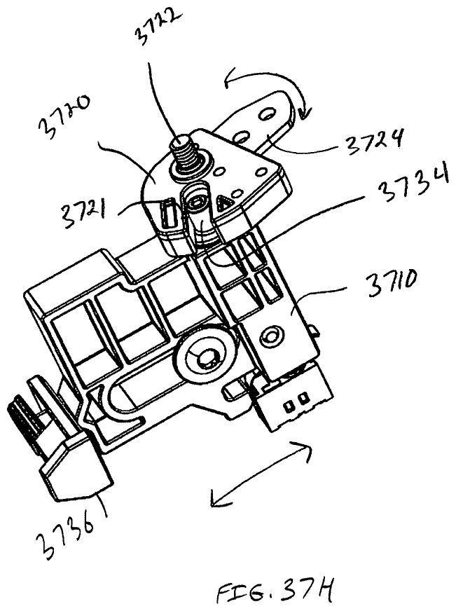

FIGS. 91-9K show impeller 930 with a different scraper 987 according to an embodiment. Impeller 930 is essentially the same as impeller 630 but with a different scraper geometry. Scraper 987 is integrated with the lower cutting portion of cutting member 626 and resembles a double sided plow designed to push organic matter upwards into cutting member 646 when impeller 930 is rotating. Scraper 987 can include plow portion 987a and plow portion 987b that extend from both sides of lower cutting portion 986 of cutting member 646. During rotation of impeller 930, the leading edge of either plow portion 987a or plow portion 987b can impact any existing OMPA input and cause that OMPA input to slide up the plow portion to cutting member 646. The bottom surfaces of plow portions 987a and 987b and lower cutting portion 986 may be substantially flat. This flat potion may be positioned parallel to, but above, the bottom wall of the metal bucket housing by a fixed distance (e.g., 1-2 mm). The upper surface of plow portions 987a and 987b may have a curved surface, a flat planer surface, a multi-curved surface, a curvilinear surface, or any other suitable geometry. In some embodiments, the overall width of scraper 987 may be approximately the same width dimension as integrated paddle and cutting member 644.

Grinding mechanisms (and the power available to those grinding mechanisms) may govern the types of OMPA input that can be handled by a given OMPA. Generally, stronger grinding mechanisms in combination with more power will allow heavier duty OMPA input (e.g., bones) to be handled without issue. Accordingly, different embodiments of OMPA could be designed for residential environments (e.g., with less power and weaker grinding mechanisms) and commercial environments (e.g., with more power and stronger grinding mechanisms).

In some embodiments, the bucket assembly 600, and more particularly, housing 602 is thermally conductive in its entirety and can convey heat from heat plate 502 to the OMPA input. As heat plate 502 heats up housing 602, the heat may radiate up the peripheral walls of the bucket. The heated bucket, coupled with heated or ambient temperature inlet air, can promote drying of OMPA input contained in the bucket. An OMPA processing algorithm can control the operation of the impellers, the heat plate, inlet fan speed, and inlet heater temperature, among controllable features to convert OMPA input to OMPA output. Heat plate 502 may be outfitted with one or more sensors (e.g., thermistors) to detect the temperature of the heat plate. In some embodiments, a temperature based cutoff switch may be used to turn off heat plate 502 to prevent thermal runaway.

When the bucket assembly 600 is installed within liner structure 310, heat plate facing surface 603a interface with heat plate 502 and impeller couplers engage with respective drivetrain couplers. The bucket assembly engagements are mechanical, self-registering, and universal. There are no electrical connections required with inserting bucket assembly 600 into the OMPA. The impeller coupling and drivetrain coupling designs are such that they self-register with each other during the insertion process. The mechanical registrations are universal in that the bucket assembly can be inserted in any orientation (e.g., impeller 610 can be on the left side or the right side).

A mass sensing system may be incorporated into the OMPA so that mass measurements can be made throughout an organic matter processing cycle or anytime the bucket is present within the OMPA. The mass sensing system may include one or more mass sensors such as, for example, a strain gauge mass sensor. The mass sensor included in the OMPA may continually or periodically output measurements that can be used to calculate, infer, or otherwise establish the total weight of the bucket 602 (including any OMPA input stored therein). These measurements can be communicated to a controller (e.g., controller 110 of FIG. 1). The controller may determine how to control other components of the OMPA (e.g., its drying and grinding mechanisms) based on these measurements. For example, the controller may determine how long to perform high intensity processing based on the rate at which the weight lessens due to loss of moisture. Mass sensing may play an important role in ensuring that the OMPA can dynamically react to changes in the state of the OMPA input.

As shown in FIGS. 6A and 6B, the cavity defined by the interior surface of the bucket 602 may be symmetrical across the longitudinal and latitudinal planes defined therethrough. For reference, the term “latitudinal plane” may be used to refer to the plane that is substantially parallel to the handle 606 while extended upward as shown. Meanwhile, the term “longitudinal plane” may be used to refer to the plane that is substantially orthogonal to the latitudinal plane. For example, the cavity may be elliptical in shape with a bottom wall and a peripheral wall extending therefrom. The usable value of the bucket may be around 7 liters, which is less than the entire volume of the bucket because the user should empty the bucket when the OMPA output reaches or approaches a designated fill line. The fill line may be set at a height of 60-70 percent the overall internal height of the bucket. In one embodiment, the fill line may be set at a height of around 155 mm from the bottom wall. One advantage of bucket assembly is that is relatively lightweight, sufficiently compact to fit into a convention residential sink, and constructed from durable materials that can withstand high temperatures of a dishwasher, for example. The bucket assembly does not include the weight of the drivetrain (e.g., the gears and motor), the heat plate, or other components.

An important aspect of increasing adoption is that the OMPA should be easily deployable and operable. The component with which many users will interact most frequently is the lid (e.g., lid 204 of FIG. 2A). Accordingly, it is important that the lid be easy to use but also offer some functionality. As an example, a user may not only be able to open the lid with her hands, but also by interacting with a mechanical pedal switch that is accessible along the front side of the OMPA. Depressing the pedal causes lid 204 to open. A mechanical linkage connecting the pedal to the lid can span the vertical height of the OMPA. This linkage can include features that provide a pleasant lid opening experience for the users. For example, the lid opening event can be characterized as having a rapid initial angular velocity but as the lid reaches a certain percentage of a fully open lid angle, the angular velocity can be gradually ramped down until the fully open lid angle is reached. An overtravel mechanism may be used to prevent overtravel and bounce back of the lid during opening. When the pedal is released, the lid can “soft” close. A dampener can be used to impart the soft close. A user may be able to manually lift the lid without depressing the pedal. The user may also be able to lock back the lid, if desired, by pressing the lid farther back to engage lid lock detents that enable the lid to lock back.

The lid may be controllably lockable, for example, via a damped mechanism with a smooth spring-loaded retraction. Assume, for example, that the OMPA is performing high intensity processing where the bucket assembly is heated. In such a situation, the lid may remain locked so long as the temperature of the processing chamber (or its contents) remains above a threshold (e.g., programmed in memory). This locking action may serve as a safety mechanism by ensuring that a user cannot easily access the interior of the OMPA under unsafe conditions. Note, however, that the user may still be able to override this locking action (e.g., by interacting with an input mechanism accessible along the exterior of the OMPA).

Air may be “sucked” downward into the air treatment system whenever the lid is opened, thereby preventing odors from escaping into the ambient environment. This action may be particularly helpful in preventing odors from escaping the OMPA when the lid is opened mid-cycle (i.e., while the OMPA input is being dried or ground). This action can be initiated by a controller based on one or more outputs produced by a sensor that is located proximate to where the lid contacts the durable housing when in the closed position. For example, a sensor could be located along the periphery of the lid, and its output may be indicative of whether the lid is adjacent to the durable housing (i.e., in the closed position). As another example, a sensor could be located along the periphery of the durable housing, and its output may be indicative of whether the lid is adjacent to the durable housing (i.e., in the closed position).

### Overview of Operating States

Over time, the OMPA may cycle between various states to process OMPA input. As mentioned above, the OMPA may be able to convert OMPA input into a relatively stable product (e.g., food grounds) by drying and grinding the OMPA input. The control parameters for drying or grinding the OMPA input may be dynamically computed (e.g., by the controller 110 of FIG. 1) as a function of the outputs produced by sensors tasked with monitoring characteristics of the air traveling through the OMPA, as well as the mass or weight of the OMPA input in the processing chamber. For example, the control parameters could be dynamically computed as a function of (i) humidity of the air traveling through the OMPA, (ii) temperature of the air traveling through the OMPA, and (iii) weight of OMPA input contained in the OMPA. FIG. 10 includes an example of an operating diagram that illustrates how control parameters can be dynamically computed in accordance with an intelligent time recipe in order to process the contents of an OMPA.

As mentioned above, the OMPA may be able to intelligently cycle between different states to process OMPA input. Six different states are described in Table I. Those skilled in the art will recognize, however, that embodiments of the OMPA may be able to cycle between any number of these states. For example, some OMPAs may only be able to cycle between two, three, or four of these states, while other OMPAs may be able to cycle between all six states.

The OMPA may rely on a single target criterion or multiple target criteria to determine when to cycle between these states. The target criteria could be programmed into the memory of the OMPA, or the target criteria could be specified by a user (e.g., through an interface generated by a control platform). Examples of target criteria include moisture level, temperature, and weight. Using moisture level as an example, there may be multiple preset moisture levels (e.g., 10, 20, 30, and 40 percent) from which the target criterion could be selected (e.g., based on the nature of the OMPA input). The OMPA may not measure moisture of the OMPA input but can instead predict or infer the moisture based on, for example, the humidity of air traveling through the OMPA and the weight of OMPA input. The OMPA could also rely on the average times for completion of these states. Assume, for example, that the OMPA receives input indicative of a request to process OMPA input deposited into the processing chamber. In such a situation, the OMPA may determine when to schedule the various states based on (i) how long those states have historically taken to complete and (ii) the weight of the OMPA input, among other factors. For example, the OMPA may attempt to schedule high intensity processing to be completed overnight as the grinding mechanisms may operate at a noise that might disturb nearby individuals.

TABLE I
Descriptions of states for processing OMPA input.

| State Identifier (ID) | State Description |
|---|---|
| High Intensity Processing (HIP) | Goal: Achieve the target moisture level at |
| | a given temperature. |
| | Details: Temperature, airflow, and/or |
| | grinding mechanisms can be set to high |
| | settings. HIP normally takes at least |
| | several hours to complete, so the OMPA |
| | may attempt to schedule overnight. HIP |
| | may be triggered manually (e.g., via an |
| | interaction with an input mechanism, or |
| | via an instruction provided through the |
| | control platform) or automatically (e.g., |
| | based on a determination that the weight |
| | of the OMPA input exceeds a threshold). |
| Sanitize | Goal: Kill at least a predetermined |
| | number (e.g., greater than 99 percent) of |
| | pathogens. |
| | Details: Settings are similar to HIP, |
| | though the temperature is higher. By |
| | default, sanitization may be performed |
| | before, during, or after HIP. Thus, |
| | sanitization may be considered part of |
| | HIP in some instances. |
| Low Intensity Processing (LIP) | Goal: Advance drying in a non-intrusive |
| | manner while individuals are more likely |
| | to be nearby (e.g., during daylight hours). |
| | Details: Temperature, airflow, and/or |
| | grinding mechanisms can be set to low |
| | settings. While LIP may be similar to HIP |
| | in operation, LIP may be more suitable if |
| | individuals may be nearby. For example, |
| | the noise generated by the grinding |
| | mechanisms will typically be more |
| | tolerable at low settings than at high |
| | settings. |
| Burst Grind | Goal: Incorporate wet (e.g., unprocessed) |
| | OMPA input into dry (e.g., processed or |
| | semi-processed) OMPA input to make |
| | drying easier. |
| | Details: Temperature and airflow may be |
| | maintained at the same settings as the |
| | prior state (e.g., HIP or LIP), but the |
| | grinding mechanisms can be set to a |
| | higher state to grind the wet OMPA input |
| | that has been newly added. Burst grind |
| | may be performed when new OMPA |
| | input is added to the processing chamber |
| | while HIP or LIP is being performed. |
| Standby | Goal: Conserve power once the target |
| | criteria have been reached. |
| | Details: Temperatures, airflow, and/or |
| | grinding mechanisms can be off, unless |
| | necessary to meet some other criterion. |
| | For example, airflow and/or grinding |
| | mechanisms may be occasionally |
| | triggered to maintain an odor criterion. |
| Cooldown | Goal: Allow the user to handle the |
| | processing chamber. |
| | Details: Settings are similar to standby, |
| | though airflow may be higher if necessary |
| | to cool the processing chamber or the |
| | product stored therein. |

As mentioned above, the durations of these states can be dynamically determined based on, for example, analysis of outputs generated by sensors housed in the OMPA. However, the durations of these states are predefined—at least initially—in some embodiments. For example, high intensity processing may be programmed to occur for a certain amount of time (e.g., 4, 6, or 8 hours), and burst grind may be programmed to occur for a certain amount of time (e.g., 30 seconds, 5 minutes, 30 minutes) whenever new OMPA input is added. Those skilled in the art will also recognize that the duration of some states could be dynamically determined, while the duration of other states could be predefined. As an example, the OMPA may continue performing high intensity processing until the target criteria are achieved. However, whenever new OMPA input is added, the OMPA may cycle to burst grind for a certain amount of time (e.g., 30 seconds, 5 minutes, 30 minutes) before reverting back to its previous state.

The above-described description of various OMPA states is merely illustrative and that those skilled in the art will appreciate that any number of OMPA states may be used and the criteria for transitioning from one state to another may vary. Examples of other OMPA processing algorithms and control methodologies can be found, for example, in commonly owned U.S. Patent Application Publication Numbers US20230081670 and US20230083105, the disclosures of which are incorporated by reference in their entireties.

The motor can be controlled to rotate in a first direction for a first period of time and to rotate in a second direction for a second period of time. The motor can alternate between the first direction and the second direction after the first period of time has elapsed or after the second period of time has elapsed. The motor may alternate rotation direction to ensure that the organic matter is sufficiently mixed and ground. The orientation of the cutting members can cause the organic matter to oscillate from side to side in a first pattern (e.g., a FIG. 8 shape following a first path) when rotated in a first direction and to oscillate from side to side in a second pattern (e.g., a similar FIG. 8 shape following a second path) when rotated in a second direction.

As yet another example, a load on the motor is monitored for an overload condition. In one approach, a torque sensor can be used to sense the load on the motor. In another approach, a current sensor can be used to sense the current consumption by the motor. If the current consumption exceeds a threshold, this can trigger an overload condition. In yet another approach, a speed sensor can be used to monitor the motor speed. If the speed drops below a certain rate for a fixed period of time, this can trigger the overload condition. Any combination of these approaches may be used to detect overload conditions. If the overload condition is monitored, an overload protection scheme can be engaged to protect the bucket assembly. The overload protection scheme can include stopping the motor to cease rotation in a current direction, reversing rotation of the motor to enable one of the cutter forks or one of the paddles responsible for causing the overload condition to backout a fixed number of angular degrees of rotation, and reversing rotation of the motor to resume rotation in the current direction. In another approach, the overload protection scheme can include stopping the motor to cease rotation and reversing rotation of the motor to cause the cutting members to rotate in the opposition direction. In yet another approach, the overload protection scheme can include determining that engagement of the overload protection scheme is not able to rectify the overload condition and notifying a user of the bucket assembly of the overload condition. If desired, any combination of these different overload protection schemes may be implemented.

As another example, the impellers can rotate asymmetrically with respect to each other at a speed ranging between 1 RPM and 2 RPMS. Despite being rotated at a constant speed, warbling noise is substantially eliminated through impeller design and specifically selected spacing of the impellers relative to the inside surfaces of the metal bucket.

FIG. 10 shows an illustrative process 1000 for processing organic matter with a bucket assembly, according to an embodiment. The bucket assembly can be, for example, bucket assembly 600 that is inserted into liner structure 310. When bucket assembly 600 is inserted into liner structure 310, the impeller couplers are interfaced with the drivetrain couplers, at step 1010. Each impeller coupler is associated with a respective impeller assembly that rotates about a respective vertical axis. Each drivetrain coupler is associated with a respective drive shaft that is coupled to a gearbox that is powered by a motor. The bucket assembly further includes a first blade array secured to a first curved surface of a metal housing in a vertical orientation and a second blade array secured to a second curved surface of the metal housing in a vertical orientation. At step 1020, after the OMPA confirms that bucket assembly is present within the liner structure and the OMPA is ready to commence an OMPA processing action, the motor is instructed to rotate in a first direction, which causes the gearbox to actuate and rotate drive shafts and associated drivetrain couplers. The gearbox may be configured to asynchronously rotate the drive shafts such that each drive shaft is rotated at a different speed. At step 1030, the first and second impeller assemblies are rotated in a first rotation direction in response to rotation of the drive shafts. The first impeller assembly rotates about a first vertical axis within the metal housing of the bucket assembly and includes at least a first cutting member and a first integrated cutting and paddle member. The first blade array interfaces with the first cutting member and the first integrated cutting and paddle member during each rotation of the first impeller assembly. The second impeller assembly rotates about a second vertical axis within the metal housing and includes at least a second cutting member and a second integrated cutting and paddle member. The second blade array interfaces with the second cutting member and the second integrated cutting and paddle member during each rotation of the second impeller assembly. At step 1040, a hot plate that interfaces with a hot plate interfacing surface of the metal housing can be heated to impart heat into the metal housing. At step 1050, a first fan draws in ambient air from outside of the OMPA and that air is optionally heated and directed into the bucket assembly. At step 1060, untreated air is pulled out of the bucket assembly by a second fan and the untreated air is routed through an air treatment system that converts the untreated air to treated air and expels the treated air outside of the OMPA. At step 1060, the OMPA can execute an OMPA processing algorithm that modifies operation of the motor, heat plate, first fan, and second fan depending on a plurality of factors (e.g., run time, mass, sensor input of temperature(s) and humidity) to convert contents contained in the bucket assembly to OMPA output.

It should be understood that the steps shown in FIG. 10 are illustrative and the order of the steps may be changed, additional steps may be added, or steps may be omitted.

FIG. 11 shows an illustrative process 1100 for processing organic matter with a bucket assembly, according to an embodiment. The bucket assembly can include first and second impeller assemblies and first and second blade arrays, a hot plate, a drivetrain assembly that is coupled to the first and second impeller assemblies when the bucket array is inserted in the OMPA. At step 1110, process 1100 is operative to rotate the first and second impeller assemblies about respective vertical axes using a drivetrain assembly, wherein the first impeller assembly includes first cutting member and first integrated paddle and cutting member, wherein the second impeller assembly includes a second cutting member and a second integrated paddle and cutting member. At step 1120, process 1100 is operative to cut the organic matter when the first cutting member and first integrated paddle and cutting member pass by the first blade array and when the second cutting member and second integrated paddle and cutting member pass by the second blade array. At step 1130, process 1100 is operative to redirect a flow of the organic matter downwards towards a bottom surface of the bucket assembly with the first and second integrated paddle and cutting members. At step 1140, process 1100 can heat the organic matter by applying heat to the bucket assembly using the hot plate, wherein a combination of the cutting, the redirecting, and the heating converts the organic matter to a ground and selectively desiccated product.

It should be understood that the steps shown in FIG. 11 are illustrative and the order of the steps may be changed, additional steps may be added, or steps may be omitted.

FIG. 12 shows an illustrative process 1200 for processing organic matter with a bucket assembly, according to an embodiment. At step 1210, process 1200 can asynchronously rotate first and second impeller assemblies in response to operation of a drivetrain assembly, wherein the first and second impeller assemblies rotate about respective vertical axes within an ellipsoid shaped metal housing comprising a first vertically oriented blade array secured to an inner surface of the metal housing within a first radial sweep zone of the first impeller assembly and a second vertically oriented blade array secured to the inner surface within a second radial sweep zone of the second impeller assembly, wherein the first impeller assembly comprises first and second cutting members and a first paddle and cutting member, wherein the second impeller assembly comprises a third cutting member and a second paddle and cutting member, and wherein during rotation of the first impeller assembly, the first and second cutting members and the first paddle and cutting member interact with respective blades of the first blade array, and during rotation of the second impeller assembly, the third cutting member and the second paddle and cutting member interact with respective blades of the second blade array. At step 1220, process 1200 is operative to heat the metal housing with a hot plate that interfaces with a hot plate facing surface of the metal housing.

It should be understood that the steps shown in FIG. 12 are illustrative and the order of the steps may be changed, additional steps may be added, or steps may be omitted. For example, a motor associated with the drivetrain assembly can be operated at a first speed during a first phase of a processing cycle and when the first phase is determined to be complete, the motor can be operated at a second speed, wherein the second speed is faster than the first speed. As another example, the motor can be controlled to rotate in a first direction for a first period of time, controlled to rotate in a second direction for a second period of time, and alternate between the first direction and the second direction after the first period of time has elapsed or after the second period of time has elapsed. As yet another example, a load on the motor can monitored for an overload condition and engage an overload protection scheme when the overload condition is monitored. In one embodiment, the overload protection scheme can include stopping the motor to cease rotation in a current direction, reversing rotation of the motor to move in a direction opposite of the current direction to cause the first and second impeller assemblies to reverse rotate a fixed number of angular degrees of rotation, and resuming rotation of the motor in the current direction. In another embodiment, the overload protection scheme can include stopping the motor to cease rotation, and reversing rotation of the motor to cause the plurality of cutter forks and the plurality of paddles to rotate in the opposition direction. In yet another embodiment, the overload protection scheme can include determining that engagement of the overload protection scheme is not able to rectify the overload condition and notifying a user of the bucket assembly of the overload condition.

### Overview of Control Platform

In some situations, it may be desirable to remotely interface with an OMPA. For example, a user may want to initiate high intensity processing if she is not at home and does not expect to return home for an extended duration (e.g., several hours). This could be done through a control platform that is communicatively connected to the OMPA. Thus, the user may be able to interact with the OMPA through the control platform. Through the control platform, the user may also be able to view information regarding the OMPA (e.g., its current state, average duration of each state, how much OMPA input has been processed over a given interval of time, current weight of the bucket and its contents) through interfaces that are generated by the control platform.

As discussed above in connection with FIGS. 5A-5E, load cell 544 supports a combination of mass components including bucket assembly 600, overmold structure 510, heat plate 502, insulation layer 504, and drivetrain assembly 550. Load cell 544 can measure the mass of this combination, including contents (e.g., OMPA input and prior existing FOOD GROUNDS) contained in bucket assembly 600. Load cell 544 is designed and used as a strain gauge to measure mass. Load cell 544 may benefit from relatively enhanced resolution in mass measurements because the load cell only has to account for the weight of the combination and organic contents, as opposed to one or more load cells that have to account for the entire weight of the OMPA. However, the ability to obtain precise and high resolution mass measurements can require that noise sources be isolated or eliminated. For example, air being injected into the bucket assembly may introduce noise that affects the accuracy of load cell mass measurements. Many noise sources (e.g., air induced noise, temperature drift) can be handled in firmware. Other noise sources can be eliminated or mitigated using mechanical interface embodiments discussed herein. These mechanical interfaces are now discussed. FIGS. 15A and 15B show different views of load cell 544 according to an embodiment. Load cell 544 can include mass bracket interfacing surface 1510, hard stop interfacing surface 1520, and drivetrain assembly interfacing surface 1530. Interfacing surfaces 1510 and 1530 are on opposite sides and on opposing faces of load cell 544. For example, surface 1510 may point downwards to the bottom of the OMPA, whereas surface 1530 may point upwards to the top of the OMPA. Mass bracket interfacing surface 1510 and hard stop interfacing surface exist on the side of load cell 544, but on opposite ends, as shown.

Surface 1510 may include registration posts 1511 and 1512 that protrude from the planar surface defining interfacing surface 1510. Registration posts 1511 and 1512 may slot into respective registration cavities existing in the mass bracket (e.g., mass bracket 414). In some embodiments, registration posts 1511 and 1512 can be press fit into respective registration cavities. Retention holes 1514 and 1515 may exist within in the portion of load cell 544 proximate to interfacing surface 1510. Retention holes 1514 and 1515 may be configured to receive screws, fasteners, or some other retention mechanism secure surface 1510 to the mass bracket. In some embodiments, the screws can be self-tapping screws that lock into place without assistance of an adhesive (e.g., such as Loctite™). In another embodiment, the screws can be trilobular screws that self-tap.

In some embodiments, surface 1510 can include a shim or include an integrated shim designed to counteract any angular rotation that could be caused by the combination of mass components. As shown in FIG. 5B, for example, load cell 544 is offset with respect to a center axis of the OMPA. This offset position can result in the combination of mass components tending to rotate into load cell 544. Such a rotation is undesired because the rotation may cause the bucket assembly to rotate about its center axis and potentially into the liner structure. The shim may offset load cell 544 by a fixed angle—an anti-rotation angle—to counteract a rotational load caused by the combination of mass components and the offset location of load cell 544. For example, the shim may be a wedge having a fixed angle. In some embodiments, this wedge can be integrally formed as part of the metal composition (e.g., aluminum) of load cell 544.

Surface 1530 may be associated with registration cavities 1531 and 1532 that are designed to receive respective posts extending from the drivetrain assembly (e.g., assembly 550). The respective posts may be press fit into registration cavities 1531 and 1532 to securely mount drivetrain assembly 550 to load cell 544. Surface 1530 may also be associated with retention holes 1534 and 1535 that are configured to receive screws, fasteners, or some other retention mechanism. For example, self-tapping screws (e.g., such as trilobular self-tapping screws) may be used to further secure surface 1530 to the drivetrain assembly, in addition to the press fit of the posts into cavities 1531 and 1532. The combination of the press fit with cavities 1531 and 1532 and the fasteners helps to ensure that drivetrain assembly 550 is aligned as perfectly as possible with load cell 544 by minimizing any unnecessary angular shift therebetween. In addition, this union between load cell 544 and drivetrain assembly 550 is the first in a series of precisely aligned components that stack up as part of the combination of components whose mass is measured by load cell 544. As discussed above, the stack up further includes alignment of insulation layer 504 to drivetrain assembly 550, the alignment of hot plate 502 to insulation layer 504 and to drivetrain assembly 550, the alignment of overmold structure 510 to liner structure 310, hot plate 502, and insulation layer 504. These components are designed to precisely interface with each other to ensure a desired stack up that is ultimately supported by load cell 544.

Surfaces 1510, 1520, and 1530 represent interface points in which load cell 544 interfaces with the mass bracket and the drivetrain assembly. Member 1550 may exist between surfaces 1510 and 1520, as shown. Member 1550 may serve as the cantilever arm stemming from mass bracket interfacing portion 1510 and terminating with portions 1520 and 1530. Member 1550 may be stepped down in dimensions relative to portions 1510, 1520, and 1530. As shown in FIG. 15A, the step change transition from portion 1510 to member 1550 is greater than the step change transition from portion 1520 to member 1550. This difference in step changes ensures that portions 1520 and 1530 are cantilevered with respect to portion 1510. That is, when a downward force is applied by the combination of components onto portion 1530, load cell 544 can bend downwards at the distal portion (e.g., portions 1520 and 1530). This force is measured by load cell 544.

Load cell 544 may be calibrated at a particular temperature and firmware can incorporate temperature compensation to adjust for changes in temperature conditions existing in the OMPA. For example, when the hot plate is active and the metal housing is being heated up, the temperature inside the OMPA, including the environment surrounding load cell may exhibit increased temperatures. The changes in ambient temperature, which affect the temperature of load cell 544, can be compensated for to ensure that load cell 544 provides accurate mass measurements.

FIGS. 16A and 16B show illustrative bottom and top perspective views, respectively, of mass bracket 414 according to embodiment. Mass bracket 414 may be constructed from a metal or plastic material. Mass bracket 414 includes, among other features, load cell interface 1610. Load cell interface 1610 can provide a mounting surface for load cell 544 to be secured to mass bracket 414. As shown, load cell interface 1610 may be raised or offset from surface 1601, which points towards the top of the OMPA and extends for at least the length of load cell 544 (such that portion 1520 can interface with it if required). Load cell interface 1610 may be offset, for example, to accommodate clearance tolerances with the OMPA. In other words, but for the offset of interface 1610, there may not be sufficient space for the fasteners, for example. Surface 1602, by contrast, points downwards to the bottom of the OMPA. As will be shown in other figures, mass bracket interface portion 1510 of load cell 544 is anchored to mass bracket interface portion 1510. When mass bracket interface portion 1510 is secured to mass bracket 414, the surface of portion 1510 and the surface of load cell interface 1610 can be substantially co-planar and a gap distance can exist between interface portion 1520 and load cell interface 1610 (when the combination of components and organic matter are not causing load cell 544 to bottom out). Load cell interface 1610 can include registration cavities 1611 and 1612 that receive respective registration post 1511 and 1512 of load cell 544. Load cell interface 1610 can also include through-holes 1614 and 1615 through which screws, fasteners, or other retention mechanisms can pass through and interface with respective retention holes 1514 and 1515. When load cell 544 is secured to load cell interface 1610, the combination of the fasteners, registration posts 1511 and 1512, and registration cavities 1611 and 1612 substantially reduce or eliminate any undesired angular rotation existing between load cell interface 1610 and load cell 544.

Mass bracket 414 may function as a datum for the mass system by providing a solid platform in which the mass components are stacked up, for which liner structure 310 is attached and, for which midframe structure 412 is attached. Mass bracket 414 can include liner interface structures 1621 and 1622 for providing structures for liner structure 310 to be mounted and secured. In addition, mass bracket 414 can include frame structures 1631 and 1632 for providing structures for midframe structure 412 to be mounted and secured.

FIGS. 17A and 17B show perspective top and bottom views of drivetrain assembly 550, respectively. Drivetrain assembly 550 can include, among other features, load cell interfacing portion 1730 that is designed to connect to load cell 544. Portion 1710 can include posts 1731 and 1732 that are designed to fit inside registration cavities 1531 and 1532, respectively of load cell 544. Portion 1710 can include through-holes 1734 and 1735 through which screws, fasteners, or other retention mechanisms can pass through and interface with respective retention holes 1534 and 1535. Portion 1710 can also have side walls 1741 and 1742 that can abut reciprocal side walls of load cell 544. When load cell 544 is secured to drivetrain assembly 550 via portion 1710, the combination of the fasteners, registration posts 1731 and 1732, registration cavities 1531 and 1532, and side walls 1741 and 1742 substantially reduce or eliminate any angular rotation that could potentially occur during application of a load to load cell 544. Thus, the combination of anti-angular rotation features utilized by mass bracket interfacing portion 1610, load cell interfacing portion 1730, and load cell 544 jointly contribute to substantial mitigation or elimination of any angular rotation during load events.

FIG. 18A shows a partial illustrative view mass bracket 414 coupled to load cell 544 via fasteners 1814 and 1815, which may pass through through-holes 1614 and 1615 (not shown) and engage with retention holes 1514 and 1515 (also not shown). FIG. 18B shows a partial illustrative view of load cell 544 coupled drivetrain assembly 550 via fasteners 1834 and 1835, which may pass through through-holes 1734 and 1735 (not shown) and engage with retention holes 1534 and 1534 (also not shown). FIG. 18C show an enlarged cross-sectional view of load cell 544 mounted to mass bracket 414 (only partially shown) and to drivetrain assembly 550 (which is also partially shown). FIG. 18C also shows load cell interface 1610, mass bracket interfacing surface 1510, hard stop interfacing surface 1520, drivetrain assembly interfacing surface 1530, and member 1550. The step changes between surface 1510 and member 1550 and between surface 1520 and member 1550 are shown. Also shown, is the gap distance between surface 1520 and load cell interface 1610. The interface between surface 1520 and load cell interface 1610 can represent a first downward motion hard stop in which load cell 544 hard stops against mass bracket 414. A second downward motion hard stop is shown in FIG. 18D, which shows a partial perspective view of mass bracket 414, drivetrain assembly 550, and other bucket assembly components. The second downward hard stop can exist between a bottom surface 1851 of drivetrain assembly 550 (also shown in FIG. 17B) and surface 1601 (also shown in FIG. 16B) of mass bracket 414. The gap distance of the second downward hard stop is greater than the gap distance of the first downward hard stop. The second downward hard stop can be a failsafe to the first downward hard stop. FIG. 18D also shows an upwards direction hard stop that prevents the combination of components from moving too far upwards within the OMPA. Bracket 1880 is secured to mass bracket 414 and is designed to interface with surface portion 1852 (also shown in FIG. 17A) of drivetrain assembly 550 to provide the upwards direction hard stop. In some embodiments, bracket 1880 may be a separate component that is secured to bracket 414 or it can be integrally formed as part of bracket 414. The downward and upward hard stops can be provided to protect the OMPA from damage, for example, during shipment of the OMPA or user abuse (e.g., a user slamming the bucket assembly down into the liner structure or horseplay that results in the OMPA being toppled over).

FIG. 19 shows an illustrative cross-sectional view bucket assembly 600, liner structure 310, mass bracket 414, and other components according to an embodiment. As shown, bucket assembly 600 is shown to be contained within liner structure 310 and is supported by heat plate 502, insulation layer 504, overmold structure 510, drivetrain assembly 550, and load cell 544. Load cell 544 is also attached to mass bracket 414 and mass bracket 414 is secured to liner structure 310. As explained above, the combination of bucket assembly 600, heat plate 502, insulation layer 504, overmold structure 510, and drivetrain assembly 550 “floats” relative to liner structure 310 and mass bracket 414 and is supported by load cell 544. Individual components such as heat plate 502, insulation layer 504, overmold structure 510, drivetrain assembly 550 are now discussed. FIG. 20 shows an exploded view showing heat plate 502, insulation layer 504, overmold structure 510, drivetrain assembly 550, drivetrain seals 506, couplers 553 and 554, and various fasteners or screws. Many of the components shown in FIG. 20 can be referred to as a bucket interfacing subassembly that is operative to rotate impellers of the bucket assembly and to impart heat into the metal bucket.

FIGS. 20A and 20B show respective bottom and top views of a drivetrain and heating system 2000, showing heat plate 502, insulation layer 504, overmold structure 510, drivetrain assembly 550, drivetrain seals 506, and couplers 553 and 554 in an assembled state. As shown in FIG. 20A, insulation layer 504 abuts a surface of drivetrain assembly 550.

FIGS. 21A and 21B show respective bottom and top views showing just overmold structure 510 and insulation layer 504. Insulation layer 504 can include registration holes 2110 that serve as guide posts for heat plate post members (not shown), drivetrain through-holes 2120 in which seals 506 (not shown) can reside, and fastener through-holes 2130 through which fasteners or screws pass through layer 504 and retention tabs 2131 of overmold structure 510 to engage with hot plate 502 (not shown).

FIGS. 21C-21E show perspective bottom and top views of overmold structure 510 and hot plate 502. Hot plate 502 can reside on top of retention tabs 2131 and inner ring structure 2140. A silicon gasket may be overmolded to inner ring structure 2140. This gasket can interface with hot plate 502 to form an airtight seal. Overmold structure 510 can include outer ring structure 2142, which may be overmolded with a silicon gasket. Liner structure 310 is designed to fit on top of the gasket that is molded over outer ring structure 2142. This gasket can interface with liner structure 310 to form another airtight seal. Inner ring structure 2140 sits at a lower plane than outer ring structure 2142. In addition, the width and length of inner ring structure 2140 is smaller than the width and length of outer ring structure 2142. The size and plane differentials of ring structures 2140 and 2142 provide space for catch channel 2150 to exist between inner ring structure 2140 and outer ring structure 2142. Catch channel 2150 can serve as a debris catcher (e.g., a crumb catcher) for any matter that is not properly placed into the bucket assembly. When the bucket assembly is removed from the OMPA, a user can clean out catch channel 2150 as needed. When the bucket assembly is inserted into the OMPA, the bottom of the metal housing rests on hot plate 502 and the feet members 680 can be suspended over catch channel 2150.

Heat plate 502 can include thermistors 2132 to monitor temperature of the heat plate, thermostat 2133 for controlling a temperature of heat plate 502, and terminals 2334 for receiving power. Heat plate 502 also includes drivetrain through-holes 2135 that include drivetrain seal retaining feature 2135a and bucket assembly engagement feature 2135b. Drivetrain seal retaining feature 2135a is configured to receive an impeller seal, which provides an airtight seal between the drivetrain coupler and hot plate 502. Bucket assembly engagement feature 2135b may be chamfered to promote insertion of the impeller coupler into heat plate 502 and into a drivetrain coupler.

FIGS. 21C-21E show post structures 2115 more clearly and FIG. 22 shows how post structures 2115 interface with registration holes 2110 of insulation layer 504.

FIG. 23 shows an illustrative process 2300 for measuring mass according to an embodiment. Process 2300 may be implemented in an organic matter processing apparatus including a liner structure having a first aperture through which a bucket assembly is inserted and removed and a second aperture, a mass bracket secured to the liner structure, a load cell secured to the mass bracket, and a drivetrain and heating system secured to and supported by the load cell, wherein the drivetrain and heating system float relative to the liner structure and the mass bracket. At step 2310, presence of the bucket assembly in the liner structure can be detected (e.g., using a sensor or the load cell). At step 2320, process 2300 can measure, using the load cell, mass of the drivetrain and heating system, the bucket assembly, and any contents contained in the bucket assembly.

It should be understood that the steps shown in FIG. 23 are illustrative and the order of the steps may be changed, additional steps may be added, or steps may be omitted. For example, bucket present detection can be detected using the mass sensor. In another approach, the bucket present detection can be detected by monitoring current in the motor driving the drivetrain. In this approach, the load current incurred by the motor is higher when the bucket is present than when the bucket is not present. Thus, to determine whether the bucket is present, the system can run the motor at a relatively low duty cycle and monitor the load current. If the load current is at or above a bucket present threshold, then it can be inferred that the bucket is present. In yet another approach, air pressure or airflow within the OMPA can be measured to determine whether the bucket is present. The air treatment system in the OMPA is designed to be substantially airtight to prevent odorous gases from leaking out of the OMPA before being treated by the air treatment chamber. The presence of the bucket assembly may be required to complete the airtight seal of the air treatment system (assuming all other components are securely in place and the exhaust port filter is not clogged). When the fan in the air treatment system is running, a pressure drop can be monitored. If the bucket is present, then the monitored pressure drop should meet or exceed a nominal threshold-indicating that the bucket is present. However, if the pressure drop is below the threshold, then it may be inferred that the bucket is not present, or the air treatment chamber is not present or seated properly. If the pressure drop exceeds a max threshold, which is greater than the nominal threshold, then it may be inferred that that one or more ports (e.g., holes 308 or port 312) are clogged or blocked. Depending on the bucket present status (or indication of erroneous pressure readings), the OMPA can take the appropriate actions (e.g., prevent operation of OMPA processing or provide a notice to the user).

As discussed above, when pedal 290 is depressed, a mechanical linkage causes lid 204 to open. Bezel 305 may remain in place as lid 204 opens. If desired, a user can manually lift bezel 305, for example, to remove the bucket. The mechanical linkage is now discussed in reference to FIGS. 4G-4I and FIGS. 24A-24C through FIGS. 28A-28B. The mechanical linkage can include a pedal assembly, linkage rods, and a hinge assembly. The linkage rods connect the pedal assembly to the hinge assembly and can travel in vertical up and down directions in response to pedal depression and pedal release events. For example, when pedal 290 is depressed, linkage rods 450 may travel in an upwards direction to cause the hinge assembly to open lid 204. When pedal 290 is released, linkage rods 450 may travel downwards to cause the hinge assembly to close lid 204. Referring back to FIGS. 4G-4I, FIG. 4G shows an illustrative back view and FIGS. 4H and 4I show illustrative side views of OPMA 200 with exterior body panels removed. Linkage rods 450 are shown being routed between housing base 410 to the pedal assembly contained therein (not shown) and to the hinge assembly located near the top of OMPA 200. Two linkage rods 450 may exist to evenly distribute forces being imparted on the hinge assembly when the pedal is depressed. In addition, linkage rods 450 may have a non-linear construction to accommodate space requirements and configuration of other assemblies that collectively make up the OMPA. Linkage rods 450 may be constructed from metal, plastic, or combination thereof. For example, linkage rods can have pedal portion 450a, transition portion 450b, and hinge portion 450c. As shown in FIG. 4G, pedal portion 450a of linkage rods 450 are spaced apart at a first distance when the rods are adjacent to housing base 410, midframe structure 412, and mass bracket structure 414. Petal portion 450a may pass through respective through-holes of midframe structure 412. Linkage rods 450 can undergo a transition from the first space apart distance to a spaced apart second distance when the rods are adjacent to liner structure 310—this is illustrated by transition portion 450b. The second distance may be maintained from the transition point between portions 450b and 450c to the hinge assembly. In addition, transition portion 450b can be out of plane with respect to pedal portion 450a. This is shown more clearly in FIGS. 4H and 4I by showing that transition portion 450b transitions from a first plane that is coplanar with pedal portion 450a to a second plane that is parallel to but offset with respect to the first plane. The first plane is closer to a center vertical axis whereas the second plane is farther away from the center vertical axis. Hinge portion 450c may be oblique to the first plane and can be designed to point towards the center vertical axis at the transition junction of the transition portion 4450b and hinge portion 450c. This oblique angle may better enable hinge portion 450c to interface with a hinge pusher (shown in FIGS. 26A-26E).

The pedal assembly is now discussed in detail with reference to FIGS. 24A-24C. FIG. 24A shows an illustrative cross-sectional view of housing base 410 with pedal assembly 2410 integrated therein. FIG. 24B shows a perspective view of pedal assembly 2410 with housing base 410 removed. FIG. 24C shows an illustrative side view of pedal assembly 2410 with housing base 410 removed. Pedal assembly 2410 can include plate member 2420 that rotates about pedal hinge axis 2422 when plate member 2420 cycles between depressed and released states. Plate member 2420 can include pedal portion 2424, axis portion 2425, and linkage interface portion 2426. Pivot members 2430 (only one of which is shown in FIG. 24B) are positioned co-axially with the pedal hinge axis 2422 and a respective support block 2432. Support blocks 2432 are supported by housing base 410 and serve as anchors to pivot members 2430, which when coupled to plate 2420, enable plate to rotate about pedal hinge axis within housing base 410. Through use of support blocks 2432 and pivot member 2430, plate member 2420 is suspended in air within housing base 410 when in a released or inactive state. As shown in FIGS. 24B and 24C, pedal assembly 2410 is suspended above support plate 292 when in the released or inactive state. When pedal assembly 2410 is in a depressed state, pedal portion 2424 may interface with support plate 292. In addition, when in the depressed state, pedal assembly 2410 rotates about pedal hinge axis 2422, causing linkage interface portion 2426 to rotate upwards, which causes linkage rods 450 to travel vertically upwards. As shown in FIGS. 24B and 24C, linkage rods 450 are secured to linkage interface portion 2426.

A dampener 2440 can be mounted to pedal portion 2424. For example, dampener 2440 can be a fluidic dampener. Dampener 2440 is constructed to interface with a portion 411 of housing base 410 when pedal assembly 2410 is in an undepressed or relaxed state. Dampener 2440 is operative to dampen the closing action of lid 204 when pedal assembly transitions from a depressed state to an undepressed state. Springs located in the hinge assembly may bias linkage rods 450 to travel in downwards vertical direction, thereby returning pedal assembly 2410 to an undepressed or relaxed state.

Plate member 2420 can constructed from a single piece of plastic or metal or can be constructed from two or more components. For example, pedal portion 2424 can be constructed from metal, whereas axis portion 2425 and linkage interface portion 2426 can be constructed as a single piece of plastic.

FIGS. 25A-25E show different views of hinge assembly 2500 and components thereof. FIG. 25A shows hinge assembly 2500 and how it is secured to liner structure 310 and to lid 204. In particular, hinge bracket 442 is coupled to liner structure 310 and hinge plate 440 is coupled to lid 204 (or more particularly to lid plate 204a shown in FIG. 25B). Hinge plate 440 is rotatably coupled to hinge bracket 442 via dowels 2540 (shown in FIG. 25B) that allows hinge plate 440 to rotate about a hinge plate axis 2541. Linkage rods 450 are attached to a hinge pusher 2550, which rotates about hinge pusher axis 2551, and to pedal assembly 2410 (of FIG. 24A-24C). Hinge plate axis 2541 and hinge pusher axis 2551 may be vertically aligned in the same plane, where hinge plate axis 2541 is positioned above hinge pusher axis 2551. Hinge pusher 2550 is movably coupled to hinge bracket 442 via pins or dowls and is spring loaded with springs 2552 that bias hinge pusher 2250 to rest against a bottom surface of lid plate 204a or to hinge plate 400. Springs 2552 may also assist in opening lid 204 during a pedal depression event. When linkage rods 450 travel vertically upwards, in response to a user depressing pedal portion 2224, linkage rods cause hinge pusher 2550 rotate upwards, thereby causing hinge plate 440 to also rotate upwards to open lid 204. A dampener 2260 (e.g., a rubber dampener), which is attached to hinge plate 440, may dampen a final travel portion of lid 204 so that it gently comes to a stop when being opened. Dampener 2260 may engage a portion of hinge pusher 2550 during the upward rotation of hinge plate 440, to cause the dampening action. When pedal portion 2224 is no longer depressed, the weight of lid 204 and hinge plate 440 may cause hinge pusher 2550 and lid plate 440 to rotate downwards to close lid 204.

Hinge assembly 2500 decouples linkage rods 450 from hinge plate 440 and lid 204 by directly coupling linkage rods to hinge pusher 2550. This decoupling can enable a user to manually open lid 204 independently of the linkage rod 450 movement and/or pedal depression. In addition, the decoupling can mitigate damage to the linkage system if a user uses the lid or pedal incorrectly.

Referring now specifically to FIG. 25B, portions of lid 204 are removed and hinge bracket 442 is removed. FIG. 25B shows that hinge plate 440 has a relatively large flat planar section 440a that is parallel to lid plate 204a and a relatively smaller member 440b that extends perpendicularly with respect to section 440a. Planar section 440a can be secured to a top surface of lid plate 204a. This way, when hinge pusher 2550 pushes on lid 204a or hinge plate 440, lid 204 is opened. Member 440b may serve as a mounting point for dampener 2260 (not shown). FIG. 25B also shows how linkage rod 450 is connected to hinge pusher 2550.

FIG. 25C shows a perspective view of hinge assembly 2500, lid 204, bezel 305, and part of a latch assembly. Also shown are hinge bracket 442, linkage rods 450, hinge pusher 2550, axis 2441, and axis 2551. Hinge pusher 2550 is adjacent to bezel 305 but does not interface with it.

FIG. 25D shows another perspective view of hinge assembly 2500 and bezel 305. Also shown are hinge bracket 442, linkage rods 450, hinge pusher 2550, and dampener 2560. As shown, dampener 2560 is secured to member 440b of hinge plate 440.

FIG. 25E shows yet another perspective view of hinge assembly 2500 and lid plate 204a. Hinge bracket 442 and hinge pusher 2550 are shown as transparent elements.

FIG. 25E shows yet another perspective view of hinge assembly 2500 with hinge bracket 442 shown as being transparent.

FIGS. 25G and 25H show enlarged views of hinge bracket 442 and hinge plate 440 with emphasis on structures that enable the lid to be locked back in open position. In particular, hinge bracket 442 has nubs 2580 that are designed to interface with detents 2590 that are included with hinge plate 440. Nubs 2580 may be constructed from the same material as hinge bracket 442 (e.g., plastic or metal). In one embodiment, hinge bracket may be constructed from PC-ABS. Detents 2590 may be constructed from the same material as hinge plate 440 (e.g., a glass filled nylon, plastic, or metal). Detents 2590 move relative to nubs 2580 when hinge plate 440 is rotated among open, open and locked back, and closed positions. When plate 440 is rotated back to the open and locked back position, as shown, detents 2590 rest on top of nubs 2580. When plate 440 is not in the open and locked back position, detents 2590 do not rest on top of nubs 2580. Detents 2590 may touch nubs 2580 when the lid is open, and do not touch each other when the lid is closed.

FIGS. 26A-26E show different views of hinge pusher 2550 according to an embodiment. Hinge pusher axis 2551 is clearly shown in FIGS. 26A-26C. Hinge pusher 2550 can include pusher portion 2610 characterized as has having a partial hollow tubular structure that extends from and between spring retaining members 2620. Pusher portion 2610 can have interface lip 2612 that directly interfaces with a lid plate or hinge plate while at rest and when engaged in opening the lid. Spring retaining members 2620 can include cavity 2622 for holding a spring, a spring leg retaining region 2624 for holding a leg of the spring, and a hole 2666 for securing a linkage rod. A pin or dowel (not shown) can contain the spring in place with respect to spring retaining member 2620 and couple hinge pusher to hinge bracket 442 (not shown).

FIGS. 27A-26C show different views of hinge bracket 442 according to an embodiment. Hinge plate axis 2541 and hinge pusher axis 2551 are shown. Member 440b (not shown) is constructed to fit inside gap 2710 and rotate upwards towards crossbar 2712 when the lid is opening. Holes 2720 may provide clearance for fasteners or screws being used to connect dampener 2560 (not shown) to member 440b. Detent 2580 is shown in FIG. 27B.

FIGS. 28A-28B show different views of hinge plate 440 according to an embodiment. Planar section 440a, member 440b, and hinge plate axis 2541 are shown. Member 440b can include dampener interface surface 2810 for interfacing with dampener 2560, holes 2812, support ribs 2814, support structures 2816. Holes 2812 can coincide with holes 2720 to allow fasteners or screws to secure dampener 2560 to surface 2810. Support ribs 2814 and support structures 2816 may enhance rigidity of hinge plate 440 to repeatedly open and close lid for the lifetime of the OMPA. Detents 2590 (shown in FIGS. 25F and 25G) may be incorporated into support structures 2816 (shown clearly in FIG. 28A).

### Air Treatment System

FIGS. 29A-29E shows an illustrative view of the air intake system, or components thereof, according to an embodiment. FIG. 29A, in particular, has removed air intake manifold 431 to better illustrate positions of fan 432, heater 2910, sensor assembly 2920, which includes board 2921, gasket 2922, and sensor 2923 with respect to liner structure 310. FIG. 29A also shows that interface portions 309a and 309b each have a relatively thin wall member that extends substantially perpendicularly away from liner structure 310. As shown, fan 432 is positioned near a bottom portion of liner structure 310 and directly interfacing with interface portion 310b. Heater 2910 is positioned downstream from fan 432 within interface portion 310a. Sensor assembly 2920 is positioned adjacent to openings 308 and can be secured to air intake manifold 431. Openings 308 may be sized to balance air flow into the bucket assembly and to prevent organic matter particles from entering the air intake system. For example, in one embodiment, openings may have diameter of about 2 mm.

FIGS. 29B-29E show different views of air intake manifold 431. Manifold 431 may have a dual walled construction that provides channel 2930 to receive and engage with the relatively thin walled portion of interfacing portion 310a. The engagement between channel 2930 and interfacing portion 310a may form a substantially airtight seal that does not require a gasket or other air sealing mechanism. Manifold 431 may include mounting feet 2931 for securing manifold to liner structure 310. Manifold 431 may include heater retaining region 2933 for retaining a heater. The airtight seal may be maintained when the heater is secured to heater retaining region 2933. Manifold 431 may also include sensor retaining region 2935 for retaining a sensor assembly. Sensor retaining region 2935 may include clips 2935a for retaining board 2921 in place and a fastener receptacle 2935b to receive a fastener that further secures board 2921 to manifold 431. Manifold 431 may also include fan interface region 2937 for forming an airtight seal with the fan.

During operation of fan 432, air is drawn in from the ambient environment, pushed through heater 2910, and through openings 308. After the forced air passes through openings 308, that air is deflected downwards into the bucket assembly by bezel 305. Bezel 305, which is shown in more detail in FIGS. 30A-30C, is constructed to enable air flow into and out of the bucket assembly while simultaneously limiting spray and splatter of OMPA input during OMPA processing. Furthermore, when the lid is open, bezel 305 is designed to funnel OMPA input into the bucket assembly and prevent any OMPA input from being errantly deposited onto or around the bucket assembly. FIG. 30A shows an illustrative top view of bezel 305. This view shows hinge members 3010 and user interface cutout 3020.

FIG. 30B shows an illustrative perspective view of bezel 305 with air redirection members 3031-3034. FIG. 30C shows a close up view of bezel 305 with air redirection members 3031-3034. When the lid and bezel are closed, and the inlet fan (e.g., fan 423) is operating, the ambient air may initially be directed to flow into bezel 305 between air redirection members 3032 and 3033 or be directed anywhere between redirection members 3031 and 3034. Air redirection members 3031-3034 may be integrally formed as part of bezel 305 and are designed to redirect ambient air being pushed through holes 308 down into the bucket assembly. Absent the presence of members 3031-3034, the ambient air may tend to circulate around the top of the bucket assembly (because this would be the least path of resistance) and not mix into the OMPA input contained within the bucket. Members 3031-3034 disturb the airflow path of the injected ambient air and causes the air to be redirected downwards into the bucket assembly. Air redirection members 3031-3034 may have notches 3031a-3034a to accommodate a handle (not shown). Although only four air redirection members are shown, it should be understood that the shape and number of the air redirection members may vary. For example, FIG. 30D shows different views of bezel 305a that include two redirection members 3051 and 3052, which can include respective notches 3051a and 3052a. Furthermore, as another example, redirection members may be

FIGS. 31A-31E show different views of parts of the air treatment system according to an embodiment. FIG. 31A, in particular, shows liner structure 310 with exhaust airflow adapter 421 removed to better show interface 310c and port 312. As shown, interface 310c has a relatively thin wall member that extends substantially perpendicularly away from liner structure 310. This thin wall member may serve as an interface for exhaust airflow adapter 421 to attach and form an airtight seal. As shown in FIGS. 31B and 31C, peripheral wall 3110 may fit inside interface 310c and peripheral lip member 3112 may sit directly on top of interface 310c. A gasket 3114 may reside on lip member 3112 and be compressed between interface 310c and lip member 3112 when adapter 421 is securely mounted to liner structure 310 via feet members 3120. Exhaust airflow adapter 421 can include sensor assembly retaining region 3130 for retaining a sensor assembly including a circuit board, gasket, and sensor (e.g., similar construction to sensor assembly 2920). Sensor assembly retaining region 3130 may include clips 3131 for retaining the board and as fastener receptacle 3132 for receiving a fastener that further secures the sensor assembly to adapter 421. FIGS. 31D and 31E show exhaust duct interface 3140 that is configured to receive exhaust duct 422. If desired, exhaust duct interface 3140 can include retention features to lock duct 422 into place.

FIGS. 32A-32E show different views of duct 422 according to an embodiment. Duct 422 connects adapter 421 to exhaust fan housing 423. Duct 422 transitions in shape from a rectangular shape (adjacent to adapter 421) to a circular shape (adjacent to exhaust fan housing 423). The circular shape can promote less turbulent airflow of air being injected into air dispersion manifold 424 by the exhaust fan. Duct 422 can include adapter interface portion 3210, transition portion 3220, and fan housing interface portion 3230. Adapter interface portion 3210 can be configured to fit inside adapter 421 and be secured to liner structure 310 via mounting feet 3202. If desired, a gasket or other type of seal may be used to form an airtight seal between portion 3210 and adapter 421. Adapter portion 3210 can exhibit a substantially rectangular cross-section that is relatively thin to accommodate vertical height travel downwards along the height of the OMPA. Transition portion 3220 can transition a general shape of duct 422 from a rectangular cross-section of portion 3210 to a circular cross-section of portion 3230. In addition, transition portion 3220 is configured to position portion 3230 in the appropriate position to connect to exhaust fan housing 423. Fan housing interface portion 3230 can include articulating region 3232 to provide additional flexibility for enabling interface member 3234 to engage with and be secured to fan housing 423. In some embodiments, interface member 3234 can be press fit onto fan housing 423 and secured in place with retention pockets 3235, which can engage with retention tabs (not shown) extending from fan housing 423.

FIGS. 33A-33C show how the air treatment system, in particular, fan housing 423, is coupled to air dispersion manifold 424 by being secured to a rear portion of midframe 412. Air dispersion manifold 424 can be an integral part of midframe 412 that can be formed as part of an injection molding or extrusion process. Fan housing 423 is positioned adjacent to inlet port 3311, which receives untreated air drawn in from the bucket assembly by the fan contained in fan housing 423. Fan housing 423 may be aligned an angle, «, (shown in FIG. 33C) to maximize uniform air flow distribution by air dispersion manifold 424. In some embodiments, an angle, a of 18-22 degrees or about 20 degrees has been found to maximize uniform airflow dispersion for the shape geometry of manifold 424. Uniform air flow distribution is desired so that the activated carbon (or other odor absorption media) contained in an air treatment chamber (shown in FIGS. 34A and 34B) is worn evenly. Various different views of air dispersion manifold 424 are shown in FIGS. 33D-33F. The shape geometry of expansion chamber 3312 can be specifically tuned to ensure air is as evenly distributed as possible as it exits outlet port 3313 and passes through the air treatment chamber.

Air dispersion manifold 424 may have track members 3320 (FIG. 33F) that are configured to receive sliding members of a removable drawer (e.g., removable drawer 3600 of FIG. 36) configured to contain the air treatment chamber. Each track member 3320 may have recess members 3321 and 3322 to assist the user in inserting the removable drawer (and air treatment chamber contained therein) and for ensuring that the user properly seats removable drawer (and by default, the air treatment chamber) on top outlet port 3313. Recess member 3321 is smaller in dimensions than recess member 3322. The sliding members of the removable drawer may be sized to have similarly sized engagement members to respectively fit recess members 3321 and 3322.

FIG. 34 shows a partial backside view of the OMPA with air treatment chamber cover 211 and removable drawer removed to show air treatment chamber (ATC) 3400. In one embodiment, the user may remove cover 211 to access ATC 3400 by removing it or installing a new one. In another embodiment, the user may remove cover 211 to remove the removable drawer. Air passes through ATC 3400 into air chamber 3410 and passes out of exhaust ports 210 (which are integrated into spine member 203). Air chamber 3410 may be an internal cavity that is integral part of midframe 412 (as shown in FIGS. 33C and 33D).

FIG. 35 shows an illustrative cross-sectional view of the OMPA with emphasis on air flow path for treated air. Air chamber 3410 may be fluidically connected to air chamber 3510, which can be defined by spine member 203, mass bracket 414, backplate 3512, backplate foam 3514, and air seal member 3516. FIG. 35 shows midframe 412 connected to mass bracket 414, mass bracket 414 connected to backplate 3512, backplate 3512 connected to backplate foam 3514. Collectively, midframe 412, mass bracket 414, backplate 3512, and backplate foam 3514 form a boundary of air chamber 3510. Air chamber 3510 is also bounded by air seal member 3516, which interfaces with backplate foam 3514. The interface between air seal member 3516 and backplate foam 3514 can form the top boundary of air chamber 3510. Spine member 203, itself, forms another boundary of air chamber 3510.

FIGS. 36A-36E show different views of removable drawer 3600 configured to receive a load of air treatment media (e.g., activated carbon) or a container filled with air treatment media. Drawer 3600 may be the same as removable panel 211, discussed above. Drawer 3600 can include body 3610, which is a multifaceted part including cavity 3611 defined by perforated bottom wall 3612 and side walls 3613, gasket 3614, sliding members 3615, cosmetic member 3618, and screw retention members 3619. Drawer 3600 can include cover 3620 that can be affixed to the top of cavity 3611 and held in place with screws or other fasteners that engage screw retention members 3619. Cover 3620 can include perforated holes 3622 may be similar to in size to the holes in perforated bottom wall 3612. The holes allow treated air being pulled in from the bucket assembly to be uniformly pushed through cavity 3611 and the air treatment media contained therein. This embodiment of drawer 3600 can also include media cartridge 3630, which is secured within cavity 3611. Media cartridge 3630 is a user-removable and installable container that can be removed from or installed into cavity 3611 of body 3610. The container may be of plastic or metal construction and contains air treatment media (e.g., activated carbon or other odor adsorbing material). The container has top and bottom openings for allowing air to pass through the container. An air permeable foam or other substrate may be positioned adjacent to both the top and bottom openings to contain the air treatment media within the container. When a user first interacts with cartridge 3630, the user may be required to remove adhesive film covering the top and bottom openings to allow air to flow through the cartridge. The adhesive film coverings may prevent premature deactivation and/or spillage of the air treatment media (e.g., activated carbon) during shipment of the OMPA and/or media cartridge unit. Alternatively, a removable cap or lid may be removed from the top and bottom side of the cartridge unit. In yet another embodiment, structurally embedded caps or lids may exist as part of the cartridge unit and such caps or lids may be removed using a pull tab, or a key that is used to roll a metal layer around the periphery of each opening, or a can opener.

Drawer 3600 is configured to slide into air dispersion manifold 424 and sit in a sealed position therein when sliding members 3615 are fully seated within respective track members 3320. Drawer 3600 may be sealed when gasket 3614 forms a seal with air dispersion manifold 424. In particular, engagement tabs 3616 and 3617 may engage recess members 1321 and 1322 when drawer 3600 is fully seated and sealed to air dispersion manifold 424. In addition, when drawer 3600 is fully seated, cosmetic member 3618 may be aligned with spine member 204, the side walls of the OMPA, and bottom housing 410 (as shown in FIGS. 2B and 2D).

In some embodiments, cartridge 3630 is not used and cavity 3611 is directly filled with air treatment media and contained between cover 3620 and bottom wall 3612. If desired, an air permeable layer (e.g., foam) may be placed on top of bottom wall 3612 to prevent air treatment media from passing through the holes in bottom wall 3612. When air treatment media requires replacing, the user can remove cover 3620, dump out the old air treatment media, insert new air treatment media, and replace cover 3620.

FIGS. 37A-37H show different views of lid locking mechanism 3700 according to an embodiment. In particular, FIG. 37A shows a partial cross-sectional view of the OMPA with emphasis on lid 204 and lid locking mechanism 3700, FIG. 37B shows a partial exploded view of lid 204, lid locking mechanism 3700, and liner structure 310, FIG. 37C shows an illustrative partial front view of lid locking mechanism 3700 in a locked position, FIG. 37D shows an illustrative partial front view lid locking mechanism 3700 in an unlocked position, FIG. 37E show a partial perspective view of mechanism 3700 and lid 204 with liner structure 310 removed, FIG. 37F shows a partial perspective view of cam lock in an unlocked position, FIG. 37G shows a partial perspective view of cam lock in a locked position, and FIG. 37H shows a close up view of a latch cam and a sliding block. Referring generally to FIGS. 37A-37H, collectively, a general overview of lid locking mechanism 3700 and lid 204 is discussed. Lid 204 can include lid plate 204a, which is attached to hinge plate 440, latch member 204b, lid cover 204c, and lid veneer 204d. Latch member 204b can be an integral part of lid plate 204a. Lid cover 204c may be secured to the top of lid plate 204a and lid veneer 204d can be secured to the top of lid cover 204c. Gasket 205 may be secured to a bottom surface of lid plate 204a.

Lid lock mechanism can include bracket 3710, latch cam 3720, cam screw 3722, latch sliding block 3730, solenoid 3731, spring 3732, retaining screw 3733, bump stop 3736, sensor 3740. Bracket 3710 is secured to liner structure 310 and provides a mounting point for cam screw 3722 to secure latch cam 3720 in place so that latch cam 3720 can rotate in conjunction with movement of sliding block 3730. Latch cam 3720 can include a cutout or grove channel 3721 that interfaces rod member 3734 extending from sliding block 3730. Latch cam 3720 can also include lid engagement member 3724 operative to engage with latch member 204b. Sliding block 3730 can be movably coupled to the liner structure 310 via retaining screw 3733. Solenoid 3731 can also be secured to liner structure 310 and to sliding block 3730. Spring 3732 may exist between solenoid 3731 and sliding block 3730. Solenoid pin 3731a may connect sliding block 3730 to solenoid 3731. When solenoid 3731 is active, it can pull sliding block 3730 to a locked position (shown in FIGS. 37C, 37E, and 37G), which causes latch cam 3720 to rotate and engage latch member 204b. In the locked position, sliding block 3730 may engage sensor 3740 (e.g., a switch) to confirm to a control system of the OMPA that the lid is locked. When solenoid 3731 is not active, spring 3732 may push sliding block to an unlocked position (shown in FIGS. 37D and 37F), which causes latch cam 3720 to disengage with latch member 204b. Bump stop 3736 may protect sliding block 3730 from harsh impacts when spring 3732 returns sliding block 3730 to the unlocked position. In the unlocked position, sliding block 3730 does not engage sensor 3740, thereby indicating to the control system that lid is not locked.

Bracket 3710 may also serve as a platform for circuit board 3711 on which UI elements 3712 and button 3713 may reside. UI elements 3712 and button 3713 can be positioned under respective cutouts in liner structure 310 to enable users to view the UI elements 3712 and interact with button 3713.

A safety interlock circuit is operative to turn off the motor when the lid is open. The interlock circuit may receive a signal from a reed switch. A hall effect switch may provide a signal to solenoid 3731 that indicates the lid is sufficiently closed to engage the latch lock. A single magnet can be used to trigger the reed switch and the hall effect sensor. Use of the magnet ensures that the reed switch and hall effect are triggered in different ways by the magnetic field. The magnet is placed on the lid, aligned along the length of the reed switch. When the lid closes, the two poles of the magnet push and pull on either end of the reed, closing the switch. The hall effect is placed by the end of the magnet, so that it is triggered by the magnetic fields as they enter perpendicular to the sensor.

FIG. 13 illustrates a network environment 1300 that includes a control platform 1302. For the purpose of illustration, the control platform 1302 may be described as a computer program that is executing on an electronic device 1304 accessible to a user of OMPA 1312. As discussed above with reference to FIG. 1, OMPA 1312 may include a communication module that is responsible for receiving data from, or transmitting data to, the electronic device 1304 on which the control platform 1302 resides.

Users may be able to interface with the control platform 1302 via interfaces 1306. For example, a user may be able to access an interface through which information regarding OMPA 1312 can be viewed. This information may include historical information related to past performance (e.g., total pounds of OMPA input that has been processed), or this information may include state information related to current activity (e.g., the current state of OMPA 1312, an indication of whether OMPA 1312 is presently connected to the electronic device 1304, an indication of whether OMPA 1312 is presently locked). Thus, a user may be able to educate herself on the OMPA and its contents by reviewing content posted to interfaces generated by the control platform 1302.

Moreover, a user may be able to access an interface through which instructions can be provided to OMPA 1312. Said another way, the user may be able to specify, through the control platform 1302, when or how OMPA 1312 should process OMPA input stored therein. As an example, the OMPA 1312 may initially be configured to perform high intensity processing between 10 PM and 8 AM under the assumption that its ambient environment will generally be devoid of individuals during that timeframe. However, the user may be able to adjust aspects of setup or operation of OMPA 1312 through the control platform 1302. For instance, the user could specify that high intensity processing should not begin until 2 AM, or the user could specify that high intensity processing should not end after 6 AM.

A user could also program, through the control platform 1302, a preference regarding the weight at which to empty the processing chamber of OMPA 1312. On its own, the processing chamber may weigh 8-10 pounds. The total weight of the processing chamber (including its contents) can quickly become unwieldy for some users, such as elderly individuals and juvenile individuals. Accordingly, the control platform 1302 may permit users to define a weight at which to generate notifications (also referred to as “alarms”). Assume, for example, that a user indicates that the total weight of the processing chamber (including its contents) should not exceed 15 pounds through an interface generated by the control platform 1302. In such a scenario, the control platform 1302 may monitor mass measurements received from OMPA 1312 and then generate a notification in response to determining that the total weight of the processing chamber (including its contents) is within a certain amount of 15 pounds. The certain amount may be a fixed value (e.g., 1 pound or 2 pounds), or the certain amount may be a dynamically determined value (e.g., 5 percent or 10 percent of the weight specified by the user).

The notification could be presented in various ways. In embodiments where the control platform 1302 is implemented as a computer program executing on an electronic device 1304 as shown in FIG. 13, the notification may be generated by the computer program (e.g., in the form of a push notification). Additionally or alternatively, the control platform 1302 may transmit an instruction to OMPA 1312 to generate the notification. Accordingly, the notification could be a visual, audible, or tactile notification that is generated by the electronic device 1304 or OMPA 1312.

As shown in FIG. 13, the control platform 1302 may reside in a network environment 1300. Thus, the electronic device 1304 on which the control platform 1302 is implemented may be connected to one or more networks 1308A-C. These networks 1308A-C may be personal area networks (PANs), local area networks (LANs), wide area networks (WANs), metropolitan area networks (MANs), cellular networks, or the Internet. Additionally or alternatively, the electronic device 1304 could be communicatively connected to other electronic devices—including OMPA 1312—over a short-range wireless connectivity technology, such as Bluetooth, NFC, Wi-Fi Direct (also referred to as “Wi-Fi P2P”), and the like.

In some embodiments, at least some components of the control platform 1302 are hosted locally. That is, part of the control platform 1302 may reside on the electronic device 1304 that is used to access the interfaces 1306 as shown in FIG. 13. For example, the control platform 1302 may be embodied as a mobile application that is executable by a mobile phone. Note, however, that the mobile application may be communicatively connected to (i) OMPA 1312 and/or (ii) a server system 1310 on which other components of the control platform 1302 are hosted.

In other embodiments, the control platform 1302 is executed entirely by a cloud computing service operated by, for example, Amazon Web Services®, Google Cloud Platform™, or Microsoft Azure®. In such embodiments, the control platform 1302 may reside on a server system 1310 that is comprised of one or more computer servers. These computer servers can include different types of data (e.g., regarding batches of product that have been produced by OMPAs associated with different users), algorithms for implementing the routine described above (e.g., based on knowledge regarding ambient temperatures, humidity, etc.), algorithms for tailoring or training the routine described above (e.g., based on knowledge gained from nearby OMPAs or comparable OMPAs), and other assets (e.g., user credentials). Those skilled in the art will recognize that this information could also be distributed amongst the server system 1310 and one or more other electronic devices. For example, some data that is generated by a given OMPA may be stored on, and processed by, that OMPA or an electronic device that is “paired” with that OMPA. Thus, not all data generated by OMPAs—or even the control platform—may be transmitted to the server system 1310 for security or privacy purposes.

One benefit of having a network-connected OMPA is that it enables connectivity with other electronic devices, and thus integration into related systems.

Assume, for example, that a user purchases and then deploys a OMPA in a home. This OMPA may include a set of instructions (also referred to as the “intelligent time recipe”) that, when executed, indicate how its components are to be controlled. These instructions may involve the execution of heuristics, algorithms, or computer-implemented models. Rather than learn best practices “from scratch,” the OMPA (or a control platform to which it is communicatively connected) may be able to learn from the experiences of other OMPAs. These OMPAs may be located nearby, and therefore may experience comparable ambient conditions such as humidity, temperature, and the like. Alternatively, these OMPAs may be comparable, for example, in terms of amount of actual or expected OMPA input, type of actual or expected OMPA input, number of users (e.g., a single individual versus a family of four individuals), etc. Thus, knowledge may be shared among OMPAs as part of a networked machine learning scheme. Referring again to the above-mentioned example, the OMPA may initiate a connection with a control platform after being deployed in the home. In such a scenario, the control platform may provide another set of instructions that is learned based on knowledge gained by the control platform from analysis of the activities of other OMPAs. Accordingly, the control platform may further develop instruction sets based on machine learning. Learning may be performed continually (e.g., as OMPAs perform activities and generate data), and insights gained through learning may be provided continually or periodically. For instance, the control platform may communicate instructions to a OMPA whenever a new set is available, or the control platform may communicate a new set of instructions to an OMPA only upon receiving input (e.g., from the corresponding user) indicating that the OMPA is not operating as expected.

As another example, assume that a municipality is interested in collecting the products produced by various OMPAs for further processing (e.g., composting). In such a scenario, the municipality may be interested in information such as the weight and water content of product that is available for collection. Each OMPA may not only have the sensors needed to measure these characteristics as discussed above but may also have a communication module that is able to transmit measurements elsewhere. In some embodiments, these OMPA directly transmit the measurements to the municipality (e.g., by uploading to a network-accessible data interface, such as an application programming interface). In other embodiments, these OMPAs indirectly transmit the measurements to the municipality (e.g., by forwarding to respective control platforms, which then transmit the measurements—or analyses of the measurements-onward to the municipality). With these measurements, the municipality may be able to retrieve, transport, and handle the products produced by these OMPAs in a more intelligent manner. For example, the municipality may have a better understanding of when retrieval needs to occur, and how much storage space is needed for the products, if the weight is shared.

Users may also be able to communicate with one another, directly or indirectly, through OMPA. Assume, for example, that a first OMPA has finished processing its OMPA input into a product. Although processing is complete, a corresponding first user may not be ready to offload the product. In such a situation, a second user who is located nearby (e.g., as determined based on information generated by the respective OMPA, information input by the respective users, etc.) may offer to handle the product. For instance, the second user may retrieve the product from the first user and then handle it, add it to her own product, etc. Users may be able to communicate through the interfaces 1306 generated by the control platform 1302, or users may be able to communicate directly through their respective OMPAs.

### Computing System

FIG. 14 is a block diagram illustrating an example of a computing system 1400 in which at least some operations described herein can be implemented. For example, components of computing system 1400 may be hosted on an OMPA that is tasked with converting OMPA input into a more stable product. As another example, components of the computing system 1400 may be hosted on an electronic device that is communicatively connected to an OMPA.

The computing system 1400 may include a controller 1402, main memory 1406, non-volatile memory 1410, network adapter 1412, display mechanism 1418, input/output (I/O) device 1420, control device 1422, drive unit 1424 including a storage medium 1426, and signal generation device 1430 that are communicatively connected to a bus 1416. The bus 1416 is illustrated as an abstraction that represents one or more physical buses or point-to-point connections that are connected by appropriate bridges, adapters, or controllers. The bus 1416, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 1406, non-volatile memory 1410, and storage medium 1426 are shown to be a single medium, the terms “machine-readable medium” and “storage medium” should be taken to include a single medium or multiple media (e.g., a database distributed across more than one computer server) that store instructions 1428. The terms “machine-readable medium” and “storage medium” shall also be taken to include any medium that is capable of storing, encoding, or carrying instructions for execution by the computing system 1400.

In general, the routines executed to implement the embodiments of the present disclosure may be implemented as part of an operating system or a specific computer program. Computer programs typically comprise instructions (e.g., instructions 1404, 1408, 1428) that are set at various times in various memory and storage devices in an electronic device. When read and executed by controller 1402, the instructions cause the computing system 1400 to perform operations to execute various aspects of the present disclosure.

The network adapter 1412 enables the computing system 1400 to mediate data in a network 1414 with an entity that is external to the computing system 1400 through any communication protocol that is supported by the computing system 1400 and the external entity. The network adapter 1412 can include a network adapter card, wireless network interface card, router, access point, wireless router, switch, protocol converter, gateway, bridge, hub, digital media receiver, repeater, or any combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

From the description herein, it will be appreciated that the present disclosure encompasses multiple implementations of the technology which include, but are not limited to, the following.

Statement 1. A bucket assembly for processing organic matter in an organic matter processing apparatus, the bucket assembly comprising: a metal housing comprising a bottom wall, a first support structure extending from the bottom wall, a second support structure extending from the bottom wall, and a peripheral wall extending from the bottom wall and together defining a matter processing chamber; a first impeller tree assembly mounted to the first support structure and operative to rotate around a first vertical axis, the first impeller tree assembly comprising a first plurality of structures extending radially away from the first vertical axis and each positioned at different heights with respect to the bottom wall; a second impeller tree assembly mounted to the second support structure and operative to rotate around a second vertical axis, the second impeller tree assembly comprising a second plurality of structures extending radially away from the second vertical axis and each positioned at different heights with respect to the bottom wall; and a blade array mounted in a vertical orientation on the peripheral wall and configured such that the first plurality of structures pass by the blade array during each rotation of the first impeller tree.

Statement 2. The bucket assembly of any previous statement, wherein the first impeller tree assembly comprises:
a first impeller structure comprising:
   a first base portion positioned around the first support structure and adjacent to the bottom wall and comprising a first cutting member extending radially from the first base portion into the matter processing chamber;
   a first telescoping portion extending upwards from the first base portion;
   an integrated paddle and cutting member extending radially from the first base portion, the first telescoping portion, or a combination thereof into the matter processing chamber; and
   a second cutting member extending radially from the first telescoping portion into the matter processing chamber, wherein the first plurality of structures comprises the first cutting member, the second cutting member, and the integrated paddle and cutting member.

Statement 3. The bucket assembly of any previous statement, wherein the second impeller tree assembly comprises:
a second impeller structure comprising:
   a second base portion positioned around the second support structure and adjacent to the bottom wall and comprising a third cutting member extending radially from the second base portion into the matter processing chamber;
   a second telescoping portion extending upwards from the second base portion; and
   a paddle member extending radially from the second base portion, the second telescoping portion, or a combination thereof into the matter processing chamber, wherein the second plurality of structures comprises the third cutting member and the paddle member.

Statement 4. The bucket assembly of any previous statement, wherein the first impeller structure and the second impeller structure are investment cast from stainless steel, and wherein the metal housing is constructed from a die cast aluminum.

Statement 5. The bucket assembly of any previous statement, wherein the second cutting member has larger cutting dimensions than the first cutting member.

Statement 6. The bucket assembly of any previous statement, wherein the first cutting member comprises a bottom wall scraper; and wherein the third cutting member comprises a bottom wall scraper.

Statement 7. The bucket assembly of any previous statement, wherein the matter processing chamber has a height from the bottom wall, wherein the first cutting member and the third cutting member are positioned at a first height position relative to the bottom wall, and
wherein the integrated paddle and cutting member, the paddle member, and the second cutting member are positioned at different respective height positions relative to the bottom wall.

Statement 8. The bucket assembly of any previous statement, wherein the first impeller structure further comprises a first thumb screw member integrated with the first telescoping portion, and wherein the second impeller structure further comprises a second screw member integrated with the second telescoping portion.

Statement 9. The bucket assembly of any previous statement, wherein the first impeller tree does not overlap any portion of the second impeller tree during rotation of the first impeller tree and the second impeller tree.

Statement 10. The bucket assembly of any previous statement, wherein the integrated paddle and cutting member comprises:
a u-shaped member having a top side and a bottom side;
a first matter redirection member integrally formed with and extending from the top side; and
a second matter redirection member integrally formed with and extending from the bottom side.

Statement 11. The bucket assembly of any previous statement, wherein the first impeller tree assembly and the second impeller tree assembly are removable from the matter processing chamber.

Statement 12. The bucket assembly of any previous statement, wherein the matter processing chamber has a substantially elliptical cross section with a length and a width.

Statement 13. The bucket assembly of any previous statement, wherein the matter processing chamber has a height, the metal housing further comprising:
a first deflector positioned adjacent to an opening of the matter processing chamber along a first interior side of the peripheral wall; and
a second deflector positioned adjacent to the opening along a second interior side of the peripheral wall, wherein the first interior side is opposite of the second interior side.

Statement 14. The bucket assembly of any previous statement, further comprising a second blade array mounted in a vertical orientation on the peripheral wall and configured such that the second plurality of structures pass by the second blade array during each rotation of the second impeller tree.

Statement 15. An organic matter processing apparatus, comprising:
a bucket assembly comprising a metal housing, a first impeller tree assembly, second impeller tree assembly, and a blade array vertically mounted to a side wall of the metal housing;
a liner structure comprising a first aperture through which the bucket assembly is inserted and removed;
a hot plate comprising a first through-hole and a second through-hole and configured to interface with a hot plate interfacing surface of the metal housing;
an insulation layer secured to the hotplate;
an overmold structure secured to the liner structure via a first gasket, the overmold structure secured to the hotplate and the insulation layer via a second gasket; and
a drivetrain assembly comprising a motor and a gear mechanism coupled to the motor, a first drive shaft, and a second drive shaft, wherein the first drive shaft extends through the first through-hole and is coupled to the first impeller tree assembly and the second drive shaft extends through the second through-hole and is coupled to the second impeller assembly when the bucket assembly is inserted.

Statement 16. The organic matter processing apparatus of any previous statement, wherein the gear mechanism comprises an asymmetric gear ratio that causes the first shaft and the second shaft to rotate asymmetrically with respect to each other.

Statement 17. The organic matter processing apparatus of any previous statement, wherein the liner structure further comprises a second aperture that is sealed by a combination of at least the hot plate, the overmold structure, the first gasket, the insulation layer, and the second gasket.

Statement 18. The organic matter processing apparatus of any previous statement, further comprising:
a mass bracket coupled to the liner structure; and
a mass sensor secured to the mass bracket and the drivetrain assembly such that a combination of the bucket assembly, the hot plate, the insulation layer, the overmold structure, and the drivetrain assembly are supported by mass sensor and the mass bracket, the mass sensor operative to measure mass of the bucket assembly, the hot plate, the insulation layer, the overmold structure, the drivetrain assembly, and any organic contents contained in the bucket assembly.

Statement 19. A method for operating an organic matter processing apparatus comprising a bucket assembly comprising a metal housing, first and second impeller assemblies having respective first and second impeller couplers, and a blade array secured to a surface of the metal housing, a liner structure, a hot plate, and a drivetrain assembly comprising first and second drive shafts coupled to a gearbox that is powered by a motor, the first and second drive shafts associated with respective first and second drivetrain couplers, the method comprising:
in response to confirming that the bucket assembly is present within the liner structure and the organic matter processing apparatus is ready to commence a processing action, instructing the motor to rotate in a first direction, which causes the gearbox to actuate and rotate the first and second drive shafts;
rotating the first and second impeller assemblies in a first rotation direction in response to rotation of the first and second drive shafts, wherein the first impeller assembly rotates about a first vertical axis within the metal housing of the bucket assembly and includes a first plurality of structures extending radially away from the first vertical axis and each positioned at different heights with respect to a bottom wall of the metal housing, wherein the second impeller assembly rotates about a second vertical axis within the metal housing and includes a second plurality of structures extending radially away from the second vertical axis and each positioned at different heights with respect to the bottom wall, and wherein the blade array interfaces with the first plurality of structures during each rotation of the first impeller assembly.

Statement 20. The method of any previous statement, in response to detecting that the bucket assembly has been inserted into the liner, auto-rotating the first and second drivetrain couplers to ensure that the first and second impeller couplers are fully seated with respective first and second drivetrain couplers.

Statement 21. The method of any previous statement, further comprising:
executing a dynamically adjustable algorithm to convert organic matter contained in the bucket assembly to foodgrounds, comprising:
   operating the motor;
   operating the hot plate to impart heat into the metal housing;
   operating a first fan to draw in ambient air from outside of the organic matter processing apparatus to be injected into the bucket assembly and optionally heating the ambient air before it is injected into the bucket assembly; and
   operating a second fan to pull untreated air out of the bucket assembly for routing through an air treatment system that converts the untreated air to treated air suitable for expulsion from the organic matter processing apparatus,
   wherein the algorithm selectively adjusts operating parameters of the motor, hot plate, first fan, and second fan depending on a plurality of factors to convert contents contained in the bucket assembly to OMPA output.

Statement 22. The method of any previous statement, wherein the plurality of factors comprises run time, mass sensor input, at least one temperature sensor input, at least one humidity sensor input, or any combination thereof.

Statement 23. An organic matter processing apparatus (OMPA), comprising:
a liner structure comprising a first aperture through which a bucket assembly is inserted and removed and a second aperture;
a hot plate comprising a first through-hole and a second through-hole, wherein the hot plate has an ellipsoid shape;
an overmold structure secured to the liner structure and the hotplate, wherein the overmold structure and the hot plate at least partially seal the second aperture; and
a drivetrain assembly comprising:
a first drive shaft secured to a first coupler that exists in the first through-hole and configured to interface with the bucket assembly; and
a second drive shaft secured to a second coupler that exists in the second through-hole and configured to interface with the bucket assembly is inserted; and
wherein the bucket assembly comprises:
   a metal housing configured to interface directly with the hot plate when the bucket assembly is inserted;
   a first blade array secured to a first location of an inner surface of the metal housing in a vertical orientation;
   a first impeller tree assembly configured to interface with the first coupler when the bucket assembly is inserted and rotate about a first vertical axis in conjunction with rotation of the first drive shaft; and
   a second impeller tree assembly configured to interface with the second coupler when the bucket assembly is inserted and rotate about a second vertical axis in conjunction with rotation of the second drive shaft,
wherein during operation of the drivetrain assembly, the first impeller tree assembly interfaces with the first blade array each rotation.

Statement 24. The OMPA of any previous statement, wherein the bucket assembly further comprises registration feet dimensioned to fit around the hot plate and hover over the overmold structure when the bucket assembly is inserted.

Statement 25. The OMPA of any previous statement, wherein the first impeller tree assembly comprises:
a first base portion positioned adjacent to a bottom wall of the metal housing and has a cutting member extending radially from the first base portion;
a first telescoping portion extending from the first base portion;
a first integrated paddle and cutting member extending radially from the first base portion, the first telescoping portion, or a combination thereof; and
a second cutting member extending radially from the first telescoping portion.

Statement 26. The OMPA of any previous statement, wherein the first cutting member, the second cutting member, and the first integrated paddle and cutting member pass by the first blade array during each rotation of the first impeller assembly.

Statement 27. The OMPA of any previous statement, wherein the second impeller assembly comprises:
a second base portion positioned adjacent to the bottom wall and has a third cutting member extending radially from the second base portion;
a second telescoping portion extending from the second base portion; and
a second member extending radially from the second base portion, the second telescoping portion, or a combination thereof.

Statement 28. The OMPA of any previous statement, further comprising:
a second blade array secured to a second inner surface of the metal housing in a vertical orientation, wherein the third cutting member and the second member pass by the second blade array during each rotation of the second impeller tree.

Statement 29. The OMPA of any previous statement, wherein the first cutting member comprises at least one bottom wall scraper; and
wherein the third cutting member comprises at least one bottom wall scraper.

Statement 30. The OMPA of any previous statement, wherein the second cutting member has larger cutting dimensions than the first cutting member,
wherein the first cutting member and the third cutting member are dimensioned the same, and
wherein the first integrated paddle and cutting member comprises:
   a u-shaped member having a top side and a bottom side;
   a first matter redirection member integrally formed with and extending from the top side; and
   a second matter redirection member integrally formed with and extending from the bottom side.

Statement 31. A method for processing organic matter with an organic matter processing apparatus (OMPA) comprising a bucket assembly comprising first and second impeller assemblies and a first blade array, a hot plate, a drivetrain assembly that is coupled to the first and second impeller assemblies when the bucket array is inserted in the OMPA, the method comprising:
rotating the first and second impeller assemblies about respective vertical axes using the drivetrain assembly, wherein the first impeller assembly comprises first cutting member and first integrated paddle and cutting member, wherein the second impeller assembly comprises a second cutting member and a second extension member, and wherein rotating the first and second impeller assemblies comprises:
   cutting the organic matter when the first cutting member and first integrated paddle and cutting member pass by the first blade array; and
   redirecting a flow of the organic matter downwards towards a bottom surface of the bucket assembly with the first integrated paddle and cutting member and the second extension member; and
heating the organic matter by applying heat to the bucket assembly using the hot plate, wherein a combination of the cutting, the redirecting, and the heating converts the organic matter to a ground and selectively dried product.

Statement 32. The method of any previous statement, further comprising:
alternating rotation direction such that the first and second impeller assemblies rotate in a clockwise direction for a first period of time and rotate in a counter-clockwise direction for a second period of time.

Statement 33. The method of any previous statement, wherein said first cutting member and said second cutting member are positioned near the bottom surface, wherein said first cutting member comprises a first floor scraper that faces the bottom surface, wherein said second cutting member comprises a second floor scraper that faces the bottom surface, when said rotating the first and second impeller assemblies comprises scraping the organic matter with the first and second floor scrapers.

Statement 34. The method of any previous statement, wherein the first integrated paddle and cutting member comprises:
a u-shaped member having a top side and a bottom side;
a first matter redirection member integrally formed with and extending from the top side; and
a second matter redirection member integrally formed with and extending from the bottom side.

Statement 35. The method of any previous statement, wherein the first cutting member and the second cutting member are dimensioned the same.

Statement 36. The method of any previous statement, when said rotating the first and second impeller assemblies comprises asynchronously rotating the first and second impeller assemblies.

Statement 37. The method of any previous statement, when said rotating the first and second impeller assemblies comprises generating an organic matter flow path within the bucket assembly that resembles a figure eight.

Statement 38. A method for processing organic matter with a bucket assembly, comprising:
rotating first and second impeller assemblies in response to operation of a drivetrain assembly, wherein the first and second impeller assemblies rotate about respective vertical axes within an ellipsoid shaped metal housing comprising a first vertically oriented blade array secured to an inner surface of the metal housing within a first radial sweep zone of the first impeller assembly, wherein the first impeller assembly comprises first and second cutting members and a first paddle and cutting member, wherein the second impeller assembly comprises a third cutting member and a paddle member, and wherein during rotation of the first impeller assembly, the first and second cutting members and the first paddle and cutting member interact with respective blades of the first blade array; and
heating the metal housing with a hot plate that interfaces with a hot plate facing surface of the metal housing.

Statement 39. The method of any previous statement, wherein the drivetrain assembly comprises a motor, the method further comprising:
operating the motor at a first speed during a first phase of a processing cycle; and
operating the motor at a second speed when the first phase is determined to be complete, wherein the second speed is faster than the first speed.

Statement 40. The method of any previous statement, wherein the drivetrain assembly comprises a motor, the method further comprising:
controlling the motor to rotate in a first direction for a first period of time;
controlling the motor to rotate in a second direction for a second period of time; and
alternating between the first direction and the second direction after the first period of time has elapsed or after the second period of time has elapsed.

Statement 41. The method of any previous statement, wherein the drivetrain assembly comprises a motor, the method further comprising:
monitoring a load on the motor for an overload condition; and
engaging an overload protection scheme when the overload condition is monitored.

Statement 42. The method of any previous statement, wherein the overload protection scheme comprises:
stopping the motor to cease rotation in a current direction;
reversing rotation of the motor to move in a direction opposite of the current direction to cause the first and second impeller assemblies to reverse rotate a fixed number of angular degrees of rotation; and
resuming rotation of the motor in the current direction.

Statement 43. The method of any previous statement, wherein the overload protection scheme comprises:
determining that engagement of the overload protection scheme is not able to rectify the overload condition; and
notifying a user of the bucket assembly of the overload condition.

Statement 44. The method of any previous statement, wherein the ellipsoid shaped metal housing further comprises a second vertically oriented blade array secured to the inner surface within a second radial sweep zone of the second impeller assembly; the method further comprising:
during rotation of the second impeller assembly, the third cutting member and the second paddle member interact with respective blades of the second blade array.

Statement 45. An organic matter processing apparatus (OMPA), comprising:
a bucket assembly operative to process OMPA input;
a liner structure comprising a first aperture through which the bucket assembly is inserted and removed and a second aperture;
a mass bracket secured to the liner structure adjacent to the second aperture;
a hot plate comprising a first through-hole and a second through-hole, wherein the hot plate has an ellipsoid shape;
an overmold structure mounted to the liner structure and the hotplate, wherein the overmold structure and the hot plate at least partially seal the second aperture; and
an insulation layer mounted to the hot plate and comprising a third through-hole and a fourth through-hole;
a drivetrain assembly mounted to the insulation layer; and
a load cell secured to the drivetrain assembly and the mass bracket, wherein the load cell supports and measures mass of a combination of the drivetrain assembly, the insulation layer, the hot plate, the overmold structure, the bucket assembly when present within the liner structure, and any content contained within an inserted bucket assembly.

Statement 46. The OMPA of any previous statement, wherein the load cell is a strain gauge.

Statement 47. The OMPA of any previous statement, wherein the load cell comprises a mass bracket interfacing surface, a hard stop interfacing surface, and a drivetrain assembly interfacing surface, wherein the mass bracket interfacing surface is mated to the mass bracket and the drivetrain assembly interfacing surface is mated to the drivetrain assembly.

Statement 48. The OMPA of any previous statement, wherein the mass bracket interfacing surface comprises:
at least two registration posts configured to press fit into at least two reciprocal registration cavities of the mass bracket; and
at least two retention holes each configured to receive a screw or fastener; and
the OMPA further comprising at least two screws or fasteners that secure the mass bracket to the mass bracket interfacing surface.

Statement 49. The OMPA of any previous statement, wherein the at least two screws are self-tapping trilobular screws.

Statement 50. The OMPA of any previous statement, wherein the drivetrain assembly interfacing surface comprises:
at least two registration cavities configured to receive at least two respective registration posts associated with the drivetrain assembly, wherein the at least two registration posts are press fit into the at least two registration cavities; and
at least two retention cavities configured to receive at least two screws or fasteners; and
the OMPA further comprising at least two screws or fasteners that secure the drivetrain assembly to the drivetrain assembly interfacing surface.

Statement 51. The OMPA of any previous statement, wherein the at least two screws are self-tapping trilobular screws.

Statement 52. The OMPA of any previous statement, further comprising a member existing between the mass bracket interfacing surface and the hard stop interfacing surface and between the drivetrain assembly interfacing surface and the mass bracket interfacing surface such that the hard stop interfacing surface and the drivetrain assembly interfacing surface are positioned distally from the mass bracket interfacing surface, wherein a step change transition between the mass bracket interfacing surface and the member is greater than a step change transition between the hard stop interfacing surface and the member.

Statement 53. The OMPA of any previous statement, wherein a downward force is applied to the drivetrain assembly interfacing surface, and wherein the hard stop interfacing surface is operative to have a hard stop against the mass bracket when the downward force exceeds a force threshold.

Statement 54. The OMPA of any previous statement, wherein the mass bracket interfacing surface comprises a wedge structure that defines an anti-rotation angle of the load cell that counteracts a rotational load of the combination.

Statement 55. An organic matter processing apparatus (OMPA), comprising:
a liner structure comprising a first aperture through which a bucket assembly is inserted and removed and a second aperture;
a mass bracket secured to the liner structure;
a load cell secured to the mass bracket; and
a drivetrain and heating system secured to and supported by the load cell, wherein the drivetrain and heating system float relative to the liner structure and the mass bracket.

Statement 56. The OMPA of any previous statement, wherein the drivetrain and heating system comprises:
a hot plate comprising a first through-hole and a second through-hole, wherein the hot plate has an ellipsoid shape;
an overmold structure mounted to the liner structure and the hotplate, wherein the overmold structure and the hot plate at least partially seal the second aperture; and
an insulation layer mounted to the hot plate and comprising a third through-hole and a fourth through-hole; and
a drivetrain assembly mounted to the insulation layer and the load cell, the drivetrain assembly comprises a first drive shaft that resides in the first and third through-holes and a second drive shaft that resides in the second and fourth through-holes.

Statement 57. The OMPA of any previous statement, wherein the load cell is secured and aligned to the drivetrain assembly with a post and cavity press fit.

Statement 58. The OMPA of any previous statement, wherein the load cell is further secured to the drivetrain with at least two self-tapping screws.

Statement 59. The OMPA of any previous statement, wherein the load cell is secured and aligned to the mass bracket with a post and cavity press fit.

Statement 60. The OMPA of any previous statement, wherein the load cell is further secured to the mass bracket with at least two self-tapping screws.

Statement 61. The OMPA of any previous statement, wherein a bottom portion of the drivetrain assembly hard stops against the mass bracket if a downward force applied to the load cell exceeds a first force threshold; and the mass bracket further comprising a hard stop bracket operative to provide a hard stop to a top portion of the drivetrain assembly if an upward force applied to the drivetrain and heating system exceeds a second force threshold.

Statement 62. The OMPA of any previous statement, wherein the load cell hard stops itself against the mass bracket if a downward force applied to the load cell exceeds a force threshold.

Statement 63. The OMPA of any previous statement, further comprising a bucket assembly operative to process OMPA input, wherein when the bucket assembly is inserted into the liner structure, a bottom surface of the bucket assembly directly contacts the hot plate, and wherein the load cell supports mass of the drivetrain and heating stem and the bucket assembly.

Statement 64. The OMPA of any previous statement, wherein the load cell is operative to measure mass of the drivetrain and heating stem, the bucket assembly, and any contents contained in the bucket assembly.

Statement 65. A method for measuring mass in an organic matter processing apparatus comprising a liner structure comprising an aperture through which a bucket assembly is inserted and removed, a mass bracket secured to the liner structure, a load cell secured to the mass bracket, and a drivetrain and heating system secured to and supported by the load cell, wherein the drivetrain and heating system float relative to the liner structure and the mass bracket, the method comprising:
detecting presence of the bucket assembly in the liner structure; and
measuring, using the load cell, mass of the drivetrain and heating stem, the bucket assembly, and any contents contained in the bucket assembly.

Statement 66. An organic matter processing apparatus (OMPA), comprising:
a lid; and
a framework spanning from a top portion to a bottom portion of the OMPA and defining support structures for a plurality of components comprising the OMPA, the plurality of components comprising:
a hinge assembly comprising:
   a hinge bracket secured to the top portion of the framework;
   a hinge plate secured to the lid and moveably coupled to the hinge bracket, the hinge plate configured to rotate about a hinge plate axis; and
   a hinge pusher moveably coupled to the hinge bracket and configured to rotate about a hinge pusher axis;
a pedal assembly comprising:
a plate member secured to the bottom portion of the framework and configured to rotate about a pedal hinge axis, the plate member comprising a pedal portion and a linkage interface portion; and
linkage rods coupled to the linkage interface portion and the hinge pusher,
wherein depression of the pedal portion causes the linkage rods to move upwards to rotate the hinge pusher into the lid or hinge plate to open the lid, and
wherein release of the pedal portion causes the linkage rods to move downwards to rotate the hinge pusher away from the lid or hinge plate to close the lid.

Statement 67. The OMPA of any previous statement, wherein the hinge plate axis and the hinge pusher axis are vertically aligned in the same plane, and wherein the hinge plate axis is above the hinge pusher axis.

Statement 68. The OMPA of any previous statement, wherein the hinge plate rotates independently of the hinge pusher when a user manually lifts the lid and wherein the hinge plate rotates in conjunction with the hinge pusher when the user depresses the pedal portion.

Statement 69. The OMPA of any previous statement, wherein the hinge plate further comprises:
a planar section that is secured to the lid;
a member that extends perpendicularly with respect to the planar section; and
a dampener secured to the member, the dampener operative to interface with the hinge pusher during a lid opening event.

Statement 70. The OMPA of any previous statement, wherein the hinge pusher further comprises:
springs that bias the hinge pusher to rest against the lid or the hinge plate when the pedal assembly is in a relaxed state and that assist the hinge pusher in rotating upwards when the pedal assembly is in a depressed state.

Statement 71. The OMPA of any previous statement, wherein the hinge pusher further comprises:
spring retaining members for co-axially retaining center axes of the springs inline with the hinge pusher axis; and
a pusher portion characterized as has having a partial hollow tubular structure that extends from and between spring retaining members.

Statement 72. The OMPA of any previous statement, wherein the hinge pusher enables the linkage rods to be decoupled from the lid and lid plate.

Statement 73. The OMPA of any previous statement, wherein the pedal assembly further comprises:
a dampener secured to the plate member and configured to interface with a cavity embedded in the bottom portion of the framework, the dampener operative to soft close the lid during a lid closing event.

Statement 74. The OMPA of any previous statement, wherein the pedal assembly further comprises:
support blocks secured to the bottom portion of the framework; and
pivot members co-axially aligned with the pedal hinge axis and that couple the plate member to the support blocks, wherein coupling of the pivot members to the support blocks suspends the plate member within the bottom portion of the framework.

Statement 75. The OMPA of any previous statement, wherein the framework comprises:
a liner structure representing the top portion and comprising an aperture through which a bucket assembly is inserted and removed, wherein the hinge bracket is secured to the liner structure, and wherein the lid resides on the liner structure in a closed position;
a mass bracket structure secured to the liner structure;
a midframe structure secured to the mass bracket; and
a bottom housing representing the bottom portion, wherein the pedal assembly is secured to the bottom housing, and wherein the linkage rods extend from the bottom housing to the liner structure.

Statement 76. The OMPA of any previous statement, wherein the OMPA is a floor standing OMPA having a height, a width, and a depth, wherein the height is substantially greater than the width and the depth.

Statement 77. The OMPA of any previous statement, wherein the linkage rods comprise a non-linear construction to accommodate spacing requirements of the framework.

Statement 78. A method for opening and closing a lid of an organic matter processing apparatus (OMPA), the OMPA comprising the lid, a framework defining a support structure, a hinge assembly secured to the framework and the lid, a pedal assembly secured to the framework, and at least one linkage rod coupled to the hinge assembly and the pedal assembly, the hinge assembly comprising a hinge pusher that rotates about a hinge pusher axis and a hinge plate that rotates about a hinge plate axis, wherein the hinge plate is secured to the lid and wherein the at least one linkage rod is secured to the hinge pusher, the method comprising:
in response to depression of a pedal portion of the pedal assembly, causing the at least one linkage rod to travel vertically upwards along the framework when the pedal assembly rotates about a pedal rotation axis;
translating the vertical upwards travel of the at least one linkage rod into an upwards rotation of the hinge pusher; and
causing the hinge plate and the lid to rotate to an open position in conjunction with the upwards rotation of the hinge pusher.

Statement 79. The method of any previous statement, further comprising dampening an opening motion of the lid with a dampener coupled to the lid plate when the dampener interfaces with the hinge pusher while the lid plate and the lid rotate to the open position.

Statement 80. The method of any previous statement, further comprising spring biasing the hinge pusher to rotate in the upwards rotation in response to the depression of the pedal portion.

Statement 81. The method of any previous statement, wherein the at least one linkage rod is decoupled from the lid and the lid plate by being connected to the hinge pusher, the method further comprising enabling a user to manually open the lid without depressing the pedal portion.

Statement 82. The method of any previous statement, further comprising:
in response to release of the pedal portion, causing the lid, lid plate, and hinge pusher to rotate downwards to a closed position;
translating the downward rotation into a vertically downwards motion of the at least one linkage rod; and
causing the pedal assembly to rotate to a non-depressed state in response to the downwards motion of the at least one linkage rod.

Statement 83. The method of any previous statement, further comprising dampening a closing motion of the lid with a dampener secured to the pedal assembly when the dampener engages a portion of the framework while the lid plate and lid rotate to the closed position.

Statement 84. An organic matter processing apparatus (OMPA) comprising:
a framework;
a lid;
a hinge assembly secured to the lid and to a top portion of the framework, the hinge assembly comprising:
   a hinge pusher that rotates about a hinge pusher axis; and
   a hinge plate that rotates about a hinge plate axis, wherein the hinge plate is secured to the lid;
a pedal assembly secured to a bottom portion of the framework; and
at least one linkage rod coupling the pedal assembly to the hinge pusher, wherein depression of the pedal assembly causes the at least one linkage rod to travel vertically upwards along the framework to cause an upwards rotation of the hinge pusher, wherein said upward rotation further causes the hinge plate and the lid to rotate to an open position.

Statement 85. The OMPA of any previous statement, wherein the hinge plate axis and the hinge pusher axis are vertically aligned in the same plane, wherein the hinge plate axis is above the hinge pusher axis, wherein the hinge plate rotates independently of the hinge pusher when a user manually lifts the lid, and wherein the hinge plate rotates in conjunction with the hinge pusher when the user depresses the pedal portion.

Statement 86. The OMPA of any previous statement, wherein the hinge plate comprises detents, wherein the hinge assembly further comprises a hinge bracket secured to the top portion of the framework, the hinge bracket comprising lock back nubs, and wherein the lock back nubs engage the detents when the lid is pushed to a lock back position.

Statement 87. An organic matter processing apparatus (OMPA), comprising:
a framework comprising a liner structure and a midframe structure, the liner structure comprising a plurality of holes and a port;
a bucket assembly for processing organic matter and configured to be inserted into and removed from the liner structure;
an air intake system mounted to a first side of the liner structure, the air intake system operative to inject ambient air, via the plurality of holes, into the bucket assembly; and
an air treatment system mounted to a second side of the liner structure and to the midframe structure, the air treatment system operative to receive untreated air, via the port, from the bucket assembly, convert the untreated air to treated air, and exhaust the treated air.

Statement 88. The OMPA of any previous statement, wherein the air intake system further comprises:
an air intake manifold mounted to a first respective liner structure interface to form a substantially airtight seal between the air intake manifold and the liner structure; and
a fan mounted to a second respective liner structure interface and to the air intake manifold, the fan operative to draw in ambient air and drive the ambient air through the air intake manifold through the plurality of holes.

Statement 89. The OMPA of any previous statement, wherein the air intake system further comprises:
a heater mounted between the air intake manifold and the liner structure and operative to heat the ambient air being drawn in by the fan.

Statement 90. The OMPA of any previous statement, wherein the air intake system further comprises:
a sensor assembly mounted to the air intake manifold and operative to obtain sensor data related to the ambient air being driven through the plurality of holes.

Statement 91. The OMPA of any previous statement, further comprising:
a lid operative to open and close; and
a bezel operative to open and close, the bezel further comprising a plurality of air redirection members.

Statement 92. The OMPA of any previous statement, wherein the midframe structure comprises an air dispersion manifold, and wherein the air treatment system further comprises:
an air flow adapter mounted to a respective third liner structure interface to form a substantially airtight seal between the air flow adapter and the liner structure;
a duct coupled to the air flow adapter;
a fan housing coupled to the duct and the midframe structure; a
a fan mounted to the fan housing and operative to draw untreated air from the bucket assembly via the port, air flow adapter, duct and fan housing and drive the untreated air into the air dispersion manifold, wherein the air dispersion manifold is constructed to redirect the pushed untreated air upwards through an exit port and into an air treatment chamber positioned above the exit port, wherein the air treatment chamber converts untreated air to treated air; and
at least one exhaust port positioned above the air treatment chamber that provides egress for the treated air out of the OMPA.

Statement 93. The OMPA of any previous statement, wherein the air treatment chamber comprises a chamber comprising activated carbon.

Statement 94. The OMPA of any previous statement, wherein the air treatment chamber is a removable drawer comprising activated carbon.

Statement 95. The OMPA of any previous statement, wherein the removable drawer comprises:
a bottom surface comprising a plurality of ingress holes;
a top surface comprising a plurality of egress holes; and
a chamber defined by a peripheral wall extending between the bottom surface and the top surface, wherein the chamber is configured to receive activated carbon or a removable cartridge comprising activated carbon.

Statement 96. The OMPA of any previous statement, wherein the removable cartridge is constructed from a recyclable material and includes removable adhesive layers that are removed prior to the removable cartridge being placed into the chamber.

Statement 97. The OMPA of any previous statement, wherein the air dispersion manifold comprises an expansion chamber configured to evenly distribute the untreated as it passes through the exit port and passes through the air treatment chamber.

Statement 98. The OMPA of any previous statement, wherein the air treatment system further comprises a sensor assembly mounted to the air flow adapter and operative to monitor characteristics of the untreated air.

Statement 99. The OMPA of any previous statement, wherein the duct comprises:
an adapter interface portion comprising a relatively rectangular cross-section;
a fan housing interface portion comprising a relatively circular cross-section; and
a transition portion existing between the adapter interface portion and the fan housing interface portion and configured to transition the duct from the relatively rectangular cross-section to the relatively circular cross-section.

Statement 100. The OMPA of any previous statement, wherein the midframe structure comprises track members that are configured to receive sliding members of the air treatment chamber, each track member comprising first and second recess members that assist user alignment of the air treatment chamber.

Statement 101. The OMPA of any previous statement, wherein the midframe structure comprises a first air chamber, the OMPA further comprising:
a spine member comprising an air sealing member and the at least one exhaust port;
a mass bracket;
a backplate; and
backplate foam configured to interface with the air sealing member, wherein a second air chamber that is fluidically coupled to the first air chamber is defined by the spine member, the sealing member, the mass bracket, the backplate, and the backplate foam.

Statement 102. A method for operating an organic matter processing apparatus (OMPA), comprising a framework comprising a liner structure and a midframe structure, the liner structure comprising a plurality of holes and a port, a bucket assembly for processing organic matter and configured to be inserted into and removed from the liner structure, an air intake system mounted to a first side of the liner structure, and an air treatment system mounted to a second side of the liner structure and to the midframe structure, the method comprising:
injecting, using the air intake system, ambient air, via the plurality of holes, into the bucket assembly;
retrieving, using the air treatment system, untreated air, via the port, from the bucket assembly; and
converting, using the air treatment system, the untreated air to treated air that is exhausted out of the OMPA.

Statement 103. The method of any previous statement, further comprising:
detecting whether an air treatment chamber is sealed properly to the midframe structure;
operating the air intake system and the air treatment system when the air treatment chamber is detected to be sealed properly; and
when air treatment chamber is detected not be sealed properly:
deferring operation of the air intake system and air treatment system; and
notifying a user that the air treatment chamber is detected not be sealed properly.

Statement 104. The method of any previous statement, further comprising:
using a pressure differential existing between the air intake system and the air treatment system to detect conditions within the OMPA.

Statement 105. The method of any previous statement, wherein the conditions include an air leak.

Statement 106. The method of any previous statement, further comprising:
dynamically determining an end of life event for activated carbon being used by the air treatment system; and
notifying a user of the end of life event.

1. A bucket assembly for processing organic matter in an organic matter processing apparatus, the bucket assembly comprising:
a metal housing comprising a bottom wall, a first support structure extending from the bottom wall, a second support structure extending from the bottom wall, and a peripheral wall extending from the bottom wall and together defining a matter processing chamber;
a first impeller tree assembly mounted to the first support structure and operative to rotate around a first vertical axis, the first impeller tree assembly comprising a first plurality of structures extending radially away from the first vertical axis and each positioned at different heights with respect to the bottom wall;
a second impeller tree assembly mounted to the second support structure and operative to rotate around a second vertical axis, the second impeller tree assembly comprising a second plurality of structures extending radially away from the second vertical axis and each positioned at different heights with respect to the bottom wall; and
a blade array mounted in a vertical orientation on the peripheral wall and configured such that the first plurality of structures pass by the blade array during each rotation of the first impeller tree.

2. The bucket assembly of claim 1, wherein the first impeller tree assembly comprises:
a first impeller structure comprising:
a first base portion positioned around the first support structure and adjacent to the bottom wall and comprising a first cutting member extending radially from the first base portion into the matter processing chamber;
a first telescoping portion extending upwards from the first base portion;
an integrated paddle and cutting member extending radially from the first base portion, the first telescoping portion, or a combination thereof into the matter processing chamber; and
a second cutting member extending radially from the first telescoping portion into the matter processing chamber, wherein the first plurality of structures comprises the first cutting member, the second cutting member, and the integrated paddle and cutting member.

3. The bucket assembly of claim 2, wherein the second impeller tree assembly comprises:
a second impeller structure comprising:
a second base portion positioned around the second support structure and adjacent to the bottom wall and comprising a third cutting member extending radially from the second base portion into the matter processing chamber;
a second telescoping portion extending upwards from the second base portion; and
a paddle member extending radially from the second base portion, the second telescoping portion, or a combination thereof into the matter processing chamber, wherein the second plurality of structures comprises the third cutting member and the paddle member.

4. The bucket assembly of claim 3, wherein the first impeller structure and the second impeller structure are investment cast from stainless steel, and wherein the metal housing is constructed from a die cast aluminum.

5. The bucket assembly of claim 3, wherein the second cutting member has larger cutting dimensions than the first cutting member.

6. The bucket assembly of claim 3, wherein the first cutting member comprises a bottom wall scraper; and
wherein the third cutting member comprises a bottom wall scraper.

7. The bucket assembly of claim 3, wherein the matter processing chamber has a height from the bottom wall, wherein the first cutting member and the third cutting member are positioned at a first height position relative to the bottom wall, and
wherein the integrated paddle and cutting member, the paddle member, and the second cutting member are positioned at different respective height positions relative to the bottom wall.

8. The bucket assembly of claim 3, wherein the first impeller structure further comprises a first thumb screw member integrated with the first telescoping portion, and wherein the second impeller structure further comprises a second screw member integrated with the second telescoping portion.

9. The bucket assembly of claim 1, wherein the first impeller tree does not overlap any portion of the second impeller tree during rotation of the first impeller tree and the second impeller tree.

10. The bucket assembly of claim 2, wherein the integrated paddle and cutting member comprises:
a u-shaped member having a top side and a bottom side;
a first matter redirection member integrally formed with and extending from the top side; and
a second matter redirection member integrally formed with and extending from the bottom side.

11. The bucket assembly of claim 1, wherein the first impeller tree assembly and the second impeller tree assembly are removable from the matter processing chamber.

12. The bucket assembly of claim 1, wherein the matter processing chamber has a substantially elliptical cross section with a length and a width.

13. The bucket assembly of claim 1, wherein the matter processing chamber has a height, the metal housing further comprising:
a first deflector positioned adjacent to an opening of the matter processing chamber along a first interior side of the peripheral wall; and
a second deflector positioned adjacent to the opening along a second interior side of the peripheral wall, wherein the first interior side is opposite of the second interior side.

14. The bucket assembly of claim 1, further comprising a second blade array mounted in a vertical orientation on the peripheral wall and configured such that the second plurality of structures pass by the second blade array during each rotation of the second impeller tree.

15. An organic matter processing apparatus, comprising:
a bucket assembly comprising a metal housing, a first impeller tree assembly, second impeller tree assembly, and a blade array vertically mounted to a side wall of the metal housing;
a liner structure comprising a first aperture through which the bucket assembly is inserted and removed;
a hot plate comprising a first through-hole and a second through-hole and configured to interface with a hot plate interfacing surface of the metal housing;
an insulation layer secured to the hotplate;
an overmold structure secured to the liner structure via a first gasket, the overmold structure secured to the hotplate and the insulation layer via a second gasket; and
a drivetrain assembly comprising a motor and a gear mechanism coupled to the motor, a first drive shaft, and a second drive shaft, wherein the first drive shaft extends through the first through-hole and is coupled to the first impeller tree assembly and the second drive shaft extends through the second through-hole and is coupled to the second impeller assembly when the bucket assembly is inserted.

16. The organic matter processing apparatus of claim 15, wherein the gear mechanism comprises an asymmetric gear ratio that causes the first shaft and the second shaft to rotate asymmetrically with respect to each other.

17. The organic matter processing apparatus of claim 15, wherein the liner structure further comprises a second aperture that is sealed by a combination of at least the hot plate, the overmold structure, the first gasket, the insulation layer, and the second gasket.

18. The organic matter processing apparatus of claim 15, further comprising:
a mass bracket coupled to the liner structure; and
a mass sensor secured to the mass bracket and the drivetrain assembly such that a combination of the bucket assembly, the hot plate, the insulation layer, the overmold structure, and the drivetrain assembly are supported by mass sensor and the mass bracket, the mass sensor operative to measure mass of the bucket assembly, the hot plate, the insulation layer, the overmold structure, the drivetrain assembly, and any organic contents contained in the bucket assembly.

19. A method for operating an organic matter processing apparatus comprising a bucket assembly comprising a metal housing, first and second impeller assemblies having respective first and second impeller couplers, and a blade array secured to a surface of the metal housing, a liner structure, a hot plate, and a drivetrain assembly comprising first and second drive shafts coupled to a gearbox that is powered by a motor, the first and second drive shafts associated with respective first and second drivetrain couplers, the method comprising:
in response to confirming that the bucket assembly is present within the liner structure and the organic matter processing apparatus is ready to commence a processing action, instructing the motor to rotate in a first direction, which causes the gearbox to actuate and rotate the first and second drive shafts;
rotating the first and second impeller assemblies in a first rotation direction in response to rotation of the first and second drive shafts, wherein the first impeller assembly rotates about a first vertical axis within the metal housing of the bucket assembly and includes a first plurality of structures extending radially away from the first vertical axis and each positioned at different heights with respect to a bottom wall of the metal housing, wherein the second impeller assembly rotates about a second vertical axis within the metal housing and includes a second plurality of structures extending radially away from the second vertical axis and each positioned at different heights with respect to the bottom wall, and wherein the blade array interfaces with the first plurality of structures during each rotation of the first impeller assembly.

20. The method of claim 19, in response to detecting that the bucket assembly has been inserted into the liner, auto-rotating the first and second drivetrain couplers to ensure that the first and second impeller couplers are fully seated with respective first and second drivetrain couplers.

21. The method of claim 19, further comprising:
executing a dynamically adjustable algorithm to convert organic matter contained in the bucket assembly to foodgrounds, comprising:
operating the motor;
operating the hot plate to impart heat into the metal housing;
operating a first fan to draw in ambient air from outside of the organic matter processing apparatus to be injected into the bucket assembly and optionally heating the ambient air before it is injected into the bucket assembly; and
operating a second fan to pull untreated air out of the bucket assembly for routing through an air treatment system that converts the untreated air to treated air suitable for expulsion from the organic matter processing apparatus,
wherein the algorithm selectively adjusts operating parameters of the motor, hot plate, first fan, and second fan depending on a plurality of factors to convert contents contained in the bucket assembly to OMPA output.

22. The method of claim 21, wherein the plurality of factors comprises run time, mass sensor input, at least one temperature sensor input, at least one humidity sensor input, or any combination thereof.

23.-106. (canceled)
